(19) United States
(12) Patent Application Publication
(10) Pub. No.: US 2025/0175456 A1
(43) Pub. Date: May 29, 2025

(54) AI-CONTROLLED SENSOR NETWORK FOR THREAT MAPPING AND CHARACTERIZATION AND RISK ADJUSTED RESPONSE

(71) Applicant: QOMPLX LLC, Reston, VA (US)

(72) Inventors: Jason Crabtree, Vienna, VA (US); Richard Kelley, Woodbridge, VA (US); Jason Hopper, Halifax (CA); David Park, Fairfax, VA (US)

(21) Appl. No.: 19/041,944

(22) Filed: Jan. 30, 2025

Related U.S. Application Data
(63) Continuation-in-part of application No. 18/789,647, filed on Jul. 30, 2024.
Application No. 18/789,647 is a continuation of application No. 18/353,898, filed on Jul. 18, 2023, now Pat. No. 12,052,228.
Application No. 18/353,898 is a continuation of application No. 17/139,701, filed on Dec. 31, 2020, now Pat. No. 11,805,106.
(63) Continuation-in-part of application No. 18/765,262, filed on Jul. 7, 2024.
Application No. 18/765,262 is a continuation of application No. 17/245,964, filed on Apr. 30, 2021, now Pat. No. 12,041,091.
(63) Continuation-in-part of application No. 18/336,873, filed on Jun. 16, 2023.

(51) Int. Cl. H04L 9/40; G06F 16/909; G06F 16/951; G06N 5/01; G06N 5/045; G06N 5/046; G06N 7/01; G06N 20/00; H04L 9/00; H04L 9/14; H04L 9/32

(52) U.S. Cl. CPC H04L 63/0428; G06F 16/909; G06F 16/951; G06N 7/01; H04L 9/14; H04L 9/3236; H04L 9/3297; H04L 63/061; H04L 63/12; H04L 63/123; H04L 63/1408; H04L 63/1433; G06N 5/01; G06N 5/045; G06N 5/046; G06N 20/00; H04L 9/50; H04L 63/0442; H04L 2463/121

(57) ABSTRACT

A system and method for an AI-controlled sensor network for threat mapping and characterization. The system deploys a network of honeypots and sensors across various geographic locations and network segments, collecting and aggregating data on network traffic and potential threats. An AI orchestrator analyzes this data using advanced machine learning models, generating dynamic honeypot profiles and a comprehensive threat landscape. The system can adapt in real-time to emerging threats, optimize resource allocation, and provide actionable intelligence. By correlating data across multiple points, the system offers enhanced threat detection capabilities and proactive cybersecurity measures, surpassing traditional security information and event management (SIEM) tools.

### CROSS-REFERENCE TO RELATED APPLICATIONS

Priority is claimed in the application data sheet to the following patents or patent applications, each of which is expressly incorporated herein by reference in its entirety:
Ser. No. 18/789,647
Ser. No. 18/353,898
Ser. No. 17/139,701
Ser. No. 18/765,262
Ser. No. 17/245,964
Ser. No. 18/336,873

### BACKGROUND OF THE INVENTION

### Field of the Invention

The disclosure relates to the field of cybersecurity and network security, and adaptive sensor systems, and is particularly pertinent to the use of dynamically configurable networks of widely distributed sensor nodes to classify and denoise traffic, signals, and actions from human and artificial agents across multiple domains including cyber, RF, EMF and physical spaces. The system employs context-aware denoising capabilities through tunable filters and algorithms that adapt based on spatiotemporal context and exogenous factors, using advanced techniques including Markov State Transition Models, dimensionality reduction methods (PCA/ICA), and synthetic data generation through generative AI to identify potential threats, anomalies, and broader system health and utilization patterns. This approach enables robust threat detection and signal processing for both stationary and mobile assets including vehicles, convoys, autonomous systems, atmospheric monitoring platforms, and distributed IoT networks.

### Discussion of the State of the Art

Currently, it is possible for corporations and individuals to track certain assets in certain ways, to ensure their safety and ensure valid operation. For example, it is possible to track packages shipped via many shipping corporations, and it is possible and commonplace to have temperature controls and monitoring in certain environments such as libraries and wine cellars. However, changes to assets such as addition, removal, or reconfiguration necessitate updating any related asset information such as inventories or network models. Generally, these updates must be performed manually, such as scanning incoming or outgoing inventory items to update the inventory database, but these manual approaches are costly and prone to human error.

Many organizations operate scanning resources to monitor internal assets, but few are capable of effectively monitoring external cyber assets. Malicious actors operating machines on the public internet can obfuscate their activity by making their systems appear benign when inspected by internet scanners. This dynamic makes it difficult to detect and track malicious activity across the broader internet.

What is needed is a system and method for trigger-based scanning of cyber-physical assets that uses a time-series data store to track the state of connected resources. The system includes a scanner that detects changes and scans connected cyber-physical assets to update device or network information, while incorporating data from location-aware sensors, physical security systems, and real-world events. This enables follow-on analysis and automated planning and execution for device, environment, network, and application changes, including modifications to configurations, operational parameters, computer-readable execution plans, and instructions. The system may maintain an Event Knowledge Graphs (EKGs) to track temporal-spatial relationships between cyber and physical events, enabling sophisticated correlation of threat activities across both domains. This enables follow-on analysis and automated planning and execution for device, environment, network, and application changes, including modifications to configurations, operational parameters, computer-readable execution plans, and instructions. The system provides dynamic risk scoring that considers both traditional network-based threats and physical security contexts, allowing for more nuanced and context-aware security responses that bridge the gap between cyber and physical security domains. The system also provides multi-tenant collaboration capabilities, enabling secure sharing of threat intelligence across organizations while maintaining privacy controls. Through integration with established threat intelligence feeds and campaign data, the system can automatically correlate scanning activities with known adversary tactics, techniques, and procedures (TTPs), providing deeper insights into potential threats. Additionally, the system includes advanced denoising capabilities that go beyond simple IP-based filtering, incorporating campaign-level correlation and physical proximity data to provide more accurate threat assessments. The system's temporal-spatial analysis capabilities enable it to track how threat actors' presence evolves across both time and space, helping to identify sophisticated attack patterns that might otherwise go undetected. This comprehensive approach to cyber-physical security monitoring and analysis provides organizations with superior threat detection and response capabilities compared to traditional IP-based scanning systems.

### SUMMARY OF THE INVENTION

Accordingly, the inventor has conceived and reduced to practice, in a preferred embodiment of the invention, a system and methods for an AI-controlled sensor network for threat mapping and characterization, analysis, and response. The system significantly advances beyond existing approaches by implementing comprehensive spatio-temporal context analysis that couples real-time sensor array inputs across different physical locations, times, and network enclaves to dynamically characterize threat states at a finer granularity. Unlike systems focused solely on IP-based scanning classification, this invention employs diverse sensor types including on-device and robotic sensors for detecting suspicious transmissions, tags, or local signals, as well as introspection modules that snapshot software or kernel state to differentiate benign background processes from advanced persistent threats. The system builds and maintains sophisticated event knowledge graphs that incorporate temporal sequences of device exposures, cross-OS and cross-device correlation patterns, and dynamic privacy scoring that reacts to user environments or mobile robot routes. The system further implements active response capabilities through dynamic service simulation and banner randomization to infer attacker motives in real-time. This is enhanced by a multi-tier threat categorization framework that spans from global noise detection to micro-targeting pattern analysis, high-level reconnaissance identification, and physical surveillance signal integration. The system provides continuous measurement of observability degrees based on environmental sensors and tracker presence, while outputting recommended actions for privacy and security posture adjustment in real-time. These capabilities are unified through a novel multi-modal sensor fusion architecture that bridges physical and digital security domains while maintaining dynamic adaptability to emerging threats. The following non-limiting summary of the invention is provided for clarity and should be construed consistently with embodiments described in the detailed description below.

To solve the problem of assets being unreachable by remote monitoring and smart-contract systems, a system for dynamic geospatially-referenced cyber-physical infrastructure inventory and asset management, comprising: a computing device coupled to a physical asset and comprising a first processor, a first memory, a geolocation device, and a first plurality of programming instructions stored in the memory and operating on the processor, wherein the first plurality of programmable instructions, when operating on the first processor, cause the computing device to: periodically determine a geographical location of the physical asset using the geolocation device; generate an encrypted asset status update message, the status update message comprising a device identifier of the first computing device and the geographical location of the physical asset; and transmit the encrypted asset status update message via a network to the second computing device; and a port scanner comprising at least a second processor, a second memory, and a second plurality of programming instructions stored in the second memory and operating on the second processor, wherein the second programmable instructions, when operating on the second processor, cause the port scanner to: receive a triggering event from the first computing device, the trigger event comprising a plurality of packets received over a network satisfying a preconfigured condition; retrieve a plurality of stored scan rules from the second memory or a database; perform a scan of one or more ports of the first computing device, the scan being based on the received trigger event and the retrieved scan rules; analyze the results of the scan; determine whether any additional scans are needed based on the analysis, and if so initiate the needed additional scans; and when all scans related to the received trigger event have concluded and their respective results have been analyzed, transmit an encrypted scan update message comprising the scan results and the analysis results to the second computing device; wherein the second computing device verifies the authenticity of the received encrypted asset and scan status update messages and modifies a cyber-physical graph based upon the contents of the verified encrypted asset and scan status messages, is disclosed.

According to a preferred embodiment, a system for: intelligent signal processing and noise reduction across diverse data domains including LIDAR point clouds; biological patterns; geospatial imagery; RF signals; quantum fields; magnetic fields; and seismic measurements. The system implements an expansive suite of domain-specific and cross-domain denoising methodologies, including but not limited to: Statistical Outlier Removal (SOR) and Adaptive Gaussian Filtering for LIDAR data; Empirical Mode Decomposition and Non-Linear Phase Space Filtering for biological signal processing; Fourier Domain Filtering and morphological approaches for geospatial image enhancement; Butterworth and Chebyshev filtering for RF signal conditioning; Quantum State Filtering and Dynamical Decoupling for quantum field applications; SQUID-Based Filtering and Gradiometer-Based Noise Reduction for magnetic field analysis; and F-X Deconvolution and Curvelet Transform techniques for seismic data processing. These specialized techniques are complemented by universally applicable multidisciplinary approaches including wavelet transform methods, deep learning-based denoising, singular value decomposition, and adaptive filtering frameworks. The system's adaptive sensor configuration capabilities enable real-time optimization of sensing parameters and filtering strategies based on environmental conditions, signal characteristics, and operational requirements. This adaptive framework incorporates sophisticated machine learning algorithms that continuously refine filtering parameters and sensor configurations to maintain optimal signal quality across varying conditions and noise profiles. The disclosure further encompasses the application of these techniques to security and monitoring systems, particularly in contexts involving mobile assets, distributed sensor networks, and multi-domain threat detection scenarios. Through the integration of these advanced denoising methodologies with dynamic sensor configuration capabilities, the system provides unprecedented signal clarity and reliability across a wide range of operational environments and use cases.

According to another preferred embodiment, a method for an AI-controlled sensor network for threat mapping and characterization, comprising the steps of: deploying a distributed network of diverse honeypots and sensors; aggregating data from the honeypots and sensors; analyzing the aggregated data using machine learning models and pattern recognition algorithms to identify a plurality of patterns; generating a comprehensive threat landscape based on the analyzed data; restructuring system configurations based on the comprehensive threat landscape; and optimizing honeypot profiles and system components based on feedback and observed attack patterns to improve threat detection capabilities to include the use of reinforcement learning, is disclosed.

According to a preferred embodiment, a system for an AI-controlled sensor network for threat mapping and characterization, comprising one or more computers with executable instructions that, when executed, cause the deep learning system to: deploy a distributed network of diverse honeypots and sensors; aggregate data from the honeypots and sensors; analyze the aggregated data using machine learning models and pattern recognition algorithms to identify a plurality of patterns; generate a comprehensive threat landscape based on the analyzed data; restructure system configurations based on the comprehensive threat landscape; and optimize system components based on feedback and observed traffic patterns to improve threat detection capabilities, is disclosed.

According to an aspect of an embodiment, data from the honeypots and sensors includes observed network traffic, simulated vulnerabilities, honeypot configuration profiles, and behavioral characteristics of the honeypots.

According to an aspect of an embodiment, the aggregated data is used to generate a cyber-physical graph representing the relationships between entities associated with a network.

According to an aspect of an embodiment, the aggregated data is used to characterize observed traffic and assign a threat score.

According to an aspect of an embodiment, the AI based denoising system can be applied to network traffic sampled on an internet trunk line such as an undersea cable, or major interconnect.

According to an aspect of an embodiment, the AI based denoising system can be applied to classifying packet types and identifying application streams in encrypted streams. This can include identifying DNS over HTTPS (DoH), as well as traffic for Skype, Signal, and other encrypted communication platforms.

According to an aspect of an embodiment, the AI based denoising system can be applied to is a network of radio nodes distributed across an urban area monitoring vehicle signals. The AI system can distinguish between specific cars, trucks, and other vehicles, robots or dones to identify traffic patterns, congestion, and path optimization. Automonous vehicles could also leverage this network for route information and longer range communication between vehicles, robots, or drones.

According to an embodiment, the AI based denoising system can be applied to datacenter machine telemetry to identify malicious software. The AI system can ingest telemetry such as Process Identification (PID) values, CPU usage, process names, power consumption, execution paths, operating system calls by a process, to identify and classify malicious software and take action.

According to an embodiment, the AI based denoising system can be applied to urban smart power grids. By monitoring power consumption across a wide and diverse area, localized power needs can be better responded to by the grid. This may include monitoring the load of each power meter, pole utilities, conversion stations, or interconnects to identify where energy is needed and when. This can then enable the creation of localized storage nodes that can be efficiently charged at off-peak times when demand is low and supply shifts, and used for smoothing or faster delivery when needed. This would include prediction, localization, and identification of consumption type by monitoring raw spatial usage data.

According to an embodiment, the polymorphic honeypot architecture system comprises a metamorphic engine that dynamically modifies honeypot characteristics based on attacker behavior. The engine continuously reconfigures ports, rotates service versions, mutates operating system fingerprints, transforms network topology, and varies behavioral patterns to create an adaptive defense system.

According to an embodiment, the system may incorporate a multi-frequency bug and “creep” detector subsystem to complement the overarching honeypotand sensor-based AI security framework. By “creep,” this embodiment may refer to potentially unwanted surveillance devices (hidden cameras, audio bugs, GPS trackers, or other eavesdropping tools) used for physical or electronic stalking. The following outlines how this bug-and-creep detector subsystem expands the invention's core capabilities: The multi-frequency threat scanning with AI-enhanced algorithms allows the subsystem to integrate advanced RF detection spanning wide frequency ranges (e.g., 1 MHz to 10 GHz or higher). This may account for older analog bugs working on low-frequency channels, modern digital transmissions at higher frequencies (3G/4G/5G cellular, Wi-Fi, Bluetooth), and specialized frequencies (millimeter-wave or novel IoT protocols). Multi-mode capabilities may also include infrared scanning for hidden lenses, magnetic sensing for clandestine GPS devices, and passive detection modes to avoid generating suspicious signals. Instead of merely detecting raw RF energy, the system's AI orchestrator may correlate suspected signals with known device signatures or suspicious frequency bands. Users may filter out legitimate Wi-Fi, Bluetooth, or other common signals; the system may automatically focus on unusual or suspicious frequency patterns. The subsystem may distinguish background, legitimate transmissions (e.g., standard routers) from suspicious “creep signals” that may exhibit unique periodicities, bursts, or frequency hops. AI-driven classification may use advanced algorithms (e.g., convolutional networks, spectral clustering, or domain-specific heuristics) to reduce false positives. The bug detector's sliding context windows (both short- and longer-term) may provide temporal segments to detect intermittent or low-power transmissions. The subsystem may not be a standalone device. It may become part of the broader sensor fabric (including honeypots, introspection sensors, and Onionspace listeners). Mobile deployment may include handheld bug detectors or portable scanning nodes that may relay suspicious signals to the AI orchestrator for cross-checking against known infiltration patterns or malicious frequency usage. When a potential creep device may be identified, the system may reference the SBOM graph to see if the suspicious transmissions relate to known or unknown software components. For example, a micro-camera might incorporate an off-the-shelf Wi-Fi or bluetooth stack that may have a known fingerprint in the SBOM data. If the bug or camera may be captured or physically recovered, its binary firmware may be scanned for known-libraries or vulnerabilities, linking back to the same patching and analysis pipeline used for conventional software. In corporate or government environments, identifying unauthorized IoT or camera devices may feed into the same automated patch or quarantine approach used for typical network threats. The real time-sharing and threat updating may include any discovered creeps, hidden cameras, or unknown trackers may feed back into the global knowledge graph. This may ensure new device signatures (RF signatures, lens IR reflections, etc.) are updated system-wide. The system may thus learn from each detection event, continually refining its detection rules for future sweeps. The system also includes enhanced hardware and software design which further comprises an advanced multi-frequency detection hardware which may additionally comprise a specialized hardware front-end may support wideband scanning and advanced RF mixers. High-speed sampling may allow the system to collect thousands of samples per second, aligning with references to 2,000 or more scans for quickly spotting short bursts of hidden transmissions. Dual or triple-mode operation may enable IR lens detection, magnetic sensor modules, and RF sweeps to operate simultaneously or be toggled by the orchestrator's triage logic. The bug detector may scale sensitivity in noise-heavy areas (e.g., offices with numerous legitimate signals) to avoid constant false positives. Conversely, in quieter settings (hotel room, personal residence), it may run at maximum sensitivity to catch ultra-low power signals. In personal or travel scenarios, a handheld version (like a “pocket G9/G10” form factor) may pair wirelessly with the orchestrator's software agent, sending raw signal data for deeper AI-based analysis in the cloud or local data center. On the user interface, suspicious signals may be labeled with “Likely Hidden Camera-Check 2.4 GHz band mismatch” or “Possible GSM bug-Intermittent ARFCN pattern detected,” referencing known open-source or commercial module details from SBOM data. The user or an automated mobile sensor may perform a wideband sweep in a room, car, or other environment. The subsystem may collect real-time frequency data and may see unusual spikes, frequency-hopping transmissions, or IR lens reflections. These raw signals, partial waveforms, or lens detection events may be transmitted to the AI orchestrator. The orchestrator may check historically known device signatures, cross-correlate with environment profiles, and reference the SBOM of local networks and devices for plausible matches. If an anomaly may be verified as suspicious or unknown, the user may be alerted with a “Creep Alarm.” The orchestrator may orchestrate a “triage honeypot” scenario—e.g., deploying a local virtual node or ephemeral sensor to remain in the environment, collecting deeper intercept data to confirm malicious usage. If the subsystem may obtain any code or partial firmware from the bug, the code may be scanned for vulnerabilities or library matches. The system may organize patch efforts, if relevant (e.g., the camera uses a flawed library that's also present in corporate IoT devices) or may trigger advanced takedown measures. If an anomaly may be verified as suspicious or unknown, the user may be alerted with a “Creep Alarm.” The orchestrator may orchestrate a “triage honeypot” scenario—e.g., deploying a local virtual node or ephemeral sensor to remain in the environment, collecting deeper intercept data to confirm malicious usage. If the subsystem may obtain any code or partial firmware from the bug, the code may be scanned for vulnerabilities or library matches. The system may organize patch efforts, if relevant (e.g., the camera uses a flawed library that's also present in corporate IoT devices) or may trigger advanced takedown measures. Traditional bug camera detectors may be standalone. This embodiment may merge them seamlessly with a global honeypot and sensor intelligence framework for real-time threat correlation across multiple sites. Rather than simply beep-and-flash upon detection, the system may reference an SBOM-based knowledge graph. This may reveal common or unusual hardware modules, bridging typical bug detection with deeper software-level forensics and vulnerability checks. The sliding time and space context windows may allow the system to detect ephemeral or stealth transmissions more effectively than manual scanning. Automated introspection capabilities may go far beyond single devices or local scanning tools. Combining infrared lens detection, magnetic field scanning, and advanced RF multi-frequency sweeps may yield far fewer missed threats and more precise source pinpointing, especially for cunning adversaries who might try frequency-hopping or short-burst transmissions. Every discovery of a bug or creep device may feed the knowledge base. Over time, the system may drastically reduce false positives by learning legitimate background signals for different environments, while rapidly recognizing new patterns consistent with spy devices. There are many use cases, specifically, in a corporate facility, regular sweeps may detect an unauthorized 4G-based micro camera behind a drywall. The system may see unregistered 4G signals in a local environment profile that had historically no such signals. AI may classify it as a suspicious device. A close-up IR lens detection may confirm the camera lens reflection, triggering a security alert. At a hotel or airbnb stay, a traveler with the handheld version may scan the room. The device may pick up a faint 2.4 GHz signal that may not match typical Wi-Fi MAC addresses or known Bluetooth endpoints. The orchestrator, referencing the environment's normal access points, may flag a hidden camera. User may receive an immediate alarm. Fleet vehicles, or company vehicles may have integrated sensors for scanning GPS trackers or unauthorized devices. The multi-mode detector may see a magnetic anomaly indicating a clandestine tracker attached beneath the chassis. The orchestration system may advise the user to physically inspect the location. This bug and creep detector embodiment may enhance the invention by unifying advanced multi-frequency scanning technology, infrared lens detection, and an SBOM-aware knowledge graph under the same AI orchestrator that may manage honeypots, mobile sensors, and distributed threat intelligence. Through real-time correlation, adaptive scanning windows, and integrated software-hardware forensics, the system may deliver a powerful solution for locating covert surveillance devices and aligning those findings with broader vulnerability and patch management workflows.

According to an embodiment, multi-frequency bug detection, real-time signal analysis, SBOM and knowledge-graph integration, and multimodal scene understanding unite to enhance both “bug and creep” device detection capabilities for a comprehensive security solution. The multi-frequency bug detection with advanced range coverage may comprise broad spectrum scanning which may further include Sub-30 MHz scanning which may catch older analog bugs, ultrasonic-based eavesdropping devices, and power-line carrier transmissions. VHF (30 MHZ-300 MHz) may locate low-cost or illicit radio-based bugs often deployed in clandestine “spy shop” frequencies. UHF (300 MHz-3 GHZ) may capture the bulk of modern wireless threats-GSM, 3G, 4G, Wi-Fi (2.4 GHz), Bluetooth, typical vehicle trackers, etc. Microwave (3 GHZ-30 GHz) may identify advanced or military-grade high-frequency devices, 5G transmissions, frequency-hopping bugs, or specialized gear. By covering these frequencies in a single scanning platform, the system may identify both legacy and state-of-the-art surveillance threats. Advanced frequency filtering and analysis may include real-time DSP which may continuously process signals to differentiate legitimate background transmissions (e.g., standard Wi-Fi routers) from suspicious or rarely used bands. Environment-aware features may adjust sensitivity and noise filtering depending on typical local signals (e.g., an office with high Wi-Fi traffic vs. a hotel room with minimal known RF). Advanced pattern recognition may use AI/ML models to detect unusual bursts, frequency hops, or known bug profiles, reducing false positives from ordinary devices. The multi-mode sensor fusion may comprise magnetic field sensing which may find magnetically attached trackers (GPS modules, unapproved sensors). Infrared lens detection may use high-power IR to reflect from hidden camera lenses. Passive and active modes may avoid broadcasting scans that might tip off adversaries, while active sweeps may provoke certain bugs into transmitting. Real-time signal analysis for dynamic threat detection may comprise of continuous spectrum monitoring which may further comprise of high-speed sweeps which may achieve scanning speeds of thousands of sweeps/second, ensuring short-burst or intermittent transmissions may be caught. Microsecond-level capture may be capable of intercepting signals that may be on for only a few microseconds, vital for advanced or frequency-hopping bugs. Advanced signal processing comprises spectrum analyzers which may feed raw data into an AI-based orchestrator that may identify anomalies. Adaptive sensitivity may raise detection thresholds or filter out known frequencies to reduce false alarms in especially noisy environments. Multi-channel detection may identify sophisticated multi-frequency devices in a single pass through parallel scanning across multiple bands. The integration with the honeypot and sensor grid may include Global triage which may occur when a suspicious signal surfaces; the system may correlate with honeypot data (e.g., an IP address scanning the local network) or logs from other mobile and fixed sensors. Automated forensics may be triggered if multiple sensors detect the same unknown device from different vantage points, and the orchestrator may triangulate location and further investigate. The SBOM and knowledge-graph integration may comprise correlating firmware or device-when the system may suspect a particular bug or “creep” device (hidden camera, audio transmitter), it may reference a knowledge graph enriched with SBOM data. Device and module fingerprinting may occur if a partial firmware signature or known hardware may be recognized, and the SBOM may clarify possible vulnerabilities or code libraries used. Automated patching & remediation occurs if the discovered device may be part of a known library or there may be a corporate environment running a similar library, the orchestrator may trigger patches or quarantines. Each new detection event (model, frequency pattern, library used) may update the knowledge graph, improving future detection speed and reducing false positives. The attack path visualization includes a graph-based view which may allow the orchestrator to depict how the bug may tie into network entities or physical assets (rooms, vehicles). SBOM cross-reference may reveal if an IoT camera or microphone module discovered may be identical to a known compromised library, and the system may alert system administrators to remove or patch similar devices. The multimodal scene understanding and concealment detection may comprise enhanced object detection which may integrate RGB, depth, thermal, and possibly acoustic or LiDAR data for identifying concealed hardware. AI-based “camouflaged object detection” may scan for subtle differences in texture, color, shape that might indicate hidden lens or device compartments. Knowledge-based scene graphs shows the environment (room, car interior, data center rack) may be modeled as a 3D scene graph. Prior Knowledge systems may flag if a “camera lens” or “wireless module” object node may be identified in an unexpected location (e.g., inside a wall vent). Contextual reasoning may comprise of the knowledge graph which may record typical camera placements; anything deviating from normal usage may be flagged as suspicious. The Real-time alerts may incorporate temporal data: if a bug device may be newly introduced or moved between frames, the system may raise an alarm. The adaptive focus features may allow the scanning system to reconfigure local sensors or call for a directed honeypot response (actively provoking the suspect device to transmit for easier confirmation). The global orchestrator workflow allows for regular sweeps where local or mobile scanning devices may perform frequent multi-frequency scans. AI aggregator may merge data from multiple vantage points in real time. Suspicious signal escalation occurs once an unknown signal or device signature may be noted, the orchestrator may check the knowledge graph, local environment profiles, and the SBOM database to see if it may match known benign devices or patterns. If suspicious, it may task local sensors or cameras to focus on that signal's origin. Simultaneously, any ephemeral honeypots may be deployed on the local network to see if the device may attempt data exfiltration. The identification & response occurs if verified as an unauthorized or “creep” device (bug, GPS, hidden camera), an immediate alert may be sent. The system may guide a security or user response, optionally taking automated steps: blocking transmissions, physically locating the device via real-time triangulation, or neutralizing it with jamming signals (in legal/compliant scenarios). The root cause & patch integration occurs when firmware or partial code extraction (if any) may be analyzed by the same vulnerability detection pipeline used in standard software scanning. If libraries or code from the bug may appear in the corporate environment's SBOM, the orchestrator may recommend or auto-deploy security patches, quarantines, or audits. This is a truly unified approach because traditional bug and camera detectors may remain standalone. Here, multi-frequency detection may merge seamlessly with advanced scene understanding, knowledge graphs, and SBOM-based vulnerability analysis. The system comprises an adaptive real-time AI which comprises the orchestrator's real-time signal analysis, multi-sensor correlation, and knowledge-based reasoning which may drastically reduce false positives and catch ephemeral or stealth devices. The system further comprises multi-modal scene understanding—by combining depth or thermal imaging with normal RGB, and fusing that with the multi-frequency signals, the system may gain an unprecedented ability to spot physically hidden or camouflaged devices. The comprehensive security ecosystem comprises detected bugs or creeps may not just be found and beeped at; they may feed into a global knowledge pipeline that may foster improvements in detection, potential patching of related software, and deeper forensics. This synergy may address hardware and software intrusions simultaneously, bridging typical “spy device” detection with enterprise-class vulnerability management. The system includes constant improvement via knowledge graph as each new detection event (unusual frequency, advanced bug firmware) may enrich the knowledge base, enabling future auto-detections to be faster, more precise, and more context-aware. Example scenarios: High-security facility sweeps may include periodic scans which may reveal an unexpected 915 MHz burst near a conference room. Cross-referencing with known environment signals, the orchestrator may flag it. IR lens detection may be triggered, discovering a pinhole camera lens in a wall clock. SBOM data may reveal the camera's firmware may be recognized as using “SmallCamOS” known for a backdoor vulnerability. The orchestrator may log the exploit details and may recommend searching other facility clocks or devices for the same camera module. In a hotel or rental accommodation check a traveler may use the handheld multi-frequency scanner linked to their phone's orchestrator app. The device may pick up a faint 2.4 GHz signal not matching local Wi-Fi. Depth camera from a smartphone's AR features may be integrated, scanning the room visually. The orchestrator may find a lens reflection behind a vent, correlating with the RF reading. User may receive immediate “Hidden Camera Detected” alert. In a vehicle fleet monitoring company vehicles may have a small integrated multi-frequency sensor. During routine drives, it may detect an ultra-low-power device sending short bursts at 1.2 GHz. Magnetic sensor logs may confirm a strong magnetic field near the trunk. The system may tag it as a possible illicit GPS tracker. Fleet security may be notified; on inspection, an unauthorized magnetically attached tracker may be found and removed. By fusing multi-frequency bug detection, real-time signal analysis, SBOM and knowledge-graph integration, and multimodal scene understanding, this enhanced embodiment delivers robust, adaptive, and highly context-aware “bug and creep” detection. Through constant learning, wide-spectrum scanning, local sensor synergy, and advanced AI-driven forensics, users gain a formidable defense against hidden surveillance devices—spanning everything from analog eaves dropping transmitters to cutting-edge, frequency-hopping espionage tools.

According to another embodiment, in mobile systems like robots or for pedestrians walking around, users may be suddenly faced with pervasive surveillance not only from CCTV and its ilk but also from cell phones, cameras, WiFi and Bluetooth beacons, wearables, Apple AirTags, and Tiles. This system may enable personal privacy scoring and action (or inaction) recommendations. It may be mobile or apply to a sequence of actions over a spatio-temporal region or process known to the system (both predeclared or emergent). Spatio-temporal event Knowledge Graphs (KGs) and sensor context may be key to this as they may help the user, AI agent, or robot estimate their ongoing degree of observability and the level of effort potentially required to identify them (or a group). This may have numerous personal privacy and security applications. To achieve this we provide an expanded embodiment describing how the overall system can be adapted to provide personal privacy scoring and contextual action recommendations in highly surveilled or sensor-rich environments. This embodiment covers both mobile platforms (e.g., pedestrians, robots) and spatio-temporal analysis over dynamic environments filled with CCTV cameras, wearables, Wi-Fi and Bluetooth beacons, etc. Modern urban (and even semi-rural) environments may be increasingly packed with a variety of sensors and tracking modalities: CCTV cameras (private, public, business-owned), personal devices like smartphones continuously scanning Bluetooth, Wi-Fi, or NFC, wearables (smartwatches, AR glasses) that may record audio, video or broadcast location data, asset trackers like Apple AirTags, Tile trackers, or custom BLE devices, and public beacons for location-based services (advertising, city info). An individual (pedestrian, employee, or robot agent) moving through such spaces may experience a constantly changing “observability” level, impacting personal privacy or operational stealth. The system may provide personal privacy scoring which is a real-time or near-real-time measure of how visible a user (or a robot) may be to the various sensors in its vicinity. This may consider not only presence detection (e.g., being captured on multiple CCTV cameras) but also triangulation potential (multiple phones scanning the user's device or signals). Action (in) action recommendations occur based on the computed privacy or “observability” score. The system may suggest or automate specific behaviors: potential route changes to avoid high-density camera zones, device setting changes (e.g., turning off Wi-Fi scanning), physical concealment actions for a robot (or wearing an anonymity accessory for a pedestrian), and whether to continue transmitting normal signals or to adopt a stealth mode (if available/legally permitted). The system may employ a spatio-temporal event knowledge graph that may model events, sensor deployments, known path constraints, and user-labeled or automatically inferred privacy “hotspots.” The graph may evolve in real time as the user or robot moves, tracking changes in environment sensors, e.g., newly discovered beacons or ephemeral pop-up cameras. The system components comprise of mobile sensor suite to allow for on-device scanning. A user's smartphone, wearable, or a robot's onboard scanning system may continuously scan for nearby radio signals (Wi-Fi APs, Bluetooth devices, RFID) plus camera-lens detection where possible. This local scanning may be integrated with data from any external or cloud-based honeypot and sensor nodes (if the user may be part of a broader sensor network). This can also allow for location and mapping. The device or agent typically may have some form of positioning (GPS, inertial, SLAM for robots) to determine exact or approximate location. If a robot, it may incorporate LiDAR or visual SLAM for environment mapping. If a pedestrian, the smartphone may use typical geolocation plus possible dead reckoning in areas of poor GPS. The privacy scoring engine contains a local observability calculation. The privacy scoring engine may include local observability calculation capabilities. For each vantage point along the user's path, the system may estimate how many cameras or scanning devices could detect them, plus the “strength” of that detection (e.g., high-quality camera vs. low-res camera). If the system may find multiple overlapping sensor fields of view, the user's anonymity or privacy level may be lower. A single sensor in the area might not reduce privacy as much. The signal intersection engine may cross-reference known or discovered device transmissions. If the user's own phone may be actively pinging local towers, plus there may be a local aggregator or device that can glean identity, the privacy level may be further reduced. The system may also note whether these signals may be ephemeral or persistent, possibly distinguishing short-range pings from always-on scanning. AI/ML Inference may aggregate sensor data and environmental knowledge to produce a numerical or qualitative “Privacy Score,” e.g., from 0 (highly exposed) to 100 (nearly private). The recommendations and action Module may include route and behavior suggestions. If certain blocks or hallways may be densely covered by CCTV, the system may recommend alternative paths with fewer cameras or lower-likelihood detection. For a user in a building, it may suggest using side exits or stairwells to avoid known high-sensor-density corridors. Device setting adjustments may allow the system to prompt the user to disable active transmissions (Wi-Fi, Bluetooth scanning) if they want to reduce trackability. In lawful or secure contexts, a robot may be permitted to employ radio-silence or robust encryption for certain transmissions. The physical mitigation tactics may include advising the user to wear a privacy hood, mask, or to adopt a path overshadowed by buildings to reduce overhead drone or CCTV coverage. For a robot, the system may modulate lighting or color patterns to reduce camera-based recognition or possibly shift IR reflectivity. The spatio-temporal event KG integration may involve a dynamic scene and time graph. The knowledge graph may store known sensor deployments (e.g., city-owned cameras, typical location of wearable device clusters at certain times) as nodes. Edges may represent relationships: A Wi-Fi router may cover region R from times T1-T2, or a camera may be pointed at angle X with a field of view shaped by bounding geometry. Emergent or Self-Declared Data may allow the user or system to add new data in real time (the user notices a new camera or the system's sensor detects an unexpected Apple AirTag). The KG may evolve with “events” such as “CCTV #23 is offline” or “Public event in plaza=>denser smartphone presence.” Privacy probability modeling may mean each sensor node in the KG has attributes (field of view, resolution, typical occupant patterns, etc.). A spatio-temporal inference layer may compute how likely it may be that a user at location L at time T may be recorded or recognized. This may incorporate learned or prior known behaviors, e.g., certain crowds or specific camera operators who often zoom in on passersby. The Illustrative Operation Flow may begin with Initialization, where the user or robot may obtain the relevant spatio-temporal event KG for the area or region. Possibly partial data may be pre-declared (official city cameras) plus emergent data discovered in real time (Bluetooth trackers, ephemeral pop-up security teams). Continuous Data Capture may involve the mobile device (robot or user's phone) scanning multi-frequency signals. The orchestrator may reference the knowledge graph and local environment to refine or correct the scanning data. Privacy Score Computation may mean at each step or set of coordinates, the user may see a privacy rating: Low may indicate “Highly surveilled environment: multiple active cameras, strong cell triangulation, beacons all around” Medium may suggest “Some cameras in sight, but ephemeral signals are low or partial coverage only” High may mean “No known cameras or transmissions focusing on you at the moment.” Action (In) action recommendation may occur if the user's objective may be to remain unobserved, the system might propose a route with fewer cameras or times when cameras may be known to be inactive. If a stealth-based mission for a robot, it may advise waiting behind an occluding structure or turning off LED indicators. If privacy may not be critical, the system might remain passive and do nothing. Adaptive Re-planning may occur as the user or robot moves, the environment might shift—new crowds appear, new drones overhead. The orchestrator may update the recommended route or next step to maintain the desired privacy threshold. Example scenarios may include an Urban Pedestrian Using Privacy Guidance, where during morning commute, the user's phone may suggest traveling via smaller side streets instead of main boulevards saturated by city cameras, highlighting that the difference in camera coverage may lower the user's “exposure index” by 30%. When entering a smart building, the building's internal cameras may be known from the KG; the system may warn that the elevator area may be under high-definition video. If the user wants minimal face recognition risk, it may suggest the stairwell or wearing a face covering. For an automated delivery robot, the robot may have a job to deliver packages in an environment with both public and private security cameras. The system may choose a path that avoids large clusters of cameras or times the passage when certain cameras may be more likely to be idle. If a crowd with many smartphones may be encountered, the system might momentarily reduce the robot's broadcast transmissions or switch to a secure channel to lower the chance of device fingerprinting. Group privacy preservation may allow a group traveling together to remain collectively less visible. The system may share a combined spatio-temporal plan ensuring none of them pass a high-density camera zone simultaneously. The orchestrator may track each group member's device signals to avoid handshake triggers with local beacons. Key Benefits may include Real-Time Privacy Scoring, where unlike static or offline methods, this system may continuously re-evaluate a user's privacy status in the face of dynamic sensor coverage. Multi-frequency and multi-modal integration may combine bug and creep detection, Wi-Fi scanning, camera-lens detection, BLE beacons, etc. in one unified approach, now extended to personal privacy logic rather than just infiltration detection. The spatio-temporal KG may go beyond typical mapping: It may merge environment geometry with sensor deployments and event patterns, enabling advanced path planning for privacy. Adaptive recommendations may offer actionable steps, from route changes to device silence modes or physical concealment advice, bridging a gap between detection and practical user or robot guidance. The emergent or pre-declared approach may handle known infrastructures (declared sensors) and newly discovered ephemeral or mobile sensors, essential for truly pervasive environments. Potential Extensions may include integration with legal and regulatory databases: the system may identify if certain cameras may be legally mandated for security or if it may be permissible to jam or block certain transmissions (subject to local law). Group collaboration may mean multiple users might share partial sensor data, improving community-level privacy scoring. Behavioral machine learning may mean over time, the system may learn typical movement patterns for each user or robot, preemptively suggesting daily route variants to maximize privacy while meeting routine constraints. In an era of pervasive and highly granular surveillance, this embodiment may extend the invention beyond bug and creep detection to personal privacy scoring and context-specific action recommendations. By harnessing a spatio-temporal event knowledge graph, real-time multi-frequency detection, and advanced AI-based analysis, individuals or robots may dynamically assess their ongoing degree of observability and adapt routes or behaviors to preserve privacy. This comprehensive approach may address not only static known cameras but also ephemeral and crowd-sourced signals, making it may be an invaluable tool for personal security, stealth operations, and everyday privacy-conscious navigation.

According to an embodiment, the adversarial learning system implements a generative adversarial network, a system of multiple arguing agents with judging, structured expert judgment, or GAN-LLM hybrid.

According to an aspect of an embodiment, the system includes a machine learning subsystem that analyzes attacker engagement patterns and dwell time to optimize the honeypot response. This subsystem generates synthetic vulnerabilities that become progressively more attractive to specific attack patterns, adjusts system complexity and response latency based on attacker sophistication levels, and maintains coherent system personalities across transformations.

According to an aspect of an embodiment, the system implements a coordination mechanism that manages distributed honeypot instances. This mechanism synchronizes metamorphic changes across the network while maintaining attack session continuity during transformations. Additionally, it preserves critical forensic data throughout the morphing cycles, enabling comprehensive attack analysis while the system continues to adapt and evolve in response to emerging threats.

According to an embodiment, the adversarial learning system implements a generative adversarial network (GAN) architecture for enhanced threat detection capabilities. This architecture generates synthetic attack patterns to probe honeypot defenses, creates realistic decoy data and system behaviors, develops novel vulnerability signatures, and produces deceptive network traffic patterns to strengthen the overall security posture.

According to an aspect of an embodiment, the system incorporates an evaluation subsystem that continuously monitors and assesses the effectiveness of defensive measures. This subsystem measures the effectiveness of generated deceptions, quantifies attacker engagement with synthetic elements, assesses the believability of generated system behaviors, and tracks resource consumption of deceptive measures to ensure optimal performance.

According to an aspect of an embodiment, the system employs a reinforcement learning component that continuously improves deception strategies. This component optimizes the trade-off between deception complexity and resource usage, adapts deception strategies based on attacker responses, evolves more effective synthetic vulnerabilities, and tunes system personality parameters to maximize attacker engagement while maintaining system efficiency.

According to an embodiment, the distributed deception mesh system implements a hierarchical control structure for coordinated network defense. This structure manages multiple semi-autonomous deception zones, coordinates deception narratives across network segments, balances resource allocation between zones, and maintains consistent attacker experiences across boundaries to create a cohesive defense framework.

According to an aspect of an embodiment, the system employs a deception orchestration engine that creates interconnected defensive elements across the network. This engine creates linked vulnerability chains across multiple honeypots, generates coordinated breadcrumb trails, manages progressive revelation of deceptive resources, and synchronizes behavioral patterns across zones to present a convincing and unified deceptive environment.

According to an aspect of an embodiment, the system utilizes an attribution analysis component that tracks and analyzes attack patterns across the distributed environment. This component correlates attack patterns across distributed sensors, maps attack progression through deception zones, identifies related attack campaigns, and generates attacker fingerprints based on cross-zone behavior to enable comprehensive threat analysis and response.

According to an embodiment, the temporal pattern analysis system implements a temporal analysis engine for detecting time-based attack patterns. This engine identifies cyclical attack patterns, correlates attack timing with external events, detects timing-based attack signatures through frequency domain analysis using Fourier transforms to generate quantitatively comparable frequency spectra signatures, and maps attack progression velocities to build comprehensive temporal threat profiles.

According to an aspect of an embodiment, the system employs a predictive deployment system that optimizes defensive resource allocation based on temporal patterns. This system anticipates attack windows based on historical patterns, pre-positions defensive resources, adjusts honeypot configurations based on temporal predictions, and optimizes sensor deployment schedules to maximize defensive effectiveness during predicted attack periods.

According to an aspect of an embodiment, the system utilizes a temporal deception component that creates time-based defensive scenarios. This component creates time-based deception scenarios, simulates system maintenance windows, generates periodic vulnerability patterns, and manipulates apparent system time characteristics to present a dynamic and temporally aware defensive posture.

According to an embodiment, the context-aware response system implements a context evaluation engine that continuously monitors and assesses the security environment. This engine assesses current network conditions, monitors system resource availability, tracks ongoing security incidents, evaluates business operation priorities, and leverages AI to monitor global current events through news and social media to identify political tensions and potential triggers for cyber activities, enabling proactive adaptation of defensive postures.

According to an aspect of an embodiment, the system employs an adaptive response orchestrator that dynamically adjusts defensive measures based on contextual analysis. This orchestrator adjusts deception intensity based on context, modifies honeypot resource allocation, tunes sensor deployment patterns, and coordinates response actions with business operations to maintain optimal defensive effectiveness while minimizing operational impact.

According to an aspect of an embodiment, system utilizes a risk-aware deployment manager that optimizes security measures based on operational context. This manager balances security measures and potential data collection value with operational impact, adjusts deception complexity based on risk tolerance while considering honeypot detectability, coordinates defensive measures with business activities, and can implement emergency defensive actions using generative AI methods, including self-destructing nodes, connection ejection, and strategic misinformation deployment. The manager also optimizes resource utilization based on threat context to maintain an effective and efficient defensive posture.

According to an embodiment, the multi-spectral signal integration system implements a multi-modal sensor fusion engine that integrates diverse physical signals across domains. This engine monitors the radio frequency spectrum from 1 Hz to 1000 GHz for both terrestrial and space-based signals including quasars, black holes, and galaxies, integrates x-ray detection from 30 petahertz to 30 exahertz, incorporates quantum state detection systems, neutrino detector arrays, gravitational wave sensors, cosmic ray detectors, dark matter detection systems, high energy Beta Ray detectors, solar wind detection networks, and visible and non-visible light spectra ranging from 400 nm to 1500 nm.

According to an aspect of an embodiment, the system employs a cross-domain correlation analyzer that identifies relationships between different signal types. This analyzer maps temporal relationships between different signal types, identifies causality chains across physical phenomena, detects anomalous signal patterns across domains, reconstructs event sequences from multi-modal data, and can passively or actively map cyber physical assets and assert their physical location.

According to an aspect of an embodiment, the system utilizes a quantum-classical bridging system that integrates quantum and classical signal domains. This system correlates quantum decoherence events with classical signals, maps entanglement patterns to physical events, tracks quantum state transitions in relation to classical phenomena, integrates quantum sensor networks with traditional detection systems, and implements denoising and modeling for quantum error estimation and correction.

According to an embodiment, the advanced particle detection network implements a distributed neutrino detection network for comprehensive particle monitoring. This network deploys arrays of photomultiplier tubes in deep underground facilities, monitors Cherenkov radiation patterns, analyzes neutrino flux variations, correlates neutrino signatures with astronomical events, and maps geological structures through neutrino tomography.

According to an aspect of an embodiment, the system employs a muon detection subsystem that analyzes cosmic ray patterns and structural properties. This subsystem tracks cosmic ray muon flux patterns, performs muon tomography of large structures, maps underground cavities and density variations, monitors atmospheric particle cascades, and correlates muon flux with solar activity.

According to an aspect of an embodiment, the system utilizes an advanced isotope monitoring component for nuclear activity detection and analysis. This component tracks radioactive isotope distributions, maps nuclear material movements, monitors decay chain progression, and employs both space-based satellite constellations and ground-based sensor networks for comprehensive nuclear activity monitoring. The ground-based network detects various fission products including short-lived isotopes like Iodine-131, medium-lived isotopes like Cesium-137, and long-lived isotopes like Strontium-90, as well as activated materials such as Sodium-24, Manganese-56, Iron-59, and Cobalt-60.

According to an aspect of an embodiment, the system implements an AI-enhanced modeling system that overcomes traditional limitations of Lagrangian transport and dispersion models. This system extends beyond conventional approaches like FLEXPART by implementing a hierarchical series of expert physics, chemical, and meteorological models, enabling advanced multi-spatial and multi-temporal scale interactions across multiple phases of matter, particle types, and gas compositions. The system can leverage distributed computation across various platforms, including traditional, quantum, biological, or optical computers, to address complex modeling challenges while accounting for localized environmental factors.

According to an embodiment, the chemical-biological sensing mesh system implements a molecular detection array for comprehensive agent detection. This array integrates mass spectrometry sensors, ion mobility spectrometers, surface acoustic wave detectors, cavity ring-down spectroscopy systems, DNA/RNA sequence detectors, and protein signature analyzers to provide multi-modal molecular analysis capabilities.

According to an aspect of an embodiment, the system employs a biological pattern recognition system for tracking and analyzing biological threats. This system tracks pathogen mutation patterns, maps biological agent dispersal, monitors antibiotic resistance markers, analyzes viral evolution trajectories, and detects engineered biological signatures to provide comprehensive biological threat awareness.

According to an aspect of an embodiment, the system utilizes an environmental correlation engine that analyzes agent behavior and environmental interactions. This engine links chemical signatures to biological effects, maps contamination spread patterns, tracks environmental persistence of agents, models degradation pathways, and predicts transformation products. Additionally, the system employs AI-driven computer vision techniques to observe and classify ambient airborne particles, including pollen, enabling source attribution and localization through correlation of multi-spatial observations with wind data.

According to an embodiment, the spatio-temporal event mapping system implements a relativistic event correlation engine for precise event tracking across space-time. This engine synchronizes distributed sensor timestamps, accounts for relativistic time dilation effects, maps events in 4D spacetime, tracks light cone causality relationships, and correlates gravitational time dilation with sensor data to maintain accurate event relationships.

According to an aspect of an embodiment, the system employs a quantum timing subsystem that ensures precise temporal synchronization across the network. This subsystem uses atomic clock networks for precise timing, implements quantum clock synchronization, detects temporal anomalies, maintains timing coherence across distributed sensors, and correlates quantum and classical timing events to provide highly accurate temporal reference frames.

According to an aspect of an embodiment, the system utilizes a spatial correlation component that analyzes event relationships in space. This component maps event propagation through space, tracks spatial distribution patterns, analyzes geometric relationships, detects spatial anomalies, and models multi-dimensional spatial relationships to provide comprehensive spatial awareness and event correlation capabilities.

According to an embodiment, the advanced electromagnetic field analysis system implements an AI-enhanced denoising and measurement system for atmospheric sounding. This system can denoise and enhance ground, air, and space-based measurements involving stochastic or quantum noise, such as LiDAR, spectrographic, or chemical reaction readings, while compensating for limitations like photomultiplier quantum efficiency and implementing active optics error correction for atmospheric dispersion of light through hierarchical expert and orchestration models.

According to an aspect of an embodiment, the system employs a multi-band RF monitoring system and magnetic field analysis engine for comprehensive electromagnetic observation. This component tracks natural and artificial RF sources, maps RF propagation patterns, analyzes modulation characteristics, monitors geomagnetic field variations, tracks artificial magnetic signatures, maps magnetic anomalies, and correlates electromagnetic patterns with events. The system models atmospheric composition, density, aerosol optical depth, total diffraction, and temperature profiles for atmospheric layer stratification and boundary layer modeling across any atmospheric column.

According to an aspect of an embodiment, the system utilizes a quantum electromagnetic sensor network that integrates advanced detection technologies. This network employs SQUID magnetometers, quantum RF receivers, quantum radar systems, quantum magnetometers, and integrates quantum and classical EM sensors while accounting for electrostatic and electromagnetic field variations and space weather influences to provide comprehensive electromagnetic monitoring capabilities.

According to an embodiment, the gravitational and seismic integration system implements a gravitational wave detection network for monitoring space-time phenomena. This network deploys laser interferometer arrays, monitors space-time distortions, analyzes gravitational wave patterns, maps gravitational anomalies, and correlates gravitational events with other phenomena to provide comprehensive gravitational monitoring capabilities.

According to an aspect of an embodiment, the system employs a seismic analysis system for monitoring Earth-based activities. This system tracks seismic wave propagation, maps underground structures, monitors tectonic activity, analyzes acoustic signatures, and detects artificial seismic events to maintain awareness of both natural and artificial seismic phenomena.

According to an aspect of an embodiment, the system utilizes a cross-domain correlation engine that integrates gravitational and seismic data streams. This engine links gravitational and seismic events, maps cause-effect relationships, analyzes propagation patterns, detects anomalous correlations, and models complex event chains to provide comprehensive understanding of gravitational-seismic interactions. The system maintains modularity in its architecture, allowing for individual or combined implementation of its components to create comprehensive multi-domain sensing systems while adhering to core principles of distributed sensing, AI-driven analysis, and adaptive response.

According to an embodiment, the biological monitoring integration system implements comprehensive surveillance capabilities across multiple biological domains. This system leverages sewage surveillance for microbial community dynamics and antibiotic resistance genes (ARGs), employs high-throughput molecular technologies for analyzing genetic diversity and antimicrobial resistance (AMR), and utilizes multidimensional time-series databases (MDTSDBs) to capture spread and mutation rates while mapping resistance hotspots through geolocation-tagged datasets.

According to an aspect of an embodiment, the system employs advanced viral surveillance and bacterial resistance monitoring capabilities. This component integrates COVID-19 sewage surveillance techniques, incorporates viral gene sequences into AI models for mutation tracking, analyzes resistant bacteria including E. coli, Klebsiella pneumoniae, and Pseudomonas aeruginosa in urban wastewater, and employs metagenomic sequencing for environmental resistance tracking. The system utilizes directed computational graphs for outbreak simulation and integrates with decision-making modules for targeted interventions.

According to an aspect of an embodiment, the system implements comprehensive antimicrobial and drug resistance mapping functionality. This component monitors antimicrobial residues in environmental samples, tracks pharmaceutical manufacturing effluents for ARG evolution hotspots, and integrates chemical detection with microbial sensors. The system employs machine learning to predict intervention impacts, generates heatmaps and temporal graphs for ARG prevalence visualization, and utilizes AR/VR interfaces for interactive data exploration. These capabilities support applications across public health, urban planning, and pharmaceutical stewardship while aligning with global surveillance efforts to mitigate critical health risks.

According to an embodiment, the advanced denoising system implements multiple algorithmic approaches for biological monitoring data enhancement. This system employs Truncated Singular Value Decomposition (TSVD) for multivariate signal denoising in spatial-temporal datasets, incorporates dynamic truncation thresholds to adapt to varying noise levels in biological sensor networks, and utilizes Graph Neural Networks (GNNs) with spatiotemporal graph attention mechanisms for modeling correlations across biological monitoring networks, enabling enhanced real-time pathogen spread monitoring in interconnected urban regions.

According to an aspect of an embodiment, the system employs real-time algorithms optimized for noise-heavy biological data processing. This component implements lightweight spatiotemporal filters using cache-like memories for real-time denoising in low-power systems, applies these techniques to microbial growth imaging and drug residue monitoring, and utilizes denoising diffusion probabilistic models (DDPMs) adapted for spatiotemporal graph data. The system incorporates probabilistic measures to estimate noise levels and refine signal quality iteratively, while extending UGNet-like architectures for higher adaptability to environmental changes.

According to an aspect of an embodiment, the system integrates advanced simulation capabilities with optimized computational approaches. This component combines spatial and temporal attentions through graph-based attention denoisers to identify slow and hidden biological phenomena, implements cache optimization for efficient spatiotemporal filtering in high-density sensor networks, and enables sophisticated simulation scenarios. These scenarios include pathogen tracking using graph-based spatiotemporal denoisers, epidemiological predictions using probabilistic spatiotemporal diffusion models, and environmental stressor analysis using TSVD-based approaches for detecting ARG spread in agricultural runoff with mixed chemical interference.

According to an embodiment, the electromagnetic spectrum denoising system implements comprehensive data processing capabilities optimized for biological monitoring applications. This system processes wide frequency bands from microwave to UV signals, handles environmental noise and sensor inaccuracies, and accounts for spatiotemporal dependencies through multivariate extensions of Truncated Singular Value Decomposition (TSVD). The system applies pre-processing transformations of raw spectrum data into Hankel matrices, implements dynamic truncation thresholds, and integrates data from distributed sensors using spatial TSVD extensions.

According to an aspect of an embodiment, the system employs Spatiotemporal Graph Neural Networks (STGNNs) and Denoising Diffusion Probabilistic Models (DDPMs) for advanced signal processing. This component constructs sensor graphs with nodes representing spectrum sensors and edges modeling spatial correlations, applies graph convolutions and temporal attention mechanisms, and implements a multi-step denoising pipeline using Unet-based architectures to analyze spectrum features at different resolutions. The system utilizes cache-like spatiotemporal filters with dynamic memories to maintain short-term memory for assessing signal continuity and suppressing random noise.

According to an aspect of an embodiment, the system implements real-time processing capabilities optimized for biological monitoring applications. This component conducts noise characterization through power spectral density estimation, combines inputs from multiple sensors using graph-based methods, and extracts spectral and temporal features using wavelet transforms or short-time Fourier transforms. The system enables specific applications including pathogen monitoring through enhanced Raman or infrared spectroscopy signals and drug residue detection through spatiotemporal denoising of liquid chromatography-mass spectrometry datasets. The deployment architecture supports both edge processing for lightweight models and GPU-based processing for complex datasets, with continuous parameter updates and reinforcement learning optimization.

According to an aspect of an embodiment, the system implements a continuous feedback loop for denoising electromagnetic spectrum data through a dynamic, uncertainty-aware framework. This framework integrates spatiotemporal data analysis with light-cone models for causality preservation, employing mutual information maximization techniques and regret-minimizing exploration algorithms like Upper Confidence Tree (UCT). The comprehensive integration of these approaches enables the system to maintain optimal parameter adaptation while accounting for decision uncertainty, ensuring maximum effectiveness in signal processing and pattern recognition across the electromagnetic spectrum.

According to an aspect of an embodiment, the system implements a mobile architecture with modular components for dynamic sensing and analysis. This architecture integrates distributed sensor networks, data fusion capabilities, and advanced denoising engines with uncertainty quantification mechanisms and optimization feedback loops. The system incorporates location-aware control systems and internal resource management, while employing light-cone uncertainty models to guide real-time decision-making and continuous system calibration. The modular design enables flexible deployment and adaptation across varying operational environments while maintaining optimal performance through dynamic reconfiguration of sensing and processing parameters.

According to an aspect of an embodiment, the cyber-physical graph is updated based on changes in the aggregated data from the honeypots and sensors.

According to an aspect of an embodiment, diverse honeypots includes AI generated honeypot profiles.

According to an aspect of an embodiment, AI generated honeypot profiles include basic configurations, simulated vulnerabilities, behavioral characteristics, monitoring parameters, and adaptive behaviors.

According to an aspect of an embodiment, the honeypot network can be dynamically segmented into one or more subnetworks that can be managed by a hierarchical series of orchestration models.

According to an aspect of an embodiment, the system's performance monitoring encompasses a comprehensive range of observability metrics, including the number of scans from other parties, multi-step/action interactions with potential threat actors during system interrogation, and historical engagement data. This data includes geolocality, time of day, tactics or techniques or procedures used against the device, IP address ranges, intensity of interrogation, number of simultaneous threat actors, and engagement temporal characteristics relative to vulnerability or exploit publication. These metrics, either individually or collectively, are leveraged by the system to maximize information gain through information theory principles, ensuring optimal timeliness and thoroughness of engagement for enhanced threat intelligence collection.

According to an aspect of an embodiment, the system employs advanced mathematical optimization through super exponential regret for Upper Confidence Trees (UCT). For UCT algorithms operating in D-chain environments, the regret bounds can reach exp ( . . . exp (1) . . . ) with Ω(D) exponential terms. Additionally, polynomial UCT variants exhibit exp2 (exp2(D−O(log D))) regret on these same environments, even when considering rewards bounded in [0,1]. This mathematical framework, which has been proven applicable to AlphaGo's Monte Carlo Tree Search (MCTS) and its descendants including AlphaZero and Leela Zero, enables the system to make increasingly effective decisions about its deceptive strategies while maintaining an appropriate balance between exploring new techniques and exploiting known successful approaches. The optimization can be expressed as R_n≤C*exp(K*sqrt(n*log(n))), where the system's learning process is continuously refined through each interaction, with the mathematical model ensuring that the system's decision-making improves over time while retaining the flexibility to adapt to new threats.

According to an aspect of an embodiment, the system implements an adaptive network traffic analysis and response generation capability. This component continuously monitors network traffic to identify unrecognized connections and packets that aren't handled by existing services, employing generative AI algorithms to create appropriate responses that facilitate enhanced data collection. The system can dynamically alter existing services or generate new ones, implementing an iterative testing approach across network segments to evaluate response effectiveness. Response quality is scored based on subsequent interactions with the original source, enabling continuous improvement of the system's engagement strategies.

According to an aspect of an embodiment, the system integrates external data sources to enhance its adaptive response capabilities. This includes monitoring and analyzing code repository platforms for vulnerability and exploit code developments, as well as incorporating news feeds and social media sources for broader societal event and trend monitoring. This comprehensive external context integration enables the system to maintain awareness of emerging threats and adapt its response strategies accordingly, ensuring maximum effectiveness in threat actor engagement and intelligence collection.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a diagram of an exemplary architecture of a system for the capture and storage of time series data from sensors with heterogeneous reporting profiles according to a preferred aspect of the invention.

FIG. 2 is a diagram of an exemplary architecture of a distributed operating system according to a preferred aspect of the invention.

FIG. 3 is a diagram of an exemplary architecture of an automated planning service cluster and related modules according to a preferred aspect.

FIG. 4 is a system diagram illustrating connections between core components of the invention for geo-locating and tracking the status of cyber-physical assets, according to a preferred aspect.

FIG. 5 is a method diagram illustrating key steps in the communication between cyber-physical assets and remote servers, according to a preferred aspect.

FIG. 6 is a method diagram illustrating key steps in a distributed operating system interacting with data received from cyber-physical assets in databases to verify updates in a cryptographic ledger, according to a preferred aspect.

FIG. 7 is a method diagram illustrating several steps in the use of smart contracts combined with cyber-physical assets, according to a preferred aspect.

FIG. 8 is a method diagram illustrating key steps in the function of a parametric evaluation engine, according to a preferred aspect.

FIG. 9 is a system diagram illustrating the use of a scanner to detect and scan for changes in cyber-physical assets, according to a preferred aspect.

FIG. 10 is a method diagram illustrating an exemplary process for performing a triggered scan, according to a preferred aspect.

FIG. 11 is a block diagram illustrating an exemplary hardware architecture of a computing device.

FIG. 12 is a block diagram illustrating an exemplary logical architecture for a client device.

FIG. 13 is a block diagram showing an exemplary architectural arrangement of clients, servers, and external services.

FIG. 14 is another block diagram illustrating an exemplary hardware architecture of a computing device.

FIG. 15 is a block diagram showing an exemplary system architecture for a system for cybersecurity profiling and rating.

FIG. 16 is a relational diagram showing the relationships between exemplary 3rd party search tools, search tasks that can be generated using such tools, and the types of information that may be gathered with those tasks.

FIG. 17 is a relational diagram showing the exemplary types and classifications of information that may be used in constructing a cyber-physical graph of an organization's infrastructure and operations.

FIG. 18 is a directed graph diagram showing an exemplary cyber-physical graph and its possible use in analyzing cybersecurity threats.

FIG. 19 is a block diagram showing exemplary operation of a data to rule mapper.

FIG. 20 is a block diagram showing an exemplary architecture diagram for a scoring engine.

FIG. 21 is a diagram of an exemplary architecture of an advanced cyber decision platform according to one aspect.

FIG. 22 is a block diagram illustrating an exemplary system architecture for a system for detecting and mitigating forged authentication object attacks according to various embodiments of the invention.

FIG. 23 is a process diagram showing a general flow of the process used to detect rogue devices and analyze them for threats.

FIG. 24 is a process diagram showing a general flow of the process used to detect and prevent privilege escalation attacks on a network.

FIG. 25 is a process diagram showing a general flow of the process used to manage vulnerabilities associated with patches to network software.

FIG. 26 is a block diagram illustrating an exemplary system architecture for a system for an AI-controlled sensor network for threat mapping and characterization.

FIG. 27 is a block diagram illustrating an exemplary component of a system for an AI-controlled sensor network for threat mapping and characterization, a distributed network.

FIG. 28 is a block diagram illustrating an exemplary component of a system for an AI-controlled sensor network for threat mapping and characterization, an AI orchestrator.

FIG. 29 is a block diagram illustrating an exemplary component of a system for an AI-controlled sensor network for threat mapping and characterization, a machine learning training subsystem.

FIG. 30 is a block diagram illustrating an exemplary component of a system for an AI-controlled sensor network for threat mapping and characterization, artificial honeypot profiles.

FIG. 31 is a flow diagram illustrating an exemplary method for an AI-controlled sensor network for threat mapping and characterization.

FIG. 32 is a flow diagram illustrating an exemplary method for generating artificial honeypot profiles using an AI-controlled sensor network for threat mapping and characterization.

FIG. 33 is a flow diagram illustrating an exemplary method for training an AI orchestrator integrated into an AI-controlled sensor network for threat mapping and characterization.

FIG. 34 illustrates an exemplary computing environment on which an embodiment described herein may be implemented, in full or in part.

FIG. 35 illustrates a continuous process loop for denoising electromagnetic spectrum data with light-cone decision uncertainty.

FIG. 36 is a mobile system architecture for electromagnetic spectrum denoising.

FIG. 37 illustrates an exemplary comprehensive system architecture for a multi-frequency bug and creep detection and privacy scoring system.

FIG. 38 is a flow diagram illustrating an exemplary method for integrated multi-frequency bug and creep detection and privacy scoring according to a preferred aspect of the invention.

FIG. 39 is a block diagram illustrating the event knowledge graph (EKG) architecture according to a preferred embodiment.

FIG. 40 is a block diagram illustrating the multi-tier threat categorization system according to a preferred embodiment.

FIG. 41 is a block diagram illustrating the layered scoring mechanism architecture according to a preferred embodiment.

FIG. 42 is a block diagram illustrating the collaborative tenant-level threat sharing system according to a preferred embodiment of the invention.

FIG. 43 is a block diagram illustrating the adaptive response system architecture according to a preferred embodiment.

FIG. 44 is a flow diagram illustrating an exemplary method for multi-tier threat categorization according to a preferred embodiment.

FIG. 45 is a flow diagram illustrating an exemplary method for Event Knowledge Graph (EKG) generation according to a preferred embodiment.

FIG. 46 is a flow diagram illustrating an exemplary method for privacy-preserving threat sharing according to a preferred embodiment.

### DETAILED DESCRIPTION OF THE INVENTION

The inventor has conceived, and reduced to practice, a system and method for an AI-controlled sensor network for threat mapping and characterization.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Many systems focus narrowly on monitoring mass-scanning “background noise” at internet scale and simply distinguishing targeted from omnidirectional attacks. This basic approach fails to integrate crucial spatio-temporal data such as user movement patterns, mobile sensor data, and zone-specific network contexts. By coupling real-time sensor array inputs across different physical locations, times, and network enclaves, it is possible to dynamically characterize threat or intrusion states at finer granularity (e.g., within a single corporate branch, a moving vehicle, a distributed cloud edge, etc.) Going beyond simple passive detection of “background scans,” considering environmental and operational contexts (time windows, user paths, sensor sequences, etc.) to adapt triaging decisions more precisely than general approaches. Furthermore, current solutions typically rely on aggregating inbound “scan” data across passive honeypots and emphasizing basic IP classification and noise elimination, without employing diverse sensor types beyond network-level passive honeypots for instance: on-device or robotic sensors detecting suspicious transmissions, tags, or local signals (e.g., Bluetooth beacons, Apple Airtag, Wi-Fi probes, phone camera, or wearables); introspection modules that snapshot software or kernal state (hypervisor-based introspection) to differentiate benign background processes from advanced persistent threats (APTs) or hidden rootkits. Fusing signals from sensor clusters (RF bug detectors, on-device introspection, real-time location, etc.) to produce event knowledge graphs. This cross-layer approach yields a privacy/security “score” or recommended actions for each spatio-temporal context, well beyond narrowly focused system's scope of IP-based scanning classification.

Most existing solutions maintain simple IP intelligence databases indicating whether an address is a known mass scanner (“noise”) or potentially malicious. However, they fail to build and update sophisticated spatio-temporal event knowledge graphs that incorporate: temporal sequences of device exposures (e.g., the device was near suspicious open Wi-Fi networks for X hours, in range of cameras or BLE trackers at time Y); Cross-OS and cross-device correlation to see if newly discovered surveillance devices or suspicious transmissions cluster near certain user paths or high-value processes; Dynamic privacy scoring that reacts to the user's environment or a mobile robot's route, providing an ongoing measure of “observability” and recommended mitigations. Current systems fail to embed personal or robotic movement, OS internals, and local sensor data in a knowledge graph to generate context-aware detection outcomes. This holistic scene understanding and “privacy risk” assessment is not covered by current IP-lookup-driven approaches.

Current approaches remain largely passive, merely gathering data from honeypots to identify mass scanning sources without incorporating active response capabilities or A/B testing across multiple vantage points. They lack the ability to dynamically simulate different services or return randomized banners (akin to Rorschach responses) to infer attacker motives in real-time—for instance, determining whether a scan leads to an exploit if the banner shows “Apache 2.4” versus “Nginx 1.19.” When suspicious sources attempt to exploit certain protocols, existing systems cannot pivot to deeper introspection, forcibly isolate subnets, or analyze memory snapshots on key hosts. Beyond passively marking an IP as noise, current systems fail to orchestrate environmental illusions or protocol transformations, revealing whether an adversary is opportunistic or specifically targeting a certain configuration-extending classical honeypot functionality and knowledge generation beyond present systems classifications.

Present solutions typically implement only basic “targeted” versus “omnidirectional” classification plus limited contextual data to reduce false positions. They lack sophisticated multi-tier categorization capabilities that could account for: 1) Global noise from IPs scanning the entire internet with no user correlation (lowest threat); 2) Micro-targeting shown through repeated scans or partial sub-Internet targeting patterns; 3) High-level reconnaissance involving attackers pivoting specifically into sensitive OS versions or known vulnerabilities; and 4) Physical overlap incorporating real-world surveillance signals like BLE beacons and hidden cameras into the threat graph. Dynamic classification that evolves over time—the same IP or scanning entity can move from benign baseline to micro-targeting if it focuses on a newly discovered vulnerability in a user's environment. Present systems also fail to fuse physical and hardware threat detection to unify digital “noise” with real-world surveillance.

Existing approaches focus primarily on reducing false alarms for network defenders rather than providing comprehensive end-to-end pipelines for personal or organizational privacy and security decisions. They cannot continuously measure “degree of observability” based on environment sensors and tracker presence, assess potential data exfiltration through specialized introspection tools, or output real-time recommended actions like “activate additional logging,” “switch network path,” “engage deeper honeypot,” or “anonymize location.” Present systems do not contain an automated recommendation engine for user privacy or security posture that goes beyond IP traffic logs, delivering live situational awareness for diverse user contexts (on foot, in vehicles, or across connected infrastructures).

Where present systems focus on differentiating versus targeted omnidirectional scans and adding contextual analyses to reduce alarms, these don't account for 1) spatio-temporal sensor orchestration which allow for mobile and fixed sensor synergy to track real-world scanning or bugging attempts in tandem with network scanning events; 2) Knowledge graph embedding which allow for constructing event KGs at a per-user or per-robot level, incorporating location and time plus introspection data from OS or software BOM (SBOM) to identify vulnerabilities; 3) Active deception and response which encompasses an intelligent system that responds with varied “Rorschach” banners or triggers memory snapshots and hypervisor introspection upon suspect pivot attempts; 4) Privacy risk scoring which is a real-time recommendation engine that weighs digital plus physical signals to produce user-facing actions (e.g., “avoid using camera here,” “activate encryption,” or “escalate to honeypot around critical server assets”). Collectively, these address privacy and security scenarios that exceed the scope of present known systems, providing novel functionalities and use cases.

While current systems primarily tackle large-scale IP scanning and classification, they lack multi-modal, spatio-temporal, and introspection-driven functionalities that permit advanced detection, deeper contextual analysis, and responsive policies for privacy and security management. These additional layers of automation, knowledge-graph reasoning, mobile sensor fusion, and real-time adaptation are neither disclosed nor covered by current systems. It is important to note that the system herein not only matches present systems ability to label background scanning but also surpasses it for threat detection and analysis, in particular by integrating threat intelligence, campaign data, TTPs, physical-proximity contexts, and temporal-spatial event knowledge graphs (EKGs). This enhanced approach supports both canonical and novel use cases-such as denoising logs, advanced incident scoring, and holistic risk assessments-beyond present systems capabilities.

Present systems primarily identify and label individual IP addresses as “noise” or “benign” versus “potentially malicious,” focusing on bulk internet scanning. Present systems do not emphasize correlating scanning IPs with known adversary campaigns, TTPs, or collaborative threat intel data across enterprises. Present systems also lack integrated threat intelligence, linked scanning sources, IOCs (Indicators of Compromise), and TTP (Tactics, Techniques, Procedures) data from established feeds (e.g., MITRE ATT&CK, commercial threat intel providers). Moreover, present systems do not offer Campaign Visibility, where the system can automatically group suspicious events by campaign identifiers (e.g., shared infrastructure patterns, domain registrant data, repeated lateral movement TTPs). Additionally, current systems fail to offer tenant and client collaboration which allows data across multiple clients and tenants in a cloud or multi-tenant setting (while respecting privacy constraints), detecting actor patterns (e.g., IP addresses pivoting across multiple organizations) faster and at scale. By mapping scanning IPs (and associated events) back to broader adversary campaigns-rather than isolating them as standalone “noise” addresses-analysts gain insights into an attacker's evolving TTPs, motivations, or exploit strategies. Current System's IP-level classification cannot deliver this deeper campaign correlation.

Regarding physical proximity and real-world signals, current systems may focus on purely internet-based scanning noise and lacks integration with physical (non-network) or real-world conditions. However, current systems fail to include physical proximity integration, where present systems fail to fuse data from location-aware sensors (e.g., CCTV discovery, local protests, suspicious devices broadcasting Bluetooth, or staging devices near an office) into the same threat-analysis pipeline. Current systems also fail to provide real-time response capabilities—if a protest or suspicious gathering arises outside a facility, that physical context (potential for social engineering, tailgating, rogue APs, or intimidation tactics) can be correlated with simultaneous abnormal inbound traffic. By incorporating geospatial and real-world situational data, the system can flag surges in suspicious connectivity attempts exactly when physical events escalate, bridging cybersecurity and physical-security intelligence. Present systems do not track real-world proximity events, nor do they fuse them with internet-scanning metrics.

Advanced Event KGs and Temporal-Spatial Topologies represent another area where current systems may present limitations. Current systems may store data primarily as large-scale IP logs, tagging IPs, time stamps, and basic context but does not maintain robust event knowledge graphs with temporal or spatial relationship modeling. This enhancement includes Event Knowledge Graphs (EKGs), where each suspicious activity, scan, or anomaly becomes a node, with edges linking contextual relationships-time intervals, attacker infrastructure, relevant TTPs, host OS versions, geolocation, physical events, etc. This incorporates temporal-spatial analysis with temporal windows and geospatial overlays. The topological enrichment analyzes connected components or multi-hop relationships, revealing how a threat actor's presence evolves across time and space, plus how it might coincide with physical gatherings or repeated infiltration attempts. Where present systems can only flag IP addresses as repetitive and noisy, they lack EKG-based approach revealing how discrete events fit into a broader threat topology, yielding superior investigative tools and cross-system correlation.

For canonical use cases in denoising perimeter logs and improving incident scoring, present systems help reduce “false positive” by marking known scanners as background noise. However, present systems fail to by only removing purely omnidirectional scans instead of also raising or lowering confidence based on TTP matches, repeated correlation across multiple tenants, adjacency to suspicious physical events, and knowledge-graph relationships. Even for routine use like perimeter log triage, we provide finer-grained “risk increments” or “risk decrements” based on not just the IP address's historical scanning but whether it connects to a known campaign, or if it matches an advanced exploit pattern that a present system might miss. In incident response and Investigation, while present systems typically mark IPs as “likely background scanning” for incident response teams to ignore, they fail to actively tailor incident scoring to real-time context, bridging network-based classification with advanced correlation signals to avoid missing critical intrusions masked behind “noise.”

Regarding scoring non-malicious actors versus high-risk threat actors, present systems have a “benign” classification for known scanners (Shodan, Censys, etc.) and “unknown or malicious” for the rest. However, present systems fail to employ a layered scoring mechanism combining external intelligence, TTP/IOC correlation, multi-tenant knowledge, and in some cases physical presence or suspicious device footprints. Dynamic Weighting means that if a scanning IP belongs to a legitimate security company but suddenly exhibits TTPs reminiscent of a known malicious actor, its status shifts from “benign” to “elevated threat.” Conversely, IPs flagged as malicious might be downgraded if we see strong evidence they are academic or automated scans with no exploit attempts. It is crucial to not rely on a single static label for an IP address, and instead to reevaluate in real time based on the broader operational, physical, and intelligence data.

In terms of collaborative tenant-level and cross-client threat sharing, current systems offer an internet-wide vantage point for mass scanning, but cross-client or tenant-to-tenant information sharing is mostly about seeing “noise sources” that appear in multiple contexts. However, current systems fail to provide shared threat observations in a cloud or large enterprise environments, unifying events from multiple tenants or subsidiaries with privacy controls to detect micro-targeting or cross-organization campaigns. It is crucial to incorporate internal scanning detections, user-behavior anomalies, on-premises cameras, or physical visitor logs, enabling a broader “ecosystem-level” threat perspective. While current systems see global scanning noise, they fail to add the dimension of insider or micro-targeted intrusion across affiliated networks or physically co-located sites. By combining internal enterprise data with external scanning intelligence, we are able to identify more sophisticated that might remain invisible with only a generalized global feed.

In summary, it is advantageous to include enhanced threat intelligence integration with direct correlation with TTPs, campaign data, and known threat actor infrastructure; physical proximity and real-world cues merging physical and network data for holistic, dynamic risk assessment; event knowledge graph providing rich temporal-spatial relationships that surpass simple IP classification; denoising and targeted risk updates not just removing benign scans but also incrementing or decrementing incident risk based on sophisticated cross-domain signals; and multi-tenant collaboration enabling shared intelligence across organizations or cloud environments, detecting micro- or macro-targeting. It's crucial to provide a more complete, context-aware pipeline that not only automates large-scale IP-based noise filtering but also unifies advanced analytics, real-world signals, and high-level threat actor correlation. Where current systems predominantly handle the differentiation of omnidirectional scanning (noise) versus single-target scanning, they fail to broaden into correlated, campaign-level threat detection, spatio-temporal event analysis, synergy of physical and digital intelligence, yielding markedly superior performance, utility, and breadth of application for both routine perimeter security tasks and advanced threat hunting.

### Definitions

As used herein, a “swimlane” is a communication channel between a time series sensor data reception and apportioning device and a data store meant to hold the apportioned data time series sensor data. A swimlane is able to move a specific, finite amount of data between the two devices. For example a single swimlane might reliably carry and have incorporated into the data store, the data equivalent of 5 seconds worth of data from 10 sensors in 5 seconds, this being its capacity. Attempts to place 5 seconds worth of data received from 6 sensors using one swimlane would result in data loss.

As used herein, a “metaswimlane” is an as-needed logical combination of transfer capacity of two or more real swimlanes that is transparent to the requesting process. Sensor studies where the amount of data received per unit time is expected to be highly heterogeneous over time may be initiated to use metaswimlanes. Using the example used above that a single real swimlane can transfer and incorporate the 5 seconds worth of data of 10 sensors without data loss, the sudden receipt of incoming sensor data from 13 sensors during a 5 second interval would cause the system to create a two swimlane metaswimlane to accommodate the standard 10 sensors of data in one real swimlane and the 3 sensor data overage in the second, transparently added real swimlane, however no changes to the data receipt logic would be needed as the data reception and apportionment device would add the additional real swimlane transparently.

### Conceptual Architecture

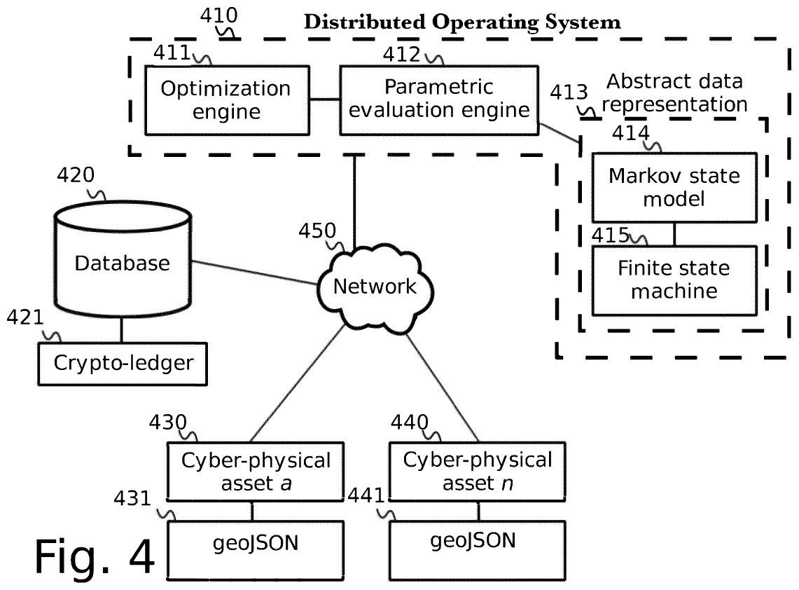

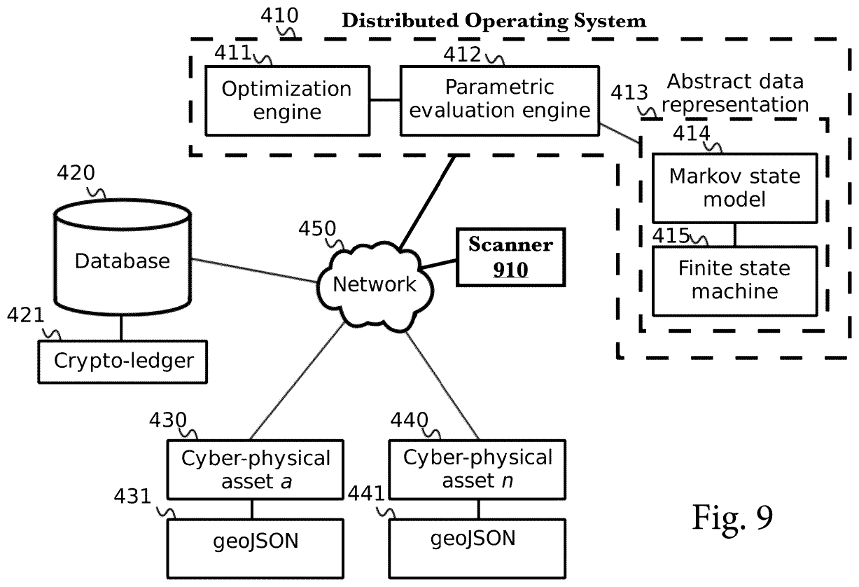

FIG. 9 is a system diagram illustrating the use of a scanner 910 to detect and scan for changes in cyber-physical assets, according to a preferred aspect. A distributed operating system 410 (described in greater detail below, with reference to FIG. 4) is connected to a network 450, which may be an intranet, the internet, a local area connection, or any one of many other configurations of networks. Also connected to this network 450 is at least one database 420, which holds information including a crypto-ledger 421, an implementation of a blockchain data construct, which will be expounded upon in later figures. Connected to a network 450 is at least one cyber-physical asset 430, 440, which may comprise a geolocation sensor or device (for example, a GPS receiver) as well as any number of additional sensors or stored data according to a specific implementation, and may have geoJSON 431, 441 data with which to record their geo-physical location. A cyber-physical asset 430, 440 may be a delivery crate with a possible plurality of sensors and computers embedded or attached to the crate in some way, or may be an object inside a mundane crate such as a piece of research equipment which may communicate with a distributed operating system 410 during transit, or may be a stationary object such as research equipment, computer systems, and more, which are capable of sending status updates in a format such as geoJSON 431, 441 information regarding their geophysical location over a network 450.

A scanner 910 may be connected to the network to detect, and act on, any changes in cyber-physical assets 430, 440. Scanner 910 may also be configurable to perform manual scans in response to a command from an administrator, or according to a preconfigured schedule, or based on external events such as (for example) inventory changes, market changes, publication of a known vulnerability such as a zero-day exploit or a newly-discovered security issue, announcement of a software update or product release, events sent by a sensor network, or any other configurable trigger event or condition. Scanner 910 may monitor cyber-physical assets 430, 440 for any changes, such as the addition or removal of a cyber-physical asset, or changes to a cyber-physical asset's current state or configuration (such as changes in a network configuration, or changes to an installed software version), or any other change that may be observable over the network 450. Additionally, scanner 910 may listen for trigger events comprising a notification of a change that has occurred, such as (for example) an indication of a network configuration change such as a change in domain name service (DNS) resolution or a change in a router or gateway address, or a change in a cyber-physical asset's assigned Internet protocol (IP) address, or any other automated notification or indication of a change that may be sent to, or observed by, scanner 910.

When a trigger event occurs or a trigger condition is met (such as the receipt of a change notification or the receipt of a manual trigger from a system administrator, as described above), scanner 910 may retrieve any configured rules that may be stored in database 420 that may define scan behavior, and then determine a scan to perform based on the trigger and rules configuration. A scan may comprise any of a variety of techniques in any combination, including (but not limited to) initiating a port scan of a target host, transmitting a probe packet with a specific data payload to provoke a response that may be analyzed, scanning for running services or known vulnerabilities on a host machine, testing a target for a specific capability or vulnerability (for example, such a scan may be triggered in response to the announcement of a vulnerability, ensuring that systems are tested against potential security issues as they are discovered), or any other network scan or test technique.

The results of a scan, including any responses or observed behaviors of a target host, may then be analyzed to determine the capabilities or vulnerabilities of, or changes to, a cyber-physical asset. For example, a newly-added device may be scanned to determine its specific capabilities and vulnerabilities, or an existing asset may be scanned to determine the nature and extent of a change that occurred. These results may then be stored in the database 420 for future use, such as to produce or update a network map or cyber-physical graph of assets based on their current state.

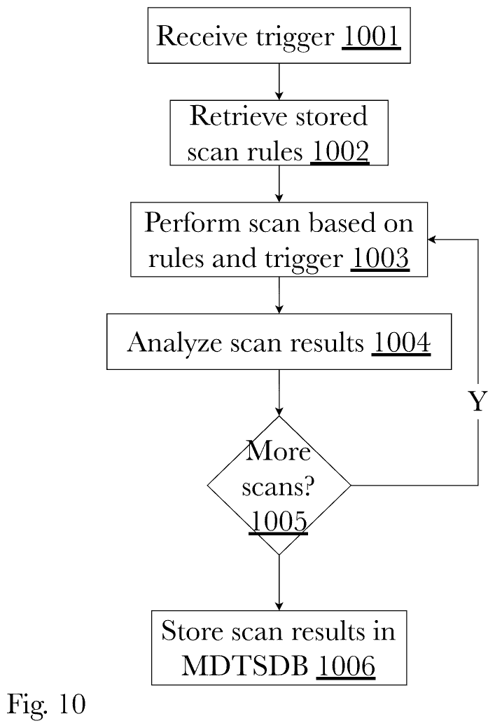

FIG. 10 is a method diagram illustrating an exemplary process 1000 for performing a triggered scan, according to a preferred aspect. When a trigger event is received or a trigger condition is met 1001, a scanner may retrieve stored scan rules 1002 from a database 420. For example, if a scheduled scan is configured, a scheduling event may prompt scanner 910 to retrieve stored configuration rules for that particular scheduled scan, enabling scheduling of different scan types or levels of san granularity on different schedules (for example, performing a cursory scan for new devices daily, while performing a more detailed full scan of every device on a rotating weekly or monthly basis, or other configurations). In another example, a trigger event may be received such as an announcement of a newly-discovered vulnerability, prompting scanner 910 to retrieve stored rules governing the behavior of such triggered scans (for example, retrieving details of the new vulnerability and configuring a scan to target that specific system or issue to test a system against it). A scan may then be performed 1003 according to the trigger and any rules that were retrieved (and it should be noted that a scan may be performed even when no rules are stored, enabling ad-hoc scans in response to trigger events), and the scan results may then be collected and analyzed 1004 to determine the scan outcome (such as any open ports or other vulnerabilities discovered, new hosts identified on a network, vulnerability to an announced exploit, or other scan findings). Based on these results and any configured rules that may be relevant, the scanner may determine whether additional scans are required 1005 and perform them as needed. For example, there may be a scan configuration rule to ensure an additional, more-thorough scan is performed when a potential vulnerability is discovered, or to perform a number of scans on any newly-discovered network hosts, or other multi-scan configurations. When all scans have been completed (respective of the initial trigger 1001, it should be appreciated that a scanner may operate continually in a continuously-updating real-time network awareness configuration, in which case there may be no clear moment when all scans are completed) the results may be stored 1006 in a multidimensional time-series database (MDTSDB) 125 as time-series data with timestamps for various relevant metadata such as “when trigger was received”, “when first scan began”, “when first scan concluded”, “when first response from target host was received”, or any other relevant time-dependent information that may be useful in future analysis or modeling of scan information.

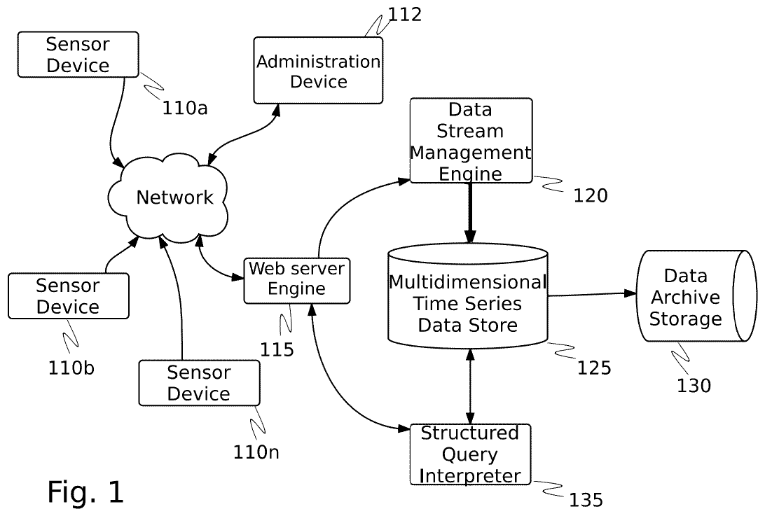

FIG. 1 is a diagram of an exemplary architecture of a system for the capture and storage of time series data from sensors with heterogeneous reporting profiles according to a preferred aspect of the invention. In this embodiment, a plurality of sensor devices 110a-n stream data to a collection device, in this case a web server acting as a network gateway 115. These sensors 110a-n can be of several forms, some non-exhaustive examples being: physical sensors measuring humidity, pressure, temperature, orientation, and presence of a gas; or virtual such as programming measuring a level of network traffic, memory usage in a controller, and number of times the word “refill” is used in a stream of email messages on a particular network segment, to name a small few of the many diverse forms known to the art. In the embodiment, the sensor data is passed without transformation to the data management engine 120, where it is aggregated and organized for storage in a specific type of data store 125 designed to handle the multidimensional time series data resulting from sensor data. Raw sensor data can exhibit highly different delivery characteristics. Some sensor sets may deliver low to moderate volumes of data continuously. It would be infeasible to attempt to store the data in this continuous fashion to a data store as attempting to assign identifying keys and the to store real time data from multiple sensors would invariably lead to significant data loss. In this circumstance, the data stream management engine 120 would hold incoming data in memory, keeping only the parameters, or “dimensions” from within the larger sensor stream that are pre-decided by the administrator of the study as important and instructions to store them transmitted from the administration device 112. The data stream management engine 120 would then aggregate the data from multiple individual sensors and apportion that data at a predetermined interval, for example, every 10 seconds, using the timestamp as the key when storing the data to a multidimensional time series data store over a single swimlane of sufficient size. This highly ordered delivery of a foreseeable amount of data per unit time is particularly amenable to data capture and storage but patterns where delivery of data from sensors occurs irregularly and the amount of data is extremely heterogeneous are quite prevalent. In these situations, the data stream management engine cannot successfully use strictly single time interval over a single swimlane mode of data storage. In addition to the single time interval method the invention also can make use of event based storage triggers where a predetermined number of data receipt events, as set at the administration device 112, triggers transfer of a data block consisting of the apportioned number of events as one dimension and a number of sensor ids as the other. In the embodiment, the system time at commitment or a time stamp that is part of the sensor data received is used as the key for the data block value of the value-key pair. The invention can also accept a raw data stream with commitment occurring when the accumulated stream data reaches a predesigned size set at the administration device 112.

It is also likely that that during times of heavy reporting from a moderate to large array of sensors, the instantaneous load of data to be committed will exceed what can be reliably transferred over a single swimlane. The embodiment of the invention can, if capture parameters pre-set at the administration device 112, combine the data movement capacity of two or more swimlanes, the combined bandwidth dubbed a metaswimlane, transparently to the committing process, to accommodate the influx of data in need of commitment. All sensor data, regardless of delivery circumstances are stored in a multidimensional time series data store 125 which is designed for very low overhead and rapid data storage and minimal maintenance needs to sap resources. The embodiment uses a key-value pair data store examples of which are Riak, Redis and Berkeley DB for their low overhead and speed, although the invention is not specifically tied to a single data store type to the exclusion of others known in the art should another data store with better response and feature characteristics emerge. Due to factors easily surmised by those knowledgeable in the art, data store commitment reliability is dependent on data store data size under the conditions intrinsic to time series sensor data analysis. The number of data records must be kept relatively low for the herein disclosed purpose. As an example one group of developers restrict the size of their multidimensional time series key-value pair data store to approximately 8.64×104 records, equivalent to 24 hours of 1 second interval sensor readings or 60 days of 1 minute interval readings. In this development system the oldest data is deleted from the data store and lost. This loss of data is acceptable under development conditions but in a production environment, the loss of the older data is almost always significant and unacceptable. The invention accounts for this need to retain older data by stipulating that aged data be placed in long term storage. In the embodiment, the archival storage is included 130. This archival storage might be locally provided by the user, might be cloud based such as that offered by Amazon Web Services or Google or could be any other available very large capacity storage method such as Ceph or alternatives known to those skilled in the art.

Reliably capturing and storing sensor data as well as providing for longer term, offline, storage of the data, while important, is only an exercise without methods to repetitively retrieve and analyze most likely differing but specific sets of data over time. The invention provides for this requirement with a robust query language that both provides straightforward language to retrieve data sets bounded by multiple parameters, but to then invoke several transformations on that data set prior to output. In the embodiment isolation of desired data sets and transformations applied to that data occurs using pre-defined query commands issued from the administration device 112 and acted upon within the database by the structured query interpreter 135. Below is a highly simplified example statement to illustrate the method by which a very small number of options that are available using the structured query interpreter 135 might be accessed.

SELECT [STREAMING|EVENTS] data_spec FROM [unit] timestamp TO timestamp GROUPBY (sensor_id, identifier) FILTER [filter_identifier] FORMAT [sensor [AS identifier] [, sensor [AS identifier]] . . . ] (TEXT|JSON|FUNNEL|KML|GEOJSON|TOPOJSON);

Here “data_spec” might be replaced by a list of individual sensors from a larger array of sensors and each sensor in the list might be given a human readable identifier in the format “sensor AS identifier”. “unit” allows the researcher to assign a periodicity for the sensor data such as second(s), minute (m), hour (h). One or more transformational filters, which include but a not limited to: mean, median, variance, standard deviation, standard linear interpolation, or Kalman filtering and smoothing, may be applied and then data formatted in one or more formats examples of with are text, JSON, KML, GEOJSON and TOPOJSON among others known to the art, depending on the intended use of the data.

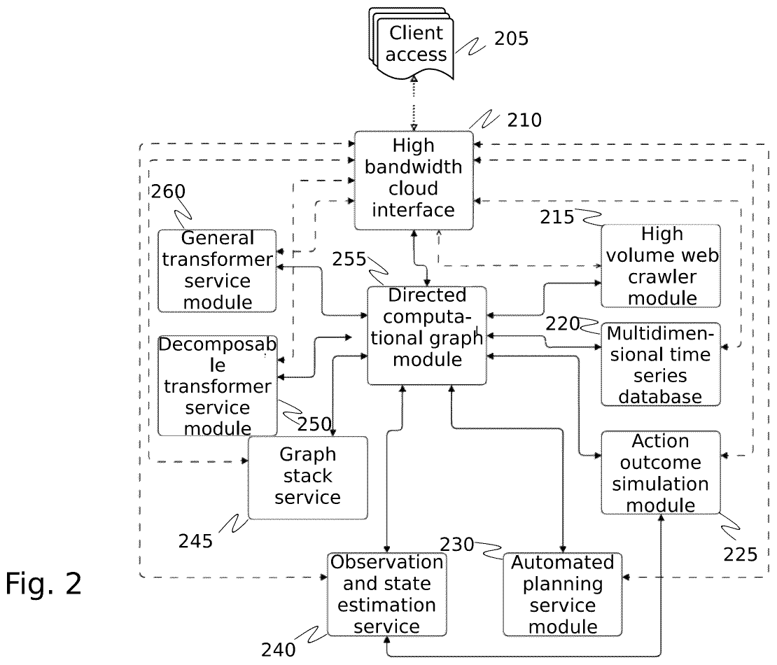

FIG. 2 is a diagram of an exemplary architecture of a distributed operating system 200 according to a preferred aspect. Client access to the system 205 both for system control and for interaction with system output such as automated predictive decision making and planning and alternate pathway simulations, occurs through the system's highly distributed, very high bandwidth cloud interface 210 which is application driven through the use of the Scala/Lift/Akka development environment and web interaction operation optionally mediated by AWS ELASTIC BEANSTALK™, both used for standards compliance and ease of development and simplistic autoscaling.

In one embodiment, a system integrates container orchestration platforms (e.g., Kubernetes, Docker Swarm) with the AI-controlled sensor network to dynamically instantiate and retire container-based honeypots and sensors. This approach enables rapid prototyping of new honeypot configurations in response to emerging cyber threats. The system further implements serverless triggers that automatically spin up ephemeral container images containing honeypot services, where the container lifespans are short and tailored to active threat windows. When threats subside or sensor capacity reaches a threshold, the system tears down these ephemeral containers without affecting other network segments. This model ensures minimal resource footprint while maximizing honeypot coverage, allowing rapid lateral expansion into new network zones or previously under-monitored segments. A container scheduler is tuned by the AI orchestrator to ensure seamless scaling across multiple zones, using real-time metrics such as honeypot engagement rate, detected vulnerability exploits, or suspicious traffic events to prioritize container provisioning.

Much of the data analyzed by the system both from sources within the confines of the client, and from cloud-based sources, also enter the system through the cloud interface 210, data being passed to the analysis and transformation components of the system, the directed computational graph module 255, high volume web crawling module 215 and multidimensional time series database 220. The directed computational graph retrieves one or more streams of data from a plurality of sources, which includes, but is in no way not limited to, a number of physical sensors, web-based questionnaires and surveys, monitoring of electronic infrastructure, crowd sourcing campaigns (where quality of expertise or relevance may further weight the relative importance of response for follow-on analysis and model training or RAG adjustments), and human input device information. Within the directed computational graph, data may be split into two identical streams, wherein one sub-stream may be sent for batch processing and storage while the other sub-stream may be reformatted for transformation pipeline analysis. The data is then transferred to general transformer service 260 for linear data transformation as part of analysis or decomposable transformer service 250 for branching or iterative transformations that are part of analysis. The directed computational graph 255 represents all data as directed graphs where the transformations are nodes and the result messages between transformations edges of the graph. These graphs which contain considerable intermediate transformation data are stored and further analyzed within graph stack module 245. High volume web crawling module 215 uses multiple server hosted preprogrammed web spiders to find and retrieve data of interest from web-based sources that are not well tagged by conventional web crawling technology. Multiple dimension time series database module 220 receives data from a large plurality of sensors that may be of several different types. The module is designed to accommodate irregular and high volume surges by dynamically allocating network bandwidth and server processing channels to process the incoming data. Data retrieved by the multidimensional time series database 220 and the high volume web crawling module 215 may be further analyzed and transformed into task optimized results by the directed computational graph 255 and associated general transformer service 250 and decomposable transformer service 260 modules.

Results of the transformative analysis process may then be combined with further client directives, additional rules and practices relevant to the analysis and situational information external to the already available data in the automated planning service module 230 which also runs powerful predictive statistics functions and machine learning algorithms to allow future trends and outcomes to be rapidly forecast based upon the current system derived results and choosing each a plurality of possible decisions. Using all available data, the automated planning service module 230 may propose decisions most likely to result in the most favorable outcome with a usably high level of certainty. Closely related to the automated planning service module in the use of system derived results in conjunction with possible externally supplied additional information in the assistance of end user decision making, the outcome simulation module 225 coupled with the end user facing observation and state estimation service 240 allows decision makers to investigate the probable outcomes of choosing one pending course of action over another based upon analysis of the current available data. For example, the pipelines operations department has reported a very small reduction in crude oil pressure in a section of pipeline in a highly remote section of territory. Many believe the issue is entirely due to a fouled, possibly failing flow sensor, others believe that it is a proximal upstream pump that may have foreign material stuck in it. Correction of both of these possibilities is to increase the output of the affected pump to hopefully clean out it or the fouled sensor. A failing sensor will have to be replaced at the next maintenance cycle. A few, however, feel that the pressure drop is due to a break in the pipeline, probably small at this point, but even so, crude oil is leaking and the remedy for the fouled sensor or pump option could make the leak much worse and waste much time afterwards. The company does have a contractor about 8 hours away or could rent satellite time to look but both of those are expensive for a probable sensor issue, significantly less than cleaning up an oil spill though and then with significant negative public exposure. These sensor issues have happened before and the distributed operating system 200 has data from them, which no one really studied due to the great volume of columnar figures, so the alternative courses 225, 240 of action are run. The system, based on all available data, predicts that the fouled sensor or pump are unlikely the root cause this time due to other available data and the contractor is dispatched. She finds a small breach in the pipeline. There will be a small cleanup and the pipeline needs to be shutdown for repair but multiple tens of millions of dollars have been saved. This is just one example of a great many of the possible use of the distributed operating system, those knowledgeable in the art will easily formulate more.

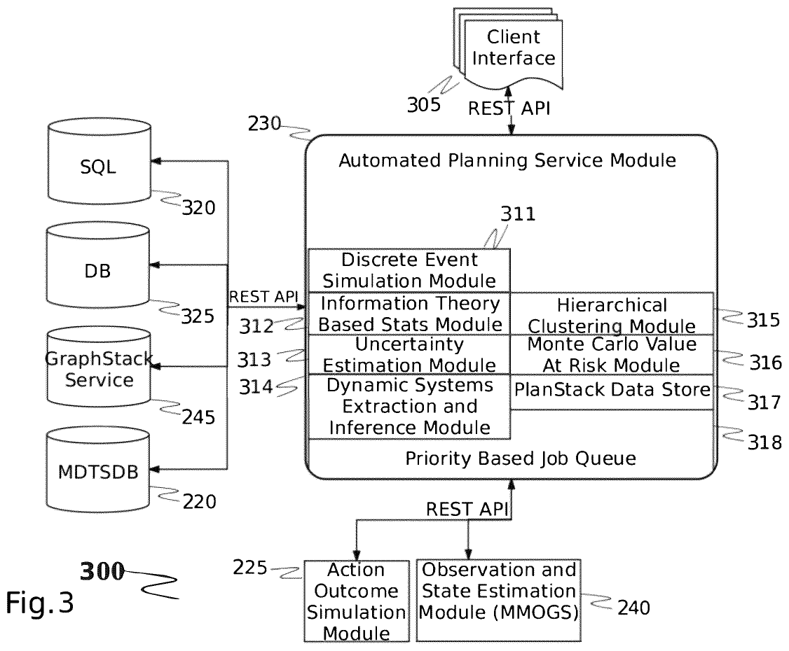

FIG. 3 is a diagram of an exemplary architecture of an automated planning service module and related modules 300 according to an embodiment of the invention. Seen here is a more detailed view of the automated planning service module 230 as depicted in FIG. 2. The module functions by receiving decision or venture candidates as well as relevant currently available related data and any campaign analysis modification commands through a client interface 305. The module may also be used provide transformed data or run parameters to the action outcome simulation module 225 to seed a simulation prior to run or to transform intermediate result data isolated from one or more actors operating in the action outcome simulation module 225, during a simulation run. Significant amounts of supporting information such as, but not restricted to current conditions, infrastructure, ongoing venture status, financial status, market conditions, and world events which may impact the current decision or venture that have been collected by the distributed operating system as a whole and stored in such data stores as the multidimensional times series database 220, the analysis capabilities of the directed computational graph module 255 and web-based data retrieval abilities of the high volume web crawler module 215 all of which may be stored in one or more data stores 320, 325 may also be used during simulation of alternative decision progression, which may entail such variables as, but are not limited to implementation timing, method to end changes, order and timing of constituent part completion or impact of choosing another goal instead of an action currently under analysis.

Contemplated actions may be broken up into a plurality of constituent events that either act towards the fulfillment of the venture under analysis or represent the absence of each event by the discrete event simulation module 311 which then makes each of those events available for information theory based statistical analysis 312, which allows the current decision events to be analyzed in light of similar events under conditions of varying dis-similarity using machine learned criteria obtained from that previous data; results of this analysis in addition to other factors may be analyzed by an uncertainty estimation module 313 to further tune the level of confidence to be included with the finished analysis. Confidence level would be a weighted calculation of the random variable distribution given to each event analyzed. Prediction of the effects of at least a portion of the events involved with a venture under analysis within a system as complex as anything from the microenvironment in which the client operates to more expansive arenas as the regional economy or further, from the perspective of success of the client is calculated in dynamic systems extraction and inference module 314, which use, among other tools algorithms based upon Shannon entropy, Hartley entropy and mutual information dependence theory.

Of great importance in any decision or new venture is the amount of value that is being placed at risk by choosing one decision over another. Often this value is monetary but it can also be competitive placement, operational efficiency or customer relationship based, for example: this may be the effects of keeping an older, possibly somewhat malfunctioning customer relationship management system one more quarter instead of replacing it for $14 million dollars and a subscription fee. The automated planning service module has the ability predict the outcome of such decisions per value that will be placed at risk using programming based upon the Monte Carlo heuristic model 316 which allows a single “state” estimation of value at risk. It is very difficult to anticipate the amount of computing power that will be needed to complete one or more of these decision analyses which can vary greatly in individual needs and often are run with several alternatives concurrently. The invention is therefore designed to run on expandable clusters 315, in a distributed, modular, and extensible approach, such as, but not exclusively, offerings of Amazon's AWS. Similarly, these analysis jobs may run for many hours to completion and many clients may be anticipating long waits for simple “what if” options which will not affect their operations in the near term while other clients may have come upon a pressing decision situation where they need alternatives as soon as possible. This is accommodated by the presence of a job queue that allows analysis jobs to be implemented at one of multiple priority levels from low to urgent. In case of a change in more hypothetical analysis jobs to more pressing, job priorities can also be changed during run without loss of progress using the priority based job queue 318.

Structured plan analysis result data may be stored in either a general purpose automated planning engine executing Action Notation Modeling Language (ANML) scripts for modeling which can be used to prioritize both human and machine-oriented tasks to maximize reward functions over finite time horizons 317 or through the graph-based data store 245, depending on the specifics of the analysis in complexity and time run.

The results of analyses may be sent to one of two client facing presentation modules, the action outcome simulation module 225 or the more visual simulation capable observation and state estimation module 240 depending on the needs and intended usage of the data by the client.

FIG. 4 is a system diagram illustrating connections between core components of the invention for geo-locating and tracking the status of cyber-physical assets, according to a preferred aspect. A distributed operating system 410 operates an optimization engine 411, parametric evaluation engine 412, and uses abstract data representations 413 including Markov State Models (MSM) 414 and abstract representations of finite state machines 415 to read, modify, and generally operate on data. A distributed operating system 410 such as this is connected to a network 450, which may be an intranet, the internet, a local area connection, or any one of many other configurations of networks. Also connected to this network 450 is at least one database 420, which holds information including a crypto-ledger 421, an implementation of a blockchain data construct, which will be expounded upon in later figures. Connected to a network 450 is at least one cyber-physical asset 430, 440, which may hold any number of sensors or data according to a specific implementation, and have geoJSON 431, 441 data with which to record their geo-physical location. A cyber-physical asset 430, 440 may be a delivery crate with a possible plurality of sensors and computers embedded or attached to the crate in some way, or may be an object inside a mundane crate such as a piece of research equipment which may communicate with a distributed operating system 410 during transit, or may be a stationary object such as research equipment, computer systems, and more, which are capable of sending status updates at least consisting of geoJSON 431, 441 information regarding their geophysical location over a network 450. A distributed operating system may use a Markov State Model (MSM) 414 as a tool for data representation of the states of cyber-physical assets which send status updates in this way, and may or may not reduce a MSM to a finite state machine representation 415 with or without stochastic elements, according to a preferred aspect. These data representations 413 are useful for visualizing and analyzing current, previous, and possible future states of assets 430, 440 connected to an operating system 410 over a network 450.

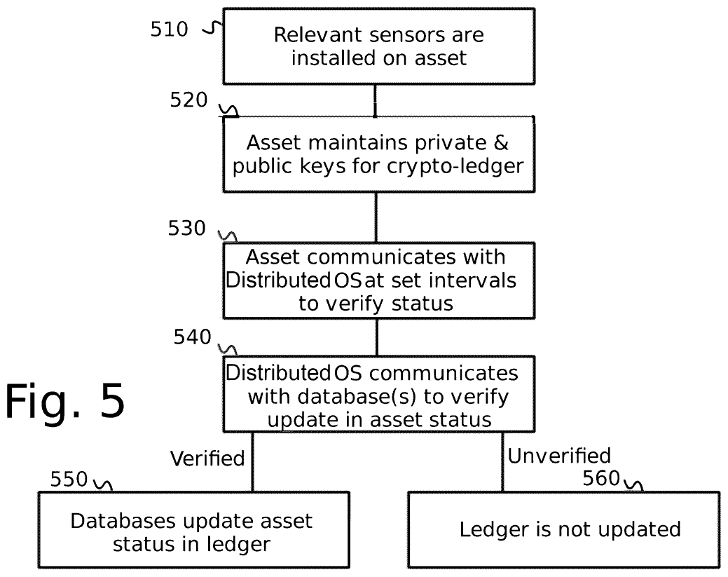

FIG. 5 is a method diagram illustrating key steps in the communication between cyber-physical assets 430, 440 and remote servers running a distributed operating system 410, according to a preferred aspect. Any relevant sensors or sensing equipment and software must be installed on the asset 510 first, before relevant data can be sent to a distributed operating system 410. Such sensors may include a variety of implementations, including temperature sensors, GPS tracking software, accelerometers, or any other sensors and accompanying hardware and software as needed or desired by the user upon implementation of this system. The cyber-physical asset 430, 440 will maintain, as part of their software involvement in the system, a private key, and the requisite software for a crypto-ledger 421 implementation 520 using blockchain technology. Blockchain technology is essentially a method for secure message sending between network connected devices, often used for the purposes of transaction ledgers and smart contracts, using asymmetric encryption. The cyber-physical asset will be in communication with a distributed operating system 410 either continuously or at set intervals 530, depending on individual implementations, according to a preferred aspect. During these communications, the asset will, using the asymmetric encryption in blockchain crypto-ledgers, send status updates based on any sensors installed on the asset 530. A distributed operating system that receives these updates will then verify them with previous status updates in databases 540 to ensure that the updates received are legitimate, and not forged or from a dubious source. If the public key, or signature, or contents of the encrypted message are not able to be verified properly, the ledger held in at least one database is not updated 560. If they are properly verified and indicate they are from the real asset and indicate a legitimate status update, any databases which hold a copy of the crypto-ledger 421 are updated with the new status of the asset 550. It will be apparent to one skilled in the art that additional uses for an update verification process may be that partial updates (for example, with certain pieces of data not sent to the server in the status update) may be used, and with this partial observability, missing data between status updates may be inferred using machine learning techniques. It is possible to implement a rules engine for this purpose, to determine what rules to apply for inference of missing data, depending on the implementation of the system.

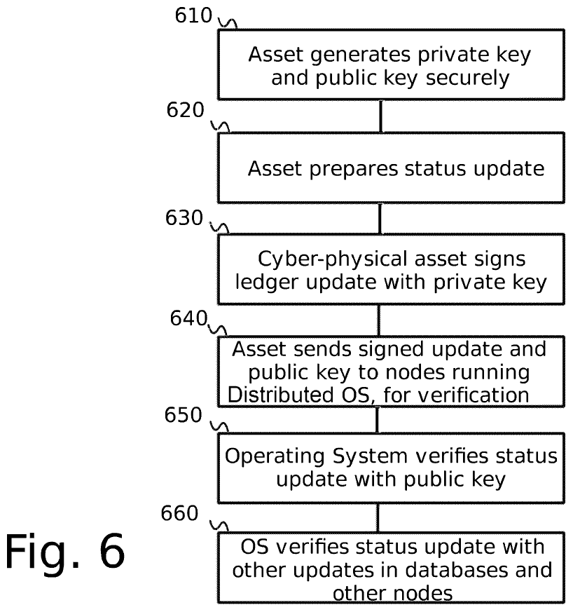

FIG. 6 is a method diagram illustrating key steps in a distributed operating system 410 interacting with data received from cyber-physical assets 430, 440 in databases 420 to verify updates in a cryptographic ledger 421, according to a preferred aspect. Any asset must generate a public and private key 610 in accordance with the specifications of asymmetric encryption, which are known technologies in the art. An asset must prepare an update 620, which may mean formatting data received from any installed sensors, performing any relevant calculations or modifications to raw data, and preparing any network devices for sending the data across a network 450. The cyber-physical asset 430, 440 must sign any update with its private key 630, which encrypts the update in a way that only the private or public keys can be used to decrypt. The asset, when connected to a network 450, may send the prepared and encrypted update to any “nodes” or computer systems running a distributed operating system 410, to be verified before being added onto the ledger 421, 640. Any nodes running a distributed operating system 410 will attempt to verify the asset status update 650, before then verifying with the ledger held in at least one database 420 and any other relevant nodes or computer systems with such a distributed operating system 410 that the asset update is legitimate, valid, and shall be added to the ledger of status updates from the asset 660. It is possible to implement this system and method in an ongoing identification and authentication service, for continuous updates, rather than discrete authentication and verification for discrete updates.

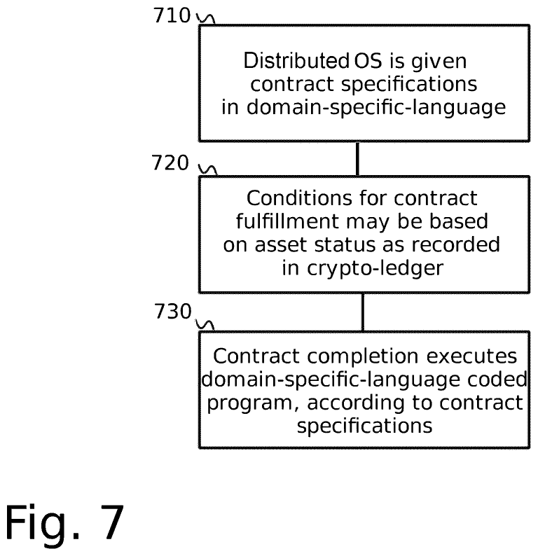

FIG. 7 is a method diagram illustrating several steps in the use of smart contracts combined with cyber-physical assets, according to a preferred aspect. Such smart contracts are possible as a result of implementing blockchain technology to not only keep track of and verify entries in crypto-ledgers 421, but to store and execute distributed programs, for the purposes of self-enforcing contracts, known as smart contracts. In this implementation, a smart contract is implemented with a domain-specific-language (DSL) which may be provided by a vendor of the system or specified by a user of the system 710. A DSL may be thought of as a custom programming language, and may, depending on the implementation, also be an otherwise unmodified implementation of a programming language, according to a preferred aspect. Conditions for smart contracts in this system may be based on the past, present, or future status of cyber-physical assets monitored by the system 720. Upon completion of whatever conditions are programmed into a smart contract, the contract program executes, which may perform any number of tasks that may be programmed into a computer, including withdrawal of funds, depositing of funds, messages sent across a network 450, or other similar results of an executed program 730, according to a preferred aspect. These parametrically-triggered remuneration contracts may be versatile and diverse in their implementation according to the needs of the consumer.

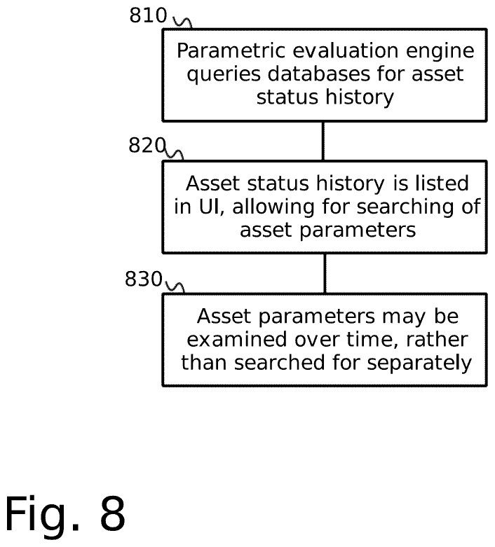

FIG. 8 is a method diagram illustrating key steps in the function of a parametric evaluation engine 412, according to a preferred aspect. A parametric evaluation engine 412 may query at least one database 420 for a ledger 421 containing previous or current status updates of at least one cyber-physical asset 430, 440, 810. This query may be performed across a network 450 from a distributed operating system 410 run on a computer system and may take the form of any database query format, including NOSQL™ databases such as MONGODB™, or SQL™ databases including MICROSOFT SQL SERVER™ and MYSQL™ databases, depending on the desired database implementation in the system, according to a preferred aspect. Asset status histories may be returned to a parametric evaluation engine 412, which may be listed to a user of the engine, in a basic user interface which allows the listing and searching of such asset status update histories 820. Asset statuses may be viewed over time as a history rather than listed separately, if desired, for the purpose of noting and examining trends in an asset's status 830, according to an aspect.

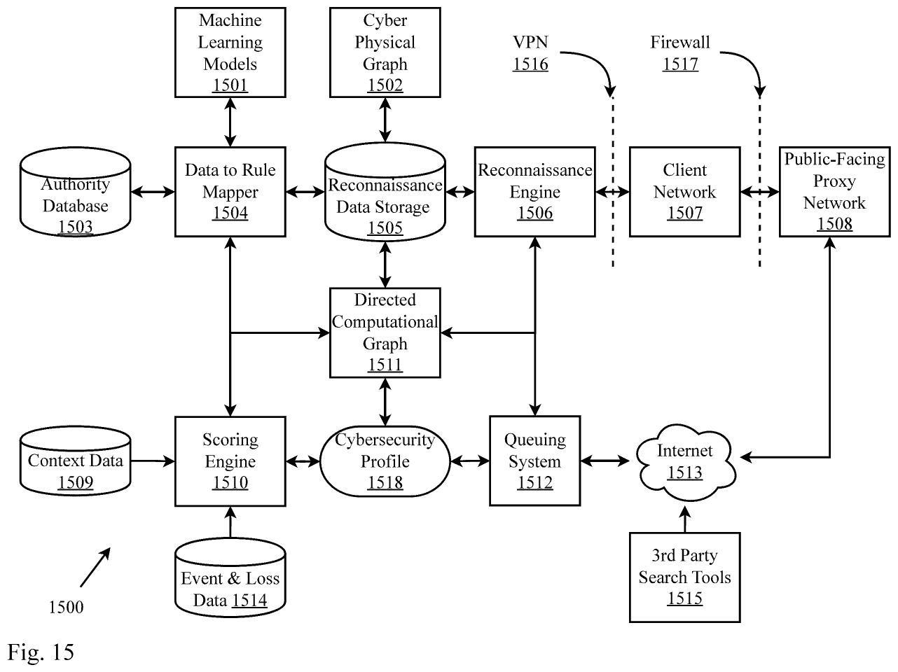

FIG. 15 is a block diagram showing an exemplary system architecture 1500 for a system for cybersecurity profiling and rating. The system in this example contains a cyber-physical graph 1502 which is used to represent a complete picture of an organization's infrastructure and operations including, importantly, the organization's computer network infrastructure particularly around system configurations that influence cybersecurity protections and resiliency. The system further contains a directed computational graph 1511, which contains representations of complex processing pipelines and is used to control workflows through the system such as determining which 3rd party search tools 1515 to use, assigning search tasks, and analyzing the cyber-physical graph 1502 and comparing results of the analysis against reconnaissance data received from the reconnaissance engine 1506 and stored in the reconnaissance data storage 1505. In some embodiments, the determination of which 3rd party search tools 1515 to use and assignment of search tasks may be implemented by a reconnaissance engine 1506. The cyber-physical graph 1502 plus the analyses of data directed by the directed computational graph on the reconnaissance data received from the reconnaissance engine 1506 are combined to represent the cyber-security profile of the client organization whose network 1507 is being evaluated. A queuing system 1512 is used to organize and schedule the search tasks requested by the reconnaissance engine 1506. A data to rule mapper 1504 is used to retrieve laws, policies, and other rules from an authority database 1503 and compare reconnaissance data received from the reconnaissance engine 1506 and stored in the reconnaissance data storage 1505 against the rules in order to determine whether and to what extent the data received indicates a violation of the rules. Machine learning models 1501 may be used to identify patterns and trends in any aspect of the system, but in this case are being used to identify patterns and trends in the data which would help the data to rule mapper 1504 determine whether and to what extent certain data indicate a violation of certain rules. A scoring engine 1510 receives the data analyses performed by the directed computational graph 1511, the output of the data to rule mapper 1504, plus event and loss data 1514 and contextual data 1509 which defines a context in which the other data are to be scored and/or rated. A public-facing proxy network 1508 is established outside of a firewall 1517 around the client network 1507 both to control access to the client network from the Internet 1513, and to provide the ability to change the outward presentation of the client network 1507 to the Internet 1513, which may affect the data obtained by the reconnaissance engine 1506. In some embodiments, certain components of the system may operate outside the client network 1507 and may access the client network through a secure, encrypted virtual private network (VPN) 1516, as in a cloud-based or platform-as-a-service implementation, but in other embodiments some or all of these components may be installed and operated from within the client network 1507.

As a brief overview of operation, information is obtained about the client network 1507 and the client organization's operations, which is used to construct a cyber-physical graph 1502 representing the relationships between devices, users, resources, and processes in the organization, and contextualizing cybersecurity information with physical and logical relationships that represent the flow of data and access to data within the organization including, in particular, network security protocols and procedures. The directed computational graph 1511 containing workflows and analysis processes, selects one or more analyses to be performed on the cyber-physical graph 1502. Some analyses may be performed on the information contained in the cyber-physical graph, and some analyses may be performed on or against the cyber-physical graph using information obtained from the Internet 1513 from reconnaissance engine 1506. The workflows contained in the directed computational graph 1511 select one or more search tools to obtain information about the organization from the Internet 1515, and may comprise one or more third party search tools 1515 available on the Internet. As data are collected, they are fed into a reconnaissance data storage 1505, from which they may be retrieved and further analyzed. Comparisons are made between the data obtained from the reconnaissance engine 1506, the cyber-physical graph 1502, the data to rule mapper, from which comparisons a cybersecurity profile of the organization is developed. The cybersecurity profile is sent to the scoring engine 1510 along with event and loss data 1514 and context data 1509 for the scoring engine 1510 to develop a score and/or rating for the organization that takes into consideration both the cybersecurity profile, context, and other information.

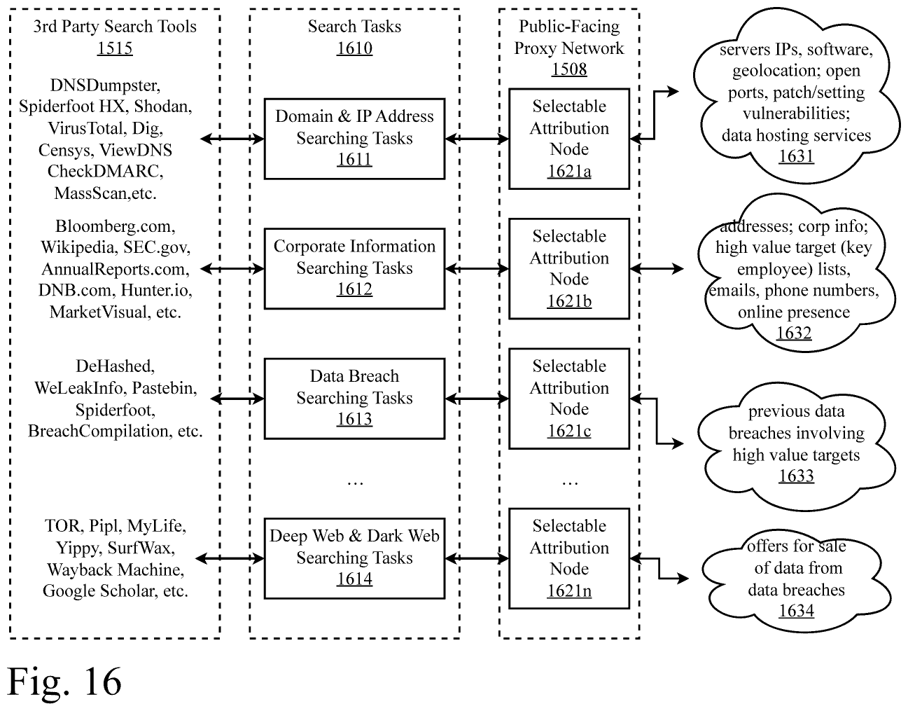

FIG. 16 is a relational diagram showing the relationships between exemplary 3rd party search tools 1515, search tasks 1610 that can be generated using such tools, and the types of information that may be gathered with those tasks 1611-1614, and how a public-facing proxy network 1508 may be used to influence the search task results. While the use of 3rd party search tools 1515 is in no way required, and proprietary or other self-developed search tools may be used, there are numerous 3rd party search tools 1515 available on the Internet, many of them available for use free of charge, that are convenient for purposes of performing external and internal reconnaissance of an organization's infrastructure. Because they are well-known, they are included here as examples of the types of search tools that may be used and the reconnaissance data that may be gathered using such tools. The search tasks 1610 that may be generated may be classified into several categories. While this category list is by no means exhaustive, several important categories of reconnaissance data are domain and internet protocol (IP) address searching tasks 1611, corporate information searching tasks 1612, data breach searching tasks 1613, and dark web searching tasks 1614. Third party search tools 1515 for domain and IP address searching tasks 1611 include, for example, DNSDumpster, Spiderfoot HX, Shodan, VirusTotal, Dig, Censys, ViewDNS, and CheckDMARC, among others. These tools may be used to obtain reconnaissance data about an organization's server IPs, software, geolocation; open ports, patch/setting vulnerabilities; data hosting services, among other data 1631. Third party search tools 1515 for corporate information searching tasks 1612 include, for example, Bloomberg.com, Wikipedia, SEC.gov, AnnualReports.com, DNB.com, Hunter.io, and MarketVisual, among others. These tools may be used to obtain reconnaissance data about an organization's addresses; corp info; high value target (key employee or key data assets) lists, emails, phone numbers, online presence 1632. Third party search tools 1515 for data breach searching tasks 1613 include, for example, DeHashed, WeLeakInfo, Pastebin, Spiderfoot, and BreachCompilation, among others. These tools may be used to obtain reconnaissance data about an organization's previous data breaches, especially those involving high value targets, and similar data loss information 1633. Third party search tools 1515 for deep web (reports, records, and other documents linked to in web pages, but not indexed in search results . . . estimated to be 90% of available web content) and dark web (websites accessible only through anonymizers such as TOR . . . estimated to be about 6% of available web content) searching tasks 1614 include, for example, Pipl, MyLife, Yippy, SurfWax, Wayback machine, Google Scholar, DuckDuckGo, Fazzle, Not Evil, and Start Page, among others. These tools may be used to obtain reconnaissance data about an organization's lost and stolen data such as customer credit card numbers, stolen subscription credentials, hacked accounts, software tools designed for certain exploits, which organizations are being targeted for certain attacks, and similar information 1634. A public-facing proxy network 1508 may be used to change the outward presentation of the organization's network by conducting the searches through selectable attribution nodes 1621a-n, which are configurable to present the network to the Internet in different ways such as, but not limited to, presenting the organization network as a commercial IP address, a residential IP address, or as an IP address from a particular country, all of which may influence the reconnaissance data received using certain search tools.

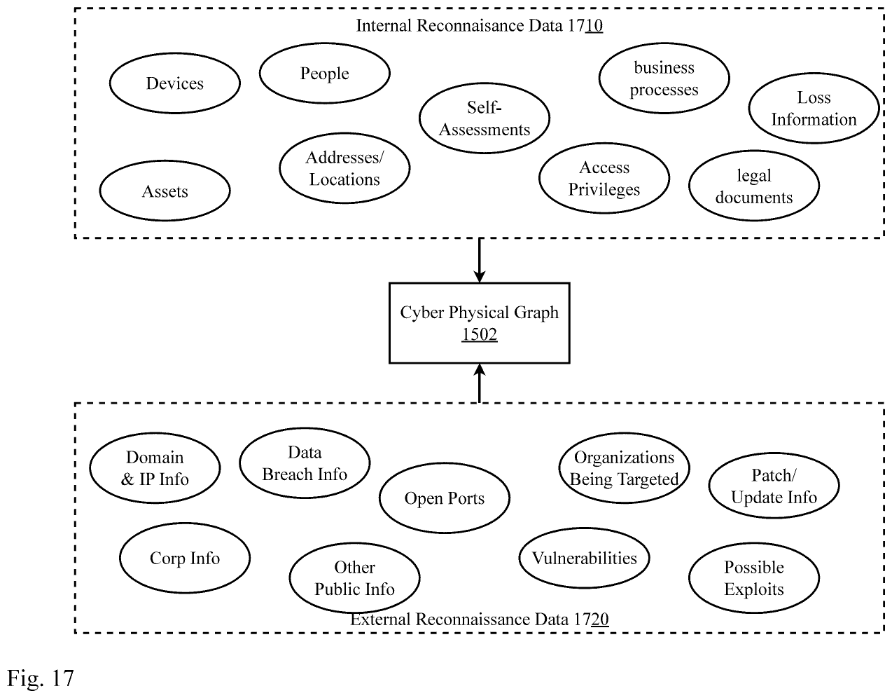

FIG. 17 is a relational diagram showing the exemplary types and classifications of information that may be used in constructing a cyber-physical graph 1502 of an organization's infrastructure and operations. The cyber-physical graph 1502 is a directed graph that represents a comprehensive picture of an organization's infrastructure and operations. A cyber-physical graph 1502 represents the relationships between entities associated with an organization, for example, devices, users, resources, groups, and computing services, the relationships between the entities defining relationships and processes in an organization's infrastructure, thereby contextualizing security information with physical and logical relationships that represent the flow of data and access to data within the organization including, in particular, network security protocols and procedures. Data that may be incorporated into a cyber-physical graph may be any data relating to an organization's infrastructure and operations, and two primary categories of data that may be incorporated are internal reconnaissance data 1710 and external reconnaissance data 1720. Non-limiting examples of internal reconnaissance data 1710 include computers and devices, physical and intangible (data) assets, people (employees, contractors, etc.), addresses and locations of buildings, servers, etc., business processes, access privileges, loss information, legal documents, and self-assessments of cybersecurity. Non-limiting examples of external reconnaissance data 1720 include domains and IP information, data breach information, organization information such as corporate structures, key employees, etc., open port information, information regarding which organizations are current targets of cyber-attacks, network vulnerability information, system version and patch/update information, known and possible exploits, and publicly available information.

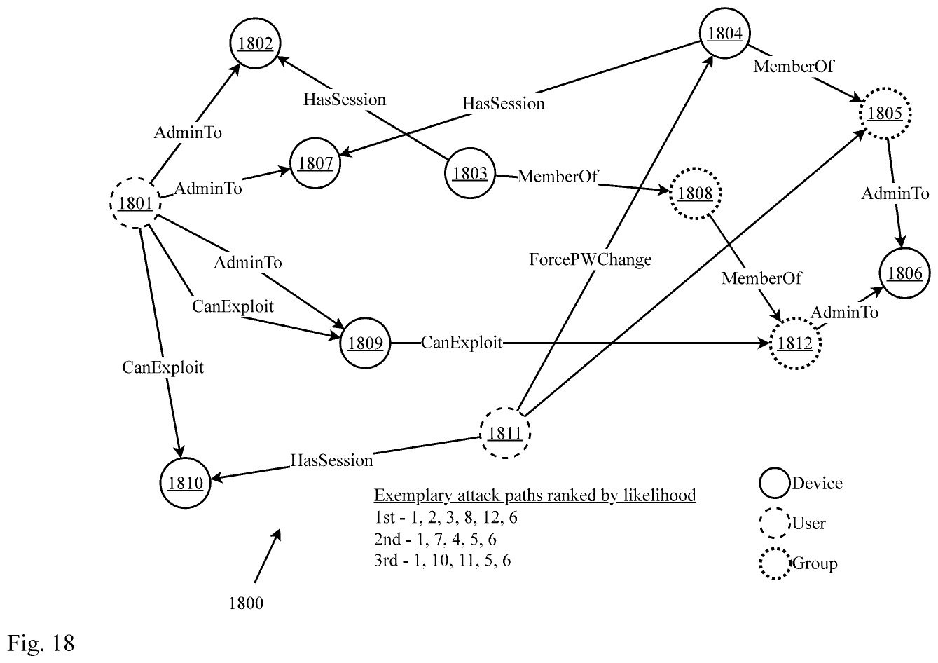

FIG. 18 is a directed graph diagram showing an exemplary cyber-physical graph 1800 and its possible use in creating cybersecurity profiles and ratings. A cyber-physical graph 1502 represents the relationships between entities associated with an organization, for example, devices, users, resources, groups, and computing services, the relationships between the entities defining relationships and processes in an organization's infrastructure, thereby contextualizing security information with physical and logical relationships that represent the flow of data and access to data within the organization including, in particular, network security protocols and procedures. A cyber-physical graph, in its most basic form, represents the network devices comprising an organization's network infrastructure as nodes (also called vertices) in the graph and the physical or logical connections between them as edges between the nodes. The cyber-physical graph may be expanded to include network information and processes such as data flow, security protocols and procedures, and software versions and patch information. Further, human users and their access privileges to devices and assets may be included. A cyber-security graph may be further expanded to include internal process information such as business processes, loss information, and legal requirements and documents; external information such as domain and IP information, data breach information; and generated information such as open port information from external network scans, and web application vulnerabilities and avenues of attack. Thus, a cyber-physical graph may be used to represent a complete picture of an organization's infrastructure and operations.

In this example, which is necessarily simplified for clarity, the cyber-physical graph 1800 contains 12 nodes (vertices) comprising: seven computers and devices designated by solid circles 1802, 1803, 1804, 1806, 1807, 1809, 1810, two users designated by dashed-line circles 1801, 1811, and three functional groups designated by dotted-line circles 1805, 1808, and 1812. The edges (lines) between the nodes indicate relationships between the nodes, and have a direction and relationship indicator such as “AdminTo,” “MemberOf,” etc. While not shown here, the edges may also be assigned numerical weights or probabilities, indicating, for example, the likelihood of a successful attack gaining access from one node to another. Possible attack paths may be analyzed using the cyber-physical graph by running graph analysis algorithms such as shortest path algorithms, minimum cost/maximum flow algorithms, strongly connected node algorithms, etc. In this example, several exemplary attack paths are ranked by likelihood. In the most likely attack path, user 1801 is an administrator to device 1802 to which device 1803 has connected. Device 1803 is a member of functional group 1808, which has a member of group 1812. Functional group 1812 is an administrator to the target 1806. In a second most likely attack path, user 1801 is an administrator to device 1807 to which device 1804 has connected. Device 1804 is a member of functional group 1805, which is an administrator to the target device 1806. In a third most likely attack path, a flaw in the security protocols allow the credentials of user 1801 to be used to gain access to device 1810. User 1811 who is working on device 1810 may be tricked into providing access to functional group 1805, which is an administrator to the target device 1806.

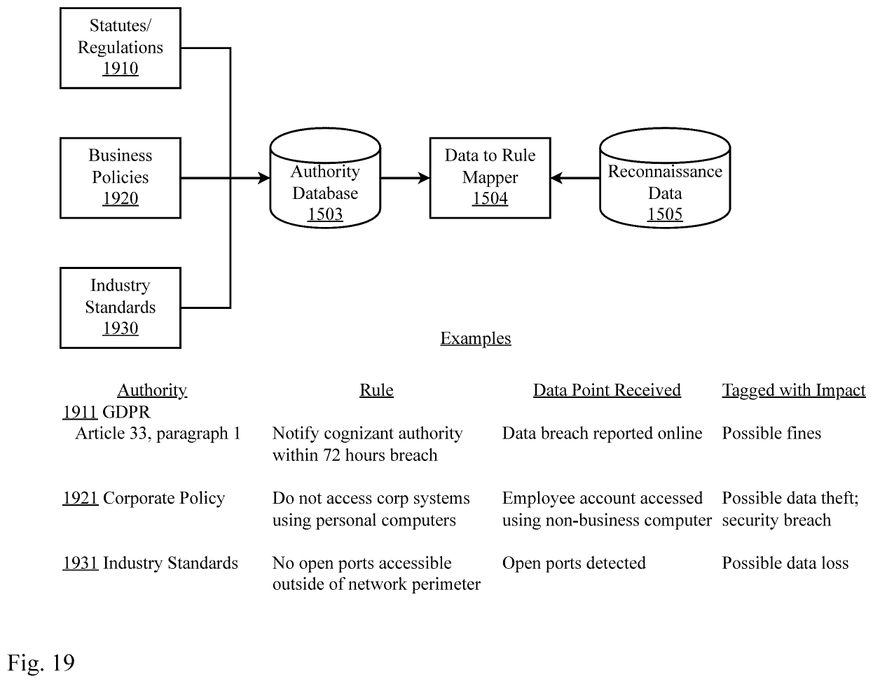

FIG. 19 is a block diagram showing exemplary operation of a data to rule mapper. Laws, policies, standards, and other rules are gathered and stored in an authority database 1503. Non-limiting examples of such rules include federal, state, and local statutes, regulations, case law interpretations, and other laws 1910, business policies and procedures 1920, and industry standards (as one example, cybersecurity industry standards for network security) 1930. Reconnaissance data are stored in a database 1505. A data to rule mapper 1504 retrieves the reconnaissance data 1505 and matches it to rules from the authority database 1503. An example of this operation for statues/regulations 1910 is shown in 1911, where Article 33, paragraph 1 of the European Union's General Data Protection Regulation (GDPR) requires that an organization notify a cognizant authority of a data breach within 72 hours of knowledge of the breach. If a data point indicates that a data breach has been discovered because data of the organization is found online, the data point is associated with that rule, and tagged with the possible impact of fines if the rule is not followed. An example of this operation for business policies 1920 is shown in 1921, where a corporate policy prohibits access of the organization's systems using personal computers. If a data point indicates that an employee account is accessed using a non-business-owned computer, the data point is associated with the rule, and tagged with possible data theft and/or security breach. An example of this operation for industry standards 1930 is shown in 1931, where an industry standard prohibits open ports accessible from outside the network perimeter. If a data point indicates an open port, the data point is associated with the rule, and tagged with possible data loss and/or security breach.

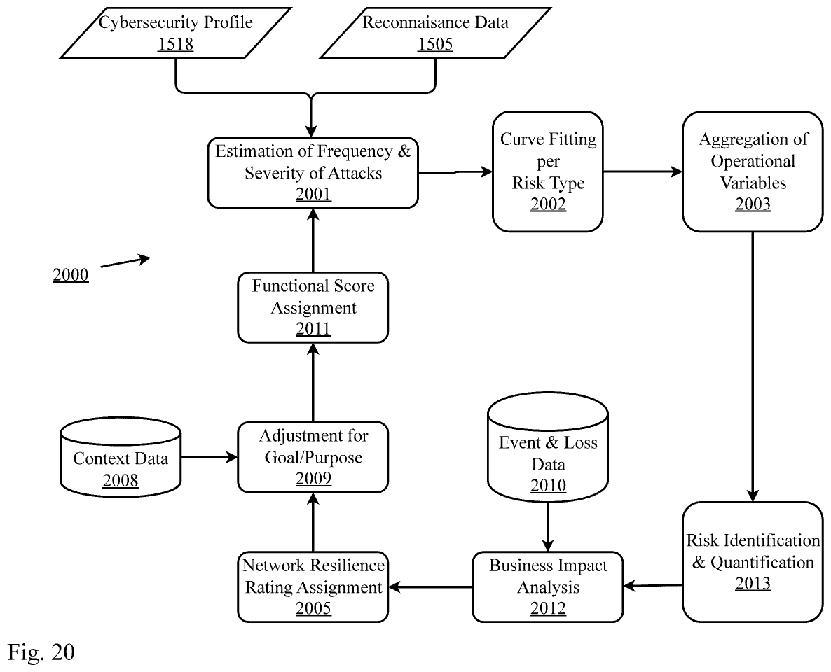

FIG. 20 is a block diagram showing an exemplary architecture 2000 for a scoring engine. Data fed into the scoring engine comprise the cybersecurity profile 1518 and reconnaissance data 1505 developed at earlier stages of system operation. Based on these data, a frequency and severity of attack is estimated 2008. For each risk type, curve fitting 2002 may be performed on the data points to assign a “best fit” function along the range of data points, which captures trends in the data and allows for predictions of how similar data will behave in the future. Aggregations of operational variables 2003 may be applied to identify maxima, minima, counts, sums, and standard deviations of the data. Risk identification and quantification is then performed 2013, and a business impact analysis is performed 2012 based on a totality of the predicted risks, their severity, business dependencies reflected in the cyber-physical graph, and prior event and loss data 2010, among other variables. From this analysis of business impact 2012, a network resilience rating is assigned 2005, representing a weighted and adjusted total of relative exposure the organization has to various types of risks, each of which may be assigned a sub-rating. The network resilience rating 2005 may be a single score for all factors, a combination of scores, or a score for a particular risk or area of concern. The network resilience rating 2011 may then be adjusted or filtered depending on the context in which it is to be used 2009. For example, context data received 2008 may indicate that the scores are to be used for compliance with internal theft policies, but the factors associated with the network resilience rating indicate that the highest risks are associated with cyber-attacks from external systems, which may cause the adjustment for goal/purpose 2009 to filter out the factors of the network resilience rating associated with risks from external cyber-attacks or reduce their contribution to a functional score. Finally, a functional cybersecurity score 2011 is assigned which takes into account the adjusted factors of the network resilience score and the context in which the functional score is to be applied. The process may be iterative, in that the network resilience rating 2005 from previous analyses may be fed back into the start of the process at estimation of frequency and severity of attacks 2001. The sensor network data can be used to score the threat level of a computer, group of networked computers, company, or other grouping of related IP address space (such as IP blocked owned by a particular ASN) as they appear from the outside. That is to say, score a machine according to how much of a thread it poses to a particular organization. This score data can be taken into account by a firewall when decision if a particular pack, stream, or connection from any particular machine, IP, or IP block may be malicious.

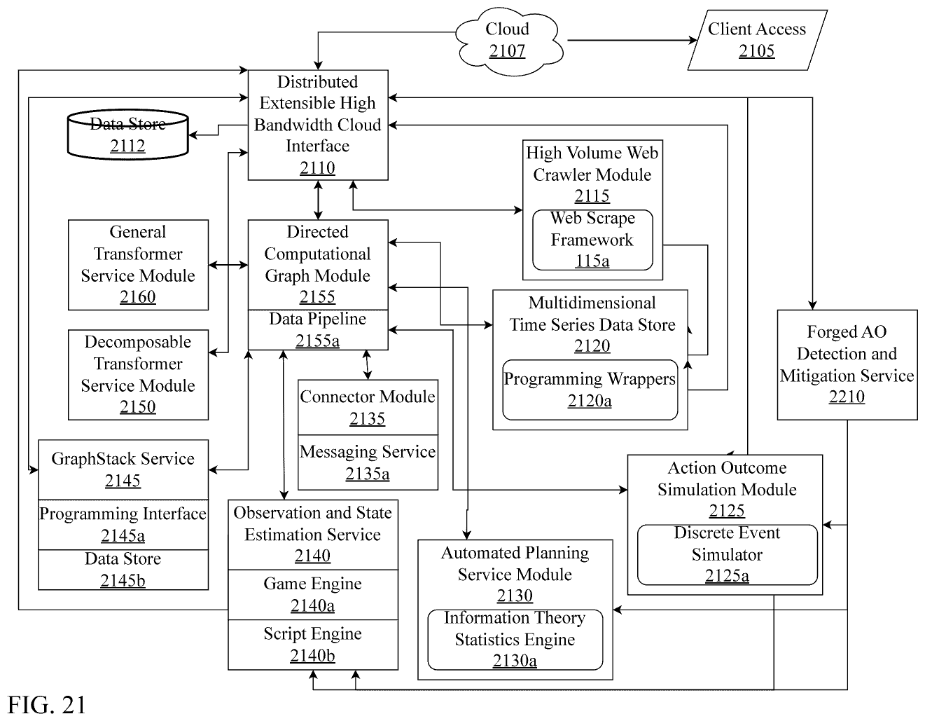

FIG. 21 is a diagram of an exemplary architecture of an advanced cyber decision platform (ACDP) 2100 according to one aspect. Client access to the system 2105 for specific data entry, system control and for interaction with system output such as automated predictive decision making and planning and alternate pathway simulations, occurs through the system's distributed, extensible high bandwidth cloud interface 2110 which uses a versatile, robust web application driven interface for both input and display of client-facing information via network 2107 and operates a data store 2112 such as, but not limited to MONGODB™, COUCHDB™ CASSANDRA™ or REDIS™ according to various arrangements. Much of the business data analyzed by the system both from sources within the confines of the client business, and from cloud based sources, also enter the system through the cloud interface 2110, data being passed to the connector module 2135 which may possess the API routines 2135a needed to accept and convert the external data and then pass the normalized information to other analysis and transformation components of the system, the directed computational graph module 2155, high volume web crawler module 2115, multidimensional time series database 2120 and the graph stack service 2145. The directed computational graph module 155 retrieves one or more streams of data from a plurality of sources, which includes, but is in no way not limited to, a plurality of physical sensors, network service providers, web based questionnaires and surveys, monitoring of electronic infrastructure, crowd sourcing campaigns, and human input device information. Within the directed computational graph module 2155, data may be split into two identical streams in a specialized pre-programmed data pipeline 2155a, wherein one sub-stream may be sent for batch processing and storage while the other sub-stream may be reformatted for transformation pipeline analysis. The data is then transferred to the general transformer service module 2160 for linear data transformation as part of analysis or the decomposable transformer service module 2150 for branching or iterative transformations that are part of analysis. The directed computational graph module 2155 represents all data as directed graphs where the transformations are nodes and the result messages between transformations edges of the graph. The high volume web crawling module 2115 uses multiple server hosted preprogrammed web spiders, which while autonomously configured are deployed within a web scraping framework 2115a of which SCRAPY™ is an example, to identify and retrieve data of interest from web based sources that are not well tagged by conventional web crawling technology. The multiple dimension time series data store module 2120 may receive streaming data from a large plurality of sensors that may be of several different types. The multiple dimension time series data store module may also store any time series data encountered by the system such as but not limited to enterprise network usage data, component and system logs, performance data, network service information captures such as, but not limited to news and financial feeds, and sales and service related customer data. The module is designed to accommodate irregular and high volume surges by dynamically allotting network bandwidth and server processing channels to process the incoming data. Inclusion of programming wrappers for languages examples of which are, but not limited to C++, PERL, PYTHON, and ERLANG™ allows sophisticated programming logic to be added to the default function of the multidimensional time series database 2120 without intimate knowledge of the core programming, greatly extending breadth of function. Data retrieved by the multidimensional time series database 2120 and the high volume web crawling module 2115 may be further analyzed and transformed into task optimized results by the directed computational graph 2155 and associated general transformer service 2150 and decomposable transformer service 2160 modules. Alternately, data from the multidimensional time series database and high volume web crawling modules may be sent, often with scripted cuing information determining important vertexes 2145a, to the graph stack service module 2145 which, employing standardized protocols for converting streams of information into graph representations of that data, for example, open graph internet technology (OGIT) ontology although the invention is not reliant on any one standard. Through the steps, the graph stack service module 2145 represents data in graph form influenced by any predetermined scripted modifications, transformations, via any LLM, or model-based classification, or transformation process to label and classify content into the ontological framework relied upon by the knowledge graph 2145a and stores it in a graph-based data store 2145b such as Neo4j, Neptune, GIRAPH™ or another data store REDIS™, Dynamo, or RIAK™, PostgreSQL, among others, all of which are suitable for storing graph-based information when suitably configured.

Results of the transformative analysis process may then be combined with further client directives, additional business rules and practices relevant to the analysis and situational information external to the already available data in the automated planning service module 2130 which also runs powerful information theory 2130a based predictive statistics functions and machine learning algorithms to allow future trends and outcomes to be rapidly forecast based upon the current system derived results and choosing each a plurality of possible business decisions. The using all available data, the automated planning service module 2130 may propose business decisions most likely to result is the most favorable business outcome with a usably high level of certainty. Closely related to the automated planning service module in the use of system derived results in conjunction with possible externally supplied additional information in the assistance of end user business decision making, the action outcome simulation module 2125 with its discrete event simulator programming module 2125a coupled with the end user facing observation and state estimation service 2140 which is highly scriptable 2140b as circumstances require and has a game engine 2140a to more realistically stage possible outcomes of business decisions under consideration, allows business decision makers to investigate the probable outcomes of choosing one pending course of action over another based upon analysis of the current available data.

For example, the Information Assurance department is notified by the system 2100 that principal X is using credentials K (Kerberos Principal Key) never used by it before to access service Y. Service Y utilizes these same credentials to access secure data on data store Z. This correctly generates an alert as suspicious lateral movement through the network and will recommend isolation of X and Y and suspension of K based on continuous baseline network traffic monitoring by the multidimensional time series data store 2120 programmed to process such data 2120a, rigorous analysis of the network baseline by the directed computational graph 2155 with its underlying general transformer service module 2160 and decomposable transformer service module 2150 in conjunction with the AI and primed machine learning capabilities 2130a of the automated planning service module 2130 which had also received and assimilated publicly available from a plurality of sources through the multi-source connection APIs of the connector module 2135. Ad hoc simulations of these traffic patterns are run against the baseline by the action outcome simulation module 2125 and its discrete event simulator 2125a which is used here to determine probability space for likelihood of legitimacy. The system 2100, based on this data and analysis, was able to detect and recommend mitigation of a cyberattack that represented an existential threat to all business operations, presenting, at the time of the attack, information most needed for an actionable plan to human analysts at multiple levels in the mitigation and remediation effort through use of the observation and state estimation service 2140 which had also been specifically preprogrammed to handle cybersecurity events 2140b.

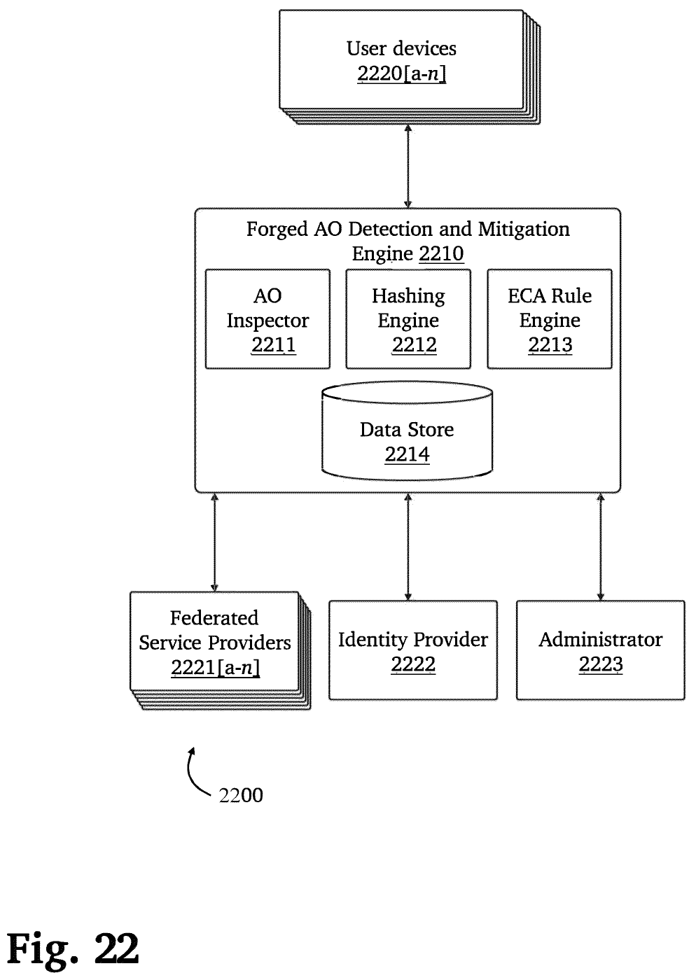

A forged authentication object detection and mitigation service 2210 may be used to detect and mitigate cyberattacks stemming from the use of authentication objects generated by an attacker. Service 910 is discussed in further detail below in FIG. 22.

According to one aspect, the advanced cyber decision platform, a specifically programmed usage of the business operating system, continuously monitors a client enterprise's normal network activity for behaviors such as but not limited to normal users on the network, resources accessed by each user, access permissions of each user, machine to machine traffic on the network, sanctioned external access to the core network and administrative access to the network's identity and access management servers in conjunction with real-time analytics informing knowledge of cyberattack methodology. The system then uses this information for two purposes: First, the advanced computational analytics and simulation capabilities of the system are used to provide immediate disclosure of probable digital access points both at the network periphery and within the enterprise's information transfer and trust structure and recommendations are given on network changes that should be made to harden it prior to or during an attack. Second, the advanced cyber decision platform continuously monitors the network in real-time both for types of traffic and through techniques such as deep packet inspection for pre-decided analytically significant deviation in user traffic for indications of known cyberattack vectors such as, but not limited to, ACTIVE DIRECTORY™/Kerberos pass-the-ticket attack, ACTIVE DIRECTORY™/Kerberos pass-the-hash attack and the related ACTIVE DIRECTORY™/Kerberos overpass-the-hash attack, ACTIVE DIRECTORY™/Kerberos Skeleton Key, ACTIVE DIRECTORY™/Kerberos golden and silver ticket attack, privilege escalation attack, compromised user credentials, ransomware disk attacks, and SAML forged authentication object attack (also may be referred to as golden SAML). When suspicious activity at a level signifying an attack (for example, including but not limited to skeleton key attacks, pass-the-hash attacks, or attacks via compromised user credentials) is determined, the system issues action-focused alert information to all predesignated parties specifically tailored to their roles in attack mitigation or remediation and formatted to provide predictive attack modeling based upon historic, current, and contextual attack progression analysis such that human decision makers can rapidly formulate the most effective courses of action at their levels of responsibility in command of the most actionable information with as little distractive data as possible. The system then issues defensive measures in the most actionable form to end the attack with the least possible damage and exposure. All attack data are persistently stored for later forensic analysis.

FIG. 22 is a block diagram illustrating an exemplary system architecture 2200 for a system 2210 for detecting and mitigating forged authentication object attacks according to various embodiments of the invention. Architecture 2200 may comprise system 2210 acting as a non-blocking intermediary between a connecting user 2220, a plurality of federated service providers (SP) 2221a-n, an identity provider (IdP) 2222, and an administrative user 2223.

System 2210 may be configured to verifying incoming connections when the user has an AO, and also keeps track of legitimately generated AO's. System 2210 may comprise an AO inspector 2211, a hashing engine 2212, an event-condition-action (ECA) rules engine 2213, and a data store 2214.

AO inspector 2211 may be configured to use faculties of ACDP 2100, for example DCG module 2155 and associated transformer modules to analyze and process AO's associated with incoming connections, and observation and state estimation services 2140 to monitor connections for incoming AO's. Incoming AO's may be retrieved for further analysis by system 2210.

Hashing engine 2212 may be configured to calculate a cryptographic hash for AOs generated by identity provider 2222 using functions of ACDP 2100, such as DCG module 2155, generate a cryptographic hash for both incoming AO's (for analysis purposes), and new AO's created by IdP 2222. A one-way hash may be used to allow protecting of sensitive information contained in the AO, but preserving uniqueness of each AO. Generated hashes may be stored in data store 2214. Hashing engine may also run a hash check function, used for validating incoming AO's.

ECA rules engine 2213 may be used by a network administrator to create and manage ECA rules that may trigger actions and queries in the event of detection of a forged AO. Rules may be for example, tracking and logging the actions of the suspicious user, deferring the suspicious connection, and the like. Rules may be nested to create a complex flow of various conditional checks and actions to create a set of “circuit breaker” checks to further ascertain the connection, or try and resolve the matter automatically before notifying a human network administrator.

Data store 2214 may be a graph and time-series hybrid database, such as multidimensional time-series data store 2120 or data store 2112, that stores hashes, ECA rules, log data, and the like, and may be quickly and efficiently queried and processed using ACDP 2100.

Federated service providers 2221a-n may comprise a group of trusted service partners that may share a common IdP 2222 in which user 2220 may wish to access. Federated service providers 921a-n may be, for instance, services employing MICROSOFT'S ACTIVE DIRECTORY FEDERATED SERVICES (AS DS), AZURE AD, OKTA, many web browser single-sign-on (SSO) implementations, cloud service provides (such as, AMAZON AWS, AZURE, and GOOGLE), and the like.

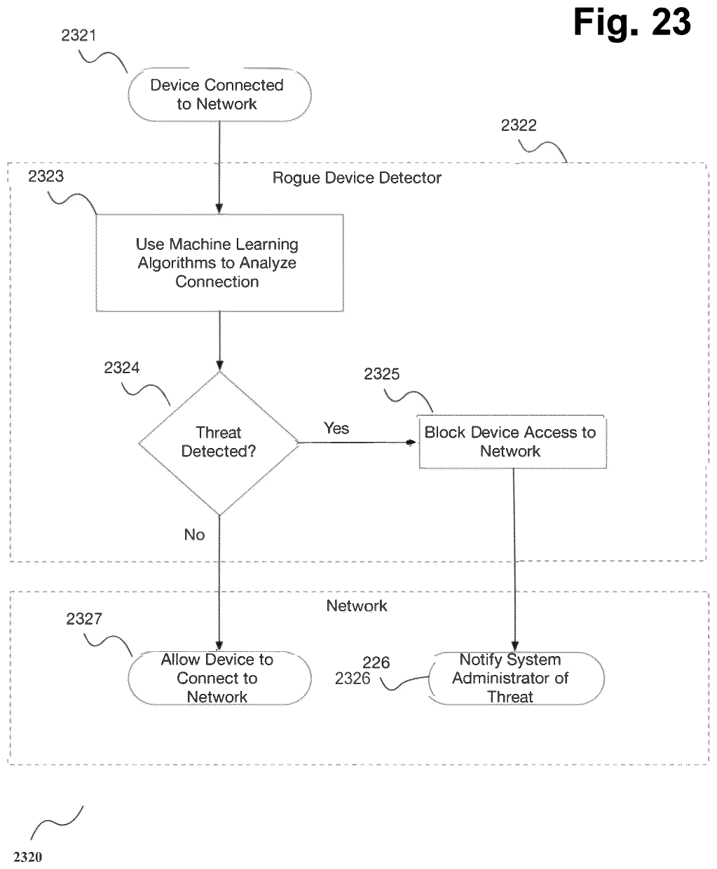

FIG. 23 is a process diagram showing a general flow of the process used to detect rogue devices and analyze them for threats 2320. Whenever a device is connected to the network 2321, the connection is immediately sent to the rogue device detector 2322 for analysis. The advanced cyber decision platform uses machine learning algorithms to analyze system-wide data to detect threats. The connected device is analyzed 2323 to assess its device type, settings, and capabilities, the sensitivity of the data stored on the server to which the device wishes to connect, network activity, server logs, remote queries, and a multitude of other data to determine the level of threat associated with the device. If the threat reaches a certain level 2324, the device is automatically prevented from accessing the network 2325, and the system administrator is notified of the potential threat, along with contextually-based, tactical recommendations for optimal response based on potential impact 226. Otherwise, the device is allowed to connect to the network 2327.

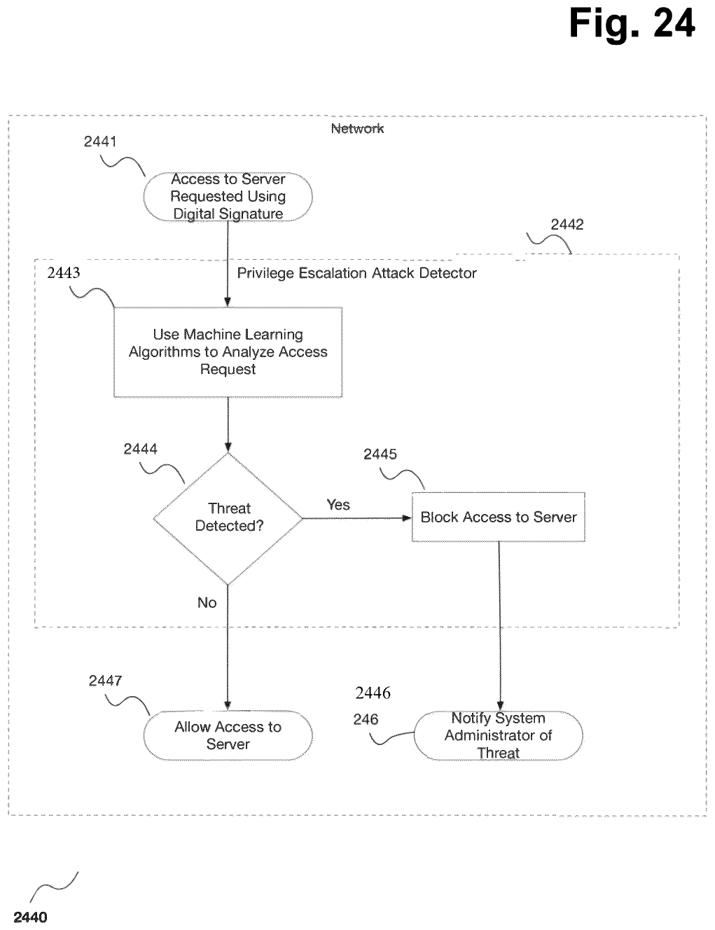

FIG. 24 is a process diagram showing a general flow of the process used to detect and prevent privilege escalation attacks on a network (for example, “Golden Ticket” attacks or “golden SAML” attacks) 2440. When access to a server within the network is requested using a digital signature or AO 2441, the connection is immediately sent to the privilege escalation attack detector 2442 for analysis. The advanced cyber decision platform uses machine learning algorithms to analyze system-wide data to detect threats. The access request is analyzed 2443 to assess the validity of the access request using the digital signature validation, plus other system-wide information such as the sensitivity of the server being accessed, the newness of the digital signature or AO, the digital signature's or AO's prior usage, and other measures of the digital signature's or AO's validity. If the assessment determines that the access request represents a significant threat 2444, even despite the Kerberos validation of the digital signature or validation of a AO, the access request is automatically denied 2445, and the system administrator is notified of the potential threat, along with contextually-based, tactical recommendations for optimal response based on potential impact 2446. Otherwise, the access request is granted 2447.

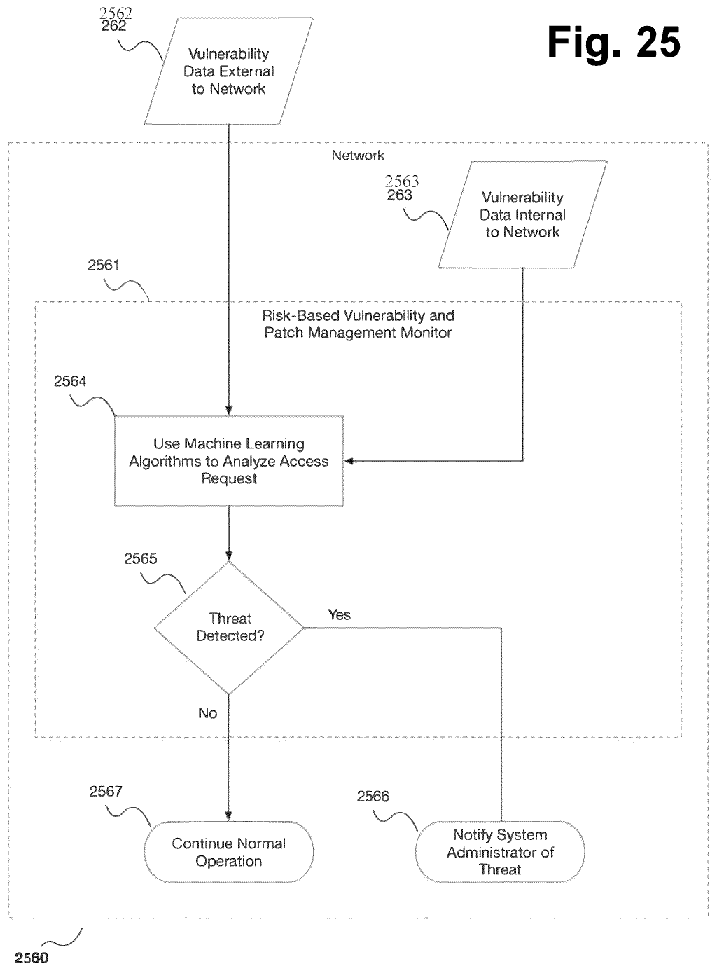

FIG. 25 is a process diagram showing a general flow of the process used to manage vulnerabilities associated with patches to network software 2560. As part of a continuously-operating risk-based vulnerability and patch management monitor 2561, data is gathered from both sources external to the network 2562 and internal to the network 2563. The advanced cyber decision platform uses machine learning algorithms to analyze system-wide data to detect threats. The data is analyzed 2564 to determine whether network vulnerabilities exist for which a patch has not yet been created and/or applied. If the assessment determines that such a vulnerability exists 2565, whether or not all software has been patched according to manufacturer recommendations, the system administrator is notified of the potential vulnerability, along with contextually-based, tactical recommendations for optimal response based on potential impact 2566. Otherwise, network activity is allowed to continue normally 2567.

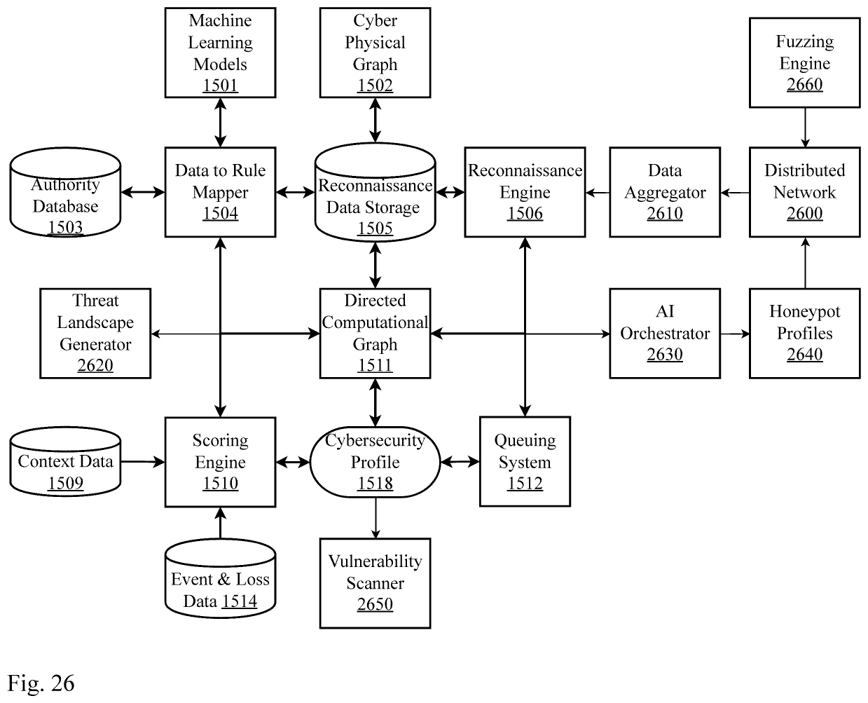

FIG. 26 is a block diagram illustrating an exemplary system architecture for a system for an AI-controlled sensor network for threat mapping and characterization. Central to the system is a distributed network 2600, which comprises a wide array of sensors and honeypots strategically deployed across various geographic locations and network segments. This distributed nature allows for a more holistic view of internet traffic and potential threats, capturing data from multiple vantage points to create a more accurate and comprehensive threat landscape.

Distributed network 2600 feeds into a data aggregator 2610, which serves as a central collection point for all the information gathered by the sensors and honeypots. This component streamlines handling the high volume and variety of data coming from multiple sources, ensuring that all relevant information is properly collected, preprocessed, and organized for further analysis. Data aggregator 2610 is designed to handle irregular and high-volume surges of data, dynamically allocating network bandwidth and processing resources to manage incoming information efficiently.

A reconnaissance engine 1506 can access data processes by data aggregator 2610 and is responsible for actively gathering information about potential threats and vulnerabilities. Reconnaissance engine 1506 may utilize various techniques, including passive monitoring and active probing, to collect data on network configurations, open ports, services, and potential vulnerabilities. In one embodiment, reconnaissance engine 1506 may work in tandem with a vulnerability scanner 2650 and a fuzzing engine 2660 to provide a comprehensive view of potential security weaknesses.

The vulnerability scanner 2650 systematically checks the honeypots and other monitored systems for known vulnerabilities, misconfigurations, or outdated software versions that could be exploited by attackers. Vulnerability scanner 2650 plays a role in ensuring that the honeypots accurately simulate vulnerable systems while also providing valuable data on the types of vulnerabilities that attackers are targeting.

Fuzzing engine 2660 complements vulnerability scanner 2650 by generating diverse and often malformed inputs to test the robustness of honeypot services and simulate a wide range of potential attack vectors. This component is vital for uncovering unknown vulnerabilities and providing rich data on attack patterns and techniques. The fuzzing engine 2660 works closely with the honeypot profiles 2640 to create dynamic, responsive honeypots that can adapt to new attack techniques.

Honeypot profiles 2640 component is a key element in the system, responsible for managing the configuration and behavior of the various honeypots deployed in the distributed network. These profiles are dynamically generated and updated by an AI orchestrator 2630 based on current threat intelligence and observed traffic patterns. Each honeypot profile may include details such as the simulated operating system, open ports, services, and vulnerabilities, as well as behavioral characteristics, including data access patterns, designed to make the honeypot attractive and convincing to potential attackers. The honey token profiles encompass various types including fake email addresses, database records, executable files with tracking capabilities, web beacons, browser cookies, canary traps, and cloud service credentials such as AWS keys. These honey tokens are strategically placed within both honeypot systems and legitimate infrastructure to enable tracking of attacker movement, identification of insider threats, and collection of valuable intelligence about the attacker tactics, techniques and procedures (TTPs). The system maintains a balance between the authenticity of the deceptive assets and their tracking capabilities, ensuring that deployed tokens and honeypots remain credible while maximizing their effectiveness for threat detection and intelligence gathering.

AI orchestrator 2630 serves as the brain of the entire system, leveraging advanced machine learning models 1501 to analyze data, make decisions, manage resources, and coordinate the various components of the network. It continuously monitors the data flowing through the system, identifies patterns and anomalies, and makes real-time adjustments to optimize the network's effectiveness in detecting and characterizing threats. AI orchestrator 2630 is responsible for dynamically updating honeypot profiles, allocating resources, and coordinating the activities of other system components to maintain an adaptive and responsive security posture.

Threat landscape generator 2620 takes the analyzed data from an AI orchestrator 2630 and other components to produce a comprehensive view of the current cybersecurity threat environment. This includes identifying trends in attack patterns, emerging threats, geographical or IP space patterns, and potential vulnerabilities across the monitored network. The threat landscape provides valuable context for interpreting individual events and helps in predicting future reconnaissance and attack vectors.

The system incorporates several databases and data processing components to support its operations. Reconnaissance data storage 1505 holds the raw and processed data collected by the reconnaissance engine 1506, honeypot network, OSINT data, and other components. Authority database 1503 contains laws, policies, and other rules used to evaluate the legality and compliance of observed network activities. Cyber-physical graph 1502 represents the complete picture of an organization's infrastructure and operations, including network topology, device relationships, and data flows.

Another embodiment augments the system with continuous ingestion of external data sources such as open-source intelligence feeds, code repositories, and exploit proof-of-concept releases. The AI orchestrator monitors these sources for newly published vulnerabilities or exploit code, including zero-day attacks, side-channel exploits, or advanced persistent threat (APT) toolkits. Upon detecting relevant or trending exploits, the system automatically updates honeypot profiles with simulated weaknesses aligned to the newly discovered threat vectors. This integration ensures the honeypots remain proactively current, even against threats first documented by the open-source community or specialized security research collectives. Additionally, the AI-driven orchestrator correlates code-level changes from repository commits with real-time traffic patterns in the distributed sensor network, identifying anomalies or suspicious behaviors that align with recently published exploit classes.

Data-to-rule mapper 1504 is used to compare the collected reconnaissance data against the rules stored in the authority database 1503, helping to identify potential compliance issues or policy violations. This component plays a crucial role in ensuring that the system's threat assessments take into account legal and regulatory requirements. A directed computational graph 1511 contains representations of complex processing pipelines and is used to control workflows through the system. It may work in conjunction with queuing system 1512 to manage and prioritize various analysis and detection tasks.

Scoring engine 1510 integrates information from multiple sources, including the threat landscape, vulnerability assessments, and compliance checks, to generate a comprehensive cybersecurity profile 1518 for the monitored organization or network. This profile may take into account various factors, including network resilience, potential impact of identified threats, and historical event and loss data 1514. Context data 1509 is used throughout the system to provide additional information that may be relevant to threat assessment and risk scoring. This could include information about the organization's business operations, critical assets, or industry-specific threat intelligence.

Machine learning models 1501 are employed by various modules to identify patterns, detect anomalies, and make predictions. These models are continuously updated and refined based on new data and observed outcomes, allowing the system to improve its accuracy and effectiveness over time.

This AI-controlled sensor network for threat mapping and characterization represents a significant advancement over traditional security information and event management (SIEM) tools. By leveraging a distributed network of sensors and honeypots, advanced AI-driven analysis, and a comprehensive approach to threat modeling, the system provides a more nuanced and adaptive approach to cybersecurity. It not only detects and responds to current threats but also anticipates future attack vectors, allowing organizations to proactively strengthen their security posture.

In one embodiment, the AI-controlled sensor network for threat mapping and characterization can be further enhanced by implementing advanced real-time manipulation of sensors and systems. The system incorporates an AI orchestrator 2360 that includes a neural network-based control policy to provide rapid, adaptive responses to changing network conditions.

The AI orchestrator 2630 may be represented by one or more neural networks such as a feed forward, recurrent, or convolutional networks with carefully designed architectures. The orchestrator receives sensor data, sensor profile and configuration information, open source intelligence data, and target parameters. This data is then processed through one or more orchestrator subsystems which may include one or more neural networks, decision trees, heuristics, rule sets, and may be executed using a computational graph to meet real-time or near real-time control requirements.

AI orchestrator 2630 integrates data from various sensors, including network traffic sensors, honeypot interaction data, system performance metrics, and external threat intelligence feeds. Based on this input, the system outputs control signals for various system actuators, such as honeypot configuration parameters, network traffic routing rules, firewall settings, and resource allocation for different system components.

Additionally, AI orchestrator 2630 may continuously improve its performance through adaptive learning techniques. AI orchestrator 2360 machine learning models may be updated in real-time based on new data and observed outcomes, with a separate network evaluating the performance of the control policy and guiding its optimization. The system balances multiple objectives simultaneously, including maximizing threat detection accuracy, minimizing false positives, optimizing resource utilization, and ensuring system stability and responsiveness.

To handle uncertainties and variations in the network environment, AI orchestrator 2630 may be trained with domain randomization techniques to handle varying network conditions and adversarial training to improve resilience against potential attacks on the control system itself. AI orchestrator 2360 may be pre-trained in simulation and then fine-tuned on the actual network, allowing for rapid deployment of new control strategies and safe exploration of novel control approaches without risking the live network.

To overcome observability in the network environment only where desired, the system may employ advanced state estimation techniques. In one embodiment, an RNN-based network runs in parallel with AI orchestrator 2630, processing historical sensor data to estimate hidden state variables of the network. For certain well-understood system dynamics, traditional Kalman filters are integrated with the neural network approach, combining the benefits of model-based and data-driven estimation. The state estimation system operates on multiple timescales to capture both fast-changing threats and slow-evolving network trends.

Managing the complexity of controlling numerous network elements simultaneously may be achieved through a hierarchical control structure. This occurs when the AI orchestrator 2630 outputs high-level commands, while subsidiary systems or traditional controllers handle low-level execution. These subsidiary systems may be similar or smaller versions of the main AI orchestrator, and may be given more detailed expertise in particular domains. The control policy uses attention layers to focus on the most relevant sensors and actuators for a given situation. Additionally, autoencoder networks may be used to compress high-dimensional sensor data into a lower-dimensional latent space for more efficient processing.

By incorporating these advanced AI-driven control techniques, the system can provide increased levels of adaptability, responsiveness, and effectiveness in real-time activity classification, threat detection and mitigation. This approach allows for continuous optimization of the entire sensor network and security infrastructure, enabling rapid responses to emerging threats and changing network conditions. The real-time manipulation of sensors and systems, guided by sophisticated AI algorithms, represents a significant advancement in cybersecurity technology, offering a proactive and highly adaptive defense against evolving cyber threats.

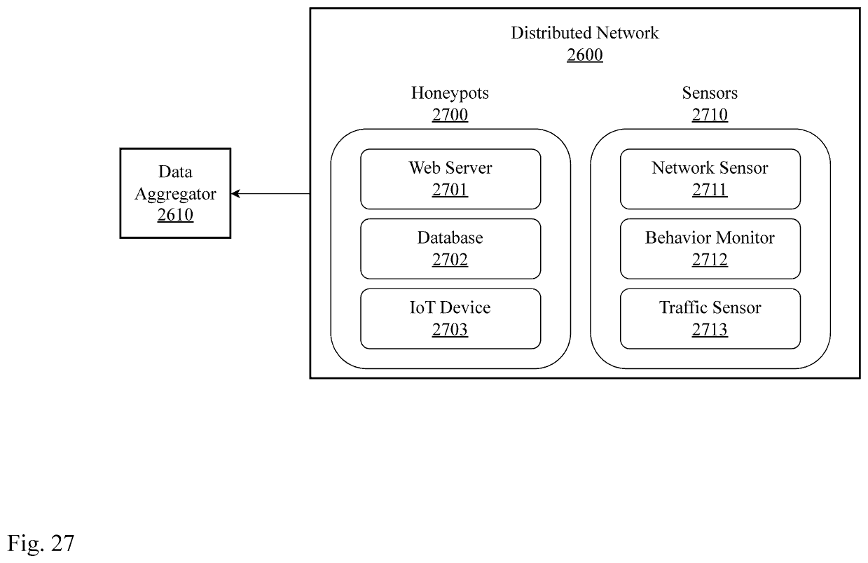

FIG. 27 is a block diagram illustrating an exemplary component of a system for an AI-controlled sensor network for threat mapping and characterization, a distributed network. This distributed network forms the foundation of the system's data collection capabilities, strategically deploying a variety of honeypots and sensors across different network segments and geographical locations to capture a comprehensive view of network activity and potential threats. At the heart of the distributed network is data aggregator 2610, which serves as the central hub for collecting, preprocessing, and organizing the vast amounts of data generated by the various honeypots and sensors. Data aggregator 2610 is designed to handle high volumes of heterogeneous data streams, dynamically allocating resources to manage irregular surges in data input. This component ensures that all relevant information is efficiently captured and prepared for further analysis by other system components.

Distributed network 2600 is comprised of two main categories of data collection points: honeypots 2700 and sensors 2710. These components work in tandem to provide a multi-faceted view of network activity, capturing both targeted attacks and general network behavior. The honeypots 2700 are deliberately vulnerable systems designed to attract and engage potential attackers, allowing the system to study their techniques and motivations. In the example depicted are three types of honeypots, each simulating a different kind of target. A web server honeypot 2701 emulates a typical web server, complete with configurable vulnerabilities and services. This honeypot is particularly effective in detecting and analyzing web-based attacks, such as SQL injection attempts, cross-site scripting (XSS), and other application-layer exploits. A database honeypot 2702 simulates a database server, allowing the system to monitor attempts at unauthorized data access or manipulation. This honeypot can be configured to mimic various database management systems, providing insights into database-specific attack vectors. An IoT device honeypot 2703 replicates the behavior of Internet of Things devices, which are increasingly targeted in cyberattacks due to their often limited security measures. This honeypot can be customized to emulate a wide range of IoT devices, from smart home appliances to industrial control systems, capturing data on the unique threats facing these devices.

Each honeypot is dynamically configured and managed by AI orchestrator 2630, which uses machine learning models capable of adapting the honeypots' behaviors, services, and vulnerabilities based on observed traffic and attack patterns, orchestrator prescribed configurations, and current threat intelligence. This adaptive approach ensures that the honeypots remain attractive and convincing to potential attackers, maximizing their effectiveness in capturing valuable threat data. Complementing the honeypots are the sensors 2710, which passively monitor network traffic and system behaviors to detect anomalies and potential threats. Additionally FIG. 27 depicts three types of sensors as examples. A network sensor 2711 monitors overall network traffic, capturing data on communication patterns, protocol usage, and potential network-level attacks such as denial of service attempts or port scans. A behavior monitor 2712 focuses on analyzing the behavior of systems and users within the network. This sensor can detect anomalies such as unusual login patterns, unexpected privilege escalations, or suspicious file access attempts, which may indicate a compromised account or an insider threat. A traffic sensor 2713 specializes in deep packet inspection, examining the content of network traffic to identify potential threats hidden within the data stream. This can include fingerprinting SSL/TLS handshake characteristics, performing deep packet inspection of encrypted traffic using server-side cryptographic keys (for protocols such as HTTPS and SSL), detecting protocol anomalies in services like DNS, analyzing web request patterns including URL structures and query parameters, and identifying non-standard or malformed protocol headers. The analysis engine can process both standard protocol behaviors and edge cases that may indicate attempted exploitation or protocol manipulation. This sensor can detect malware signatures, data exfiltration attempts, or command and control communications. It can also identify stealthy attack patterns that attempt to evade detection through distributed low-volume traffic across broad network segments. This includes detection of low-and-slow reconnaissance techniques and attacks that deliberately mimic legitimate network behavior. By correlating seemingly benign activities across time and space, the system can identify coordinated malicious behavior that might otherwise remain below traditional detection thresholds.

In another embodiment, the system may implement advanced hooking mechanisms (e.g., graph-based processing analyses and just-in-time (JIT) event emulation) to supplement hypervisor-level introspection when deploying honeypots in virtual machines. By hooking low-level system calls and monitoring kernel events in real time, the system intercepts and inspects critical OS behaviors (e.g., process creation, file I/O, and driver loading) before the underlying OS executes them. These hooks can be installed at the hypervisor layer or through privileged modules in the virtual machine kernel, allowing the AI orchestrator to observe suspicious or inconsistent invocation patterns that might signal stealthy malware attempting to hide processes, escalate privileges, or inject code into legitimate binaries. For instance, when a rootkit attempts to patch the system call table on a Linux VM, it triggers a hooking event, prompting a real-time introspection snapshot of the relevant kernel memory pages and CPU register states.

Once hooking events are captured, a graph-based processing engine analyzes the relationships among these low-level traces. Each file handle, process identifier, and memory allocation is represented as a node in a directed graph, while system calls and resource modifications are modeled as edges with timestamps and contextual metadata. This event-driven graph can quickly highlight anomalous clusters or suspicious chains-such as a rarely used network service spawning a hidden process that writes to a kernel-protected memory region. By tracking changes in graph structure and edge density over time, the system can detect advanced multi-step or multi-host attacks that otherwise evade detection by conventional signature-based methods. For example, if hooking reveals that a malicious process modifies system libraries at intervals too sporadic to register as a simple infection pattern, the graph-based engine correlates these partial anomalies across different honeypots, alerting the orchestrator to a likely rootkit deployment.

Additionally, the system implements just-in-time (JIT) event emulation for complex crash or memory dump analysis. When an OS crash or severe memory anomaly is triggered—whether intentionally by an exploit or accidentally from malformed code—the system captures the crash dump and initiates partial emulation in a sandboxed environment. This JIT environment replays relevant hooking events and kernel states leading up to the crash, allowing the orchestrator to pinpoint the code path or system calls that caused the error. On a Windows VM, for instance, the system can automatically parse the Blue Screen of Death (BSOD) crash dump and replay the final call stack to examine hidden driver hooks or suspicious process handle manipulations. On a Linux VM, it can re-run a partial execution trace of the kernel logs or system journal entries to identify orphaned processes and tampered modules. Because the introspection and hooking steps have continuously collected the necessary memory snapshots and call sequences, the JIT emulation can precisely reconstruct the final actions taken by the malware or exploit tool-often revealing custom shellcode, dynamic library injections, or ephemeral kernel module alterations. This combined approach of hooking, graph-based processing, and JIT event emulation significantly improves sensor network performance. It grants the AI orchestrator near-real-time visibility into stealthy modifications and advanced rootkit tactics while generating granular forensic data for post-mortem analysis. These capabilities prevent adversaries from simply relying on ephemeral footprints or short-lived exploit sequences to evade detection, ultimately strengthening the honeypot ecosystem's ability to adapt, respond, and self-recover in virtualized environments.

In a further embodiment, the system leverages a sliding time and space context window to dynamically adjust both the observation horizon (i.e., the time dimension) and the sensor groupings or “zones of interest” (i.e., the spatial dimension) used to monitor and analyze threat signals. Concretely, the AI orchestrator assigns each sensor or sensor team a flexible context window that can either shrink to short timescales and localized areas when high-frequency anomalies or suspected exploits emerge, or expand to longer timescales and broader regions when subtler, slow-moving threat vectors need to be captured. For instance, upon detecting suspicious honeypot engagement in a targeted network segment, the system might reduce the relevant sensor window to a few minutes of activity and a narrow network zone, facilitating rapid signal collection of ephemeral malware injections or short-lived tunneling attempts. Meanwhile, in surrounding or lower-risk segments, the system might adopt an hours- or days-long window to capture stealth reconnaissance, repeated scanning patterns, or cross-segment correlations.

A practical illustration involves multiple OS platforms and hybrid environments (on-premises, virtualized, and cloud-based) where the orchestrator spawns narrower context windows around newly identified hooking activity or suspicious kernel modifications—particularly if VM introspection logs detect changes in CPU registers or memory pages. By zooming in on a short time window, the system captures the micro-patterns leading up to a potential exploit. Simultaneously, a wider time window might be applied to sensor clusters across the rest of the data center, giving the AI orchestrator a macro-level view of possible lateral movements or coordinated intrusions that emerge gradually.

Under the hood, each sensor's events and logs—such as hooking triggers, partial crash dumps, or memory snapshots—are represented within a graph-based processing framework. The system organizes hooking traces or anomalies as nodes and edges in an event knowledge graph (EKG), leveraging contextual embeddings (e.g., arguments of events, OS calls, and timestamps) to analyze interactions among hooking events across different VMs or OS instances. The “sliding” aspect means the system continuously re-evaluates whether to expand or contract the window for any sensor cluster, factoring in local triage metrics such as newly discovered hooking attempts, suspicious transitions in ephemeral containers or virtual machines, or aggregated dwell-time indicators. Through this process, the multi-level risk-based triaging module dynamically identifies high-priority windows at finer granularity while still preserving a global vantage point for cross-device correlations.

In more severe cases—such as repeated kernel panics or manipulated process descriptor tables—just-in-time (JIT) emulation is invoked. The orchestrator replays the hooking and crash events within a narrower time window around the failure, using partial snapshots or crash dumps from different OS versions (Windows, Linux, etc.) to reconstruct the suspect code path. This reconstruction is informed by the hooking events recorded in the EKG: the system can quickly identify which hooking patterns preceded the crash and which memory blocks have been altered. Through these coordinated temporal-spatial context windows and the event knowledge graph, the orchestrator integrates near-real-time hooking data, historical cross-segment relationships, and post-failure JIT emulation. This synergy ensures that subtle or cross-platform threats are surfaced sooner, triaged more accurately, and used to adapt honeypot redeployment and sensor configurations, thereby continually refining the system's risk and threat prioritization across the entire networked environment.

In many respects, “The White-Hat Hacking Machine: Meet Mayhem, winner of the DARPA context to find and repair software vulnerabilities.” IEEE SPECTRUM 56.2 (2019): 30-35, Brumley, David. Herein now referred to as Mayhem. Mayhem (and related self-driving hacking approaches) demonstrated how automated software analysis, vulnerability discovery, and patching could be carried out without direct human intervention. The system excelled at programmatic “capture the flag” style tasks, combining symbolic execution and fuzzing to identify and exploit zero-day weaknesses under controlled conditions. It further offered basic automated patching capabilities, showing that near-real-time detection and remediation of software bugs is feasible. However, the architecture described here surpasses Mayhem's scope on several critical dimensions. Regarding Multi-Domain Sensor Integration (Global+Mobile), this system implements Background Noise Capture that operates beyond isolated or artificially bounded environments. It spreads sensors—both fixed and mobile—across on-premises data centers, private cloud networks, IoT gateways, and even Onionspace/Tor exit nodes. This broad sensor array supplies a much richer tapestry of inbound, outbound, and lateral threat traffic. The Zone-Flexible Monitoring allows the distributed sensor network to concentrate in specific subnets, geographic areas, or “cyber enclaves” (e.g., container clusters, ICS/OT segments, or ephemeral cloud fleets) when heightened risk is detected, or it can remain in a widely dispersed posture for baseline and background scanning. Through field-informed context windows, real-time triggers, anomaly detection, or scanning initiatives can cause the AI orchestrator to “slide” the sensor context window in both time and space. This allows the system to isolate ephemeral or newly discovered behaviors—especially subtle infiltration attempts or reemerging advanced persistent threats (APTs)—and gather sensor intelligence at fine or coarse scales as needed.

The Comprehensive Software Bill Of Materials (SBOM) Graph Analysis provides granular dependency tracking that surpasses Mayhem's capabilities, which primarily reasoned about compiled artifacts in isolation. This approach correlates discovered vulnerabilities directly with an SBOM graph that maps every open-source library, license, transitive dependency, or internal closed-source component. In Attack Path Visualization, through SBOM-driven relationships, the system enumerates “where else” a discovered flaw might apply-whether it's a chain of microservices sharing a compromised library or a monolithic but closed-source application embedding known-vulnerable modules. When Interleaving with detections, the system observes hooking attempts, partial crash dumps, or suspicious call-stack manipulations and aligns those signals with the SBOM-based component graph. This alignment reveals whether code in question maps to an internal function, an open-source routine, or an unpatched proprietary library. The adaptive patching strategies utilize an SBOM overlay to help auto-generated patches remain context-aware: They can be tested at small scales, thoroughly verifying performance overhead or regression risks, and then carefully deployed across clones of that library or module in other sub-systems.

Automated introspection and semantic analysis provides holistic observability beyond scanning static binaries. The system employs real-time hooking data, dynamic tracing, VM introspection (tracking CPU registers, memory pages, kernel driver calls), and ephemeral crash reconstruction. These runtime signals provide a more complete picture than fuzzing/symbolic execution alone. Through distributed triage and resilience, sensor nodes trigger local or global JIT (just-in-time) emulation if an unexpected partial crash or exploitation signature is detected. This means the system can revert to known-good states or generate micro-patches on demand, guided by both the vulnerability context and SBOM relationships.

The Rich Honeypot and Sandbox Ecosystem implements a Global Honeypot Grid where the system's honeypots—ranging from standard OS images to specialized OT/IoT simulator nodes—are arranged in a hierarchical mesh. This coverage ensures that known Internet-scale attack vectors (e.g., onion-routed exploit attempts, random port scanning, DoS variants) are captured in one region, while private or classified networks run specialized honeypots for domain-specific threat research. Context-aware denial & engagement allows sensor triggers from one sub-network to prompt ephemeral honeypot spin-ups in a neighboring sub-network to attract or stall an intruder, enabling the system to gather forensics at a deeper level than Mayhem's single-application vantage point. Through coordinated attack reconstruction, each honeypot instance logs hooking events, memory dumps, and emergent behaviors. These feeds are aggregated in a global event knowledge graph, allowing the system to correlate distributed intrusion attempts that share TTPs (tactics, techniques, procedures). The ecosystem scale and mixed OS support extends to diverse OS, kernel, and embedded targets. While Mayhem excelled primarily on Linux-based challenge sets, this broader design can operate across heterogeneous infrastructures: Windows, Linux, macOS, real-time OS used in embedded devices, as well as container base images. Industrial Integration means that because the system manages SBOM-driven vulnerability reporting alongside partial or fully automated patching, enterprise security teams and dev/ops squads can selectively adopt or refine auto-patch strategies.

Regarding adaptive defense for zero-days and post-exploitation, this system goes beyond crashing. While Mayhem's scoring focus was on demonstrating code exploits via system crashes or function hijacking, this system also detects stealthy hooking modifications that do not yield obvious crashes—like kernel rootkits that run stably for weeks or supply chain implants that hijack ephemeral processes in container orchestration frameworks. The Global “Knowledge Booster” ensures observed hooking or partial exploit attempts are cross-referenced with public vulnerability feeds, private threat intelligence, or open-source disclosures. Even if no direct CVE is recognized, the system can cluster new zero-day variants by code signatures or hooking patterns.

In summary, while Mayhem showcased the immense power of automated binary analysis combined with fuzzing and symbolic execution in a single-machine context, the approach presented here pushes well beyond those boundaries. It merges a globally distributed honeypot/sensor architecture (including ephemeral mobile sensors) with advanced introspection, bridging normal Internet background noise, private networks, and specialized enclaves. It seamlessly integrates SBOM-based software dependency graphs, enabling more precise vulnerability tracking and targeted patching across heterogeneous codebases. It enriches detection and remediation with real-time hooking records, crash-dump correlation, and dynamic sandbox replays, fostering a more comprehensive auto-defend loop than Mayhem's single-instance exploit/patch cycle. These novel components together form a unified system that not only detects zero-day exploits as elegantly as Mayhem did in the DARPA CGC environment but also orchestrates adaptive scanning, multi-layer patching, SBOM-driven vulnerability matching, and near-real-time introspection and triage-addressing the demands of genuine, large-scale enterprise and national-security software ecosystems.

These sensors operate continuously, providing a real-time stream of data to data aggregator 2610. The combination of active honeypots and passive sensors allows the system to build a comprehensive picture of both active reconnaissance, attempted attacks and the overall network environment. The distributed nature of this network is key to its effectiveness. By deploying honeypots and sensors across various network segments and geographical locations, the system can detect and correlate threats that may only be visible from a particular vantage point. This distributed approach also allows for the identification of coordinated attacks or campaigns targeting multiple points of an organization's infrastructure. Furthermore, the system's ability to dynamically reconfigure and optimize the deployment of honeypots and sensors based on current threat intelligence and observed patterns enhances its adaptability. AI orchestrator 2630 can, for example, spin up additional honeypots in response to emerging threats, reconfigure existing honeypots to gather additional or more detailed information on a particular pattern being observed, or reallocate sensor resources to focus on areas of the network experiencing unusual activity.

This sophisticated distributed network, with its array of honeypots and sensors feeding into a central data aggregator, forms the foundation of the AI-controlled sensor network's threat detection and characterization capabilities. By providing a rich, multifaceted stream of data, it enables the system to perform advanced analytics, generate comprehensive threat landscapes, and ultimately deliver actionable intelligence for enhancing an organization's cybersecurity posture.

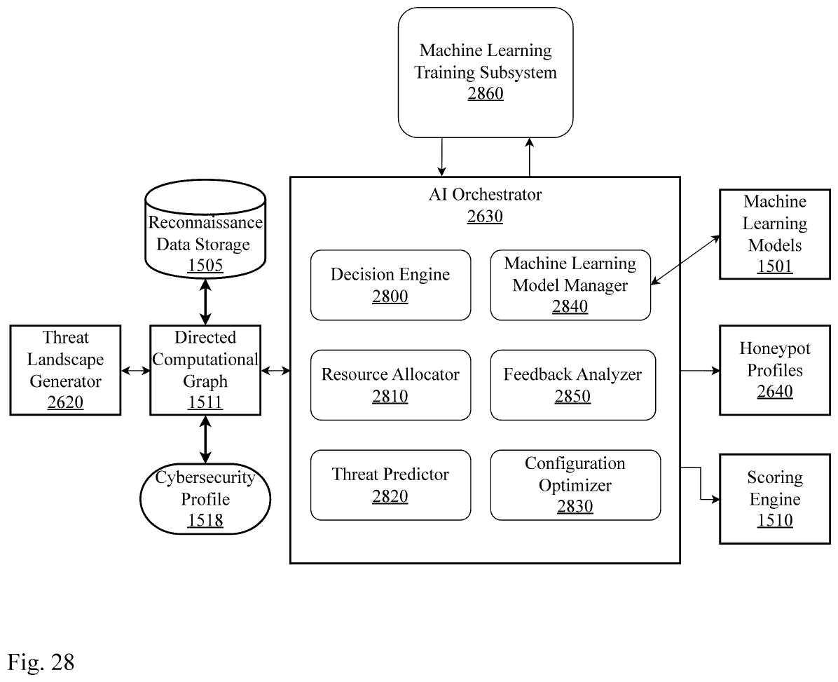

FIG. 28 is a block diagram illustrating an exemplary component of a system for an AI-controlled sensor network for threat mapping and characterization, an AI orchestrator. This figure illustrates the intricate interplay between various subcomponents that enable AI orchestrator 2630 to effectively manage and optimize the entire system's operations. AI orchestrator 2630 serves as the central intelligence hub, coordinating activities, processing information, and making decisions that affect all other components of the network.

Central to AI orchestrator 2630 is a decision engine 2800, which is responsible for high-level decision-making based on inputs from other subsystems. Decision engine 2800 analyzes the complex data streams flowing through the system and determines the most appropriate actions to take in response to detected threats or changing network conditions. Decision engine 2800 works closely with threat predictor 2820, which may use advanced analytics and machine learning techniques to forecast potential future threats based on current data, enrichment data such as port scan or OSINT data, and historical trends. This predictive capability allows the system to take proactive measures, adjusting its defenses before an attack occurs.

A resource allocator 2810 aids in optimizing the system's performance by dynamically distributing computational and network resources across various components. It ensures that the most critical tasks receive priority attention and that the system's capabilities are used efficiently. This component is particularly important when dealing with sudden surges in network activity or when responding to emerging threats that require rapid reallocation of resources.

A configuration optimizer 2830 works in tandem with honeypot profiles 2640 to continually refine and adjust the settings of the various honeypots deployed across the network. By analyzing the effectiveness of current configurations and considering the latest threat intelligence, this optimizer ensures that the honeypots remain convincing and attractive to potential attackers while maximizing their data collection capabilities.

Central to the AI orchestrator's 2630 learning capabilities is a machine learning model manager 2840. This component oversees the selection, training, and deployment of various machine learning models used throughout the system. It works closely with machine learning models 1501 to ensure that the most appropriate algorithms are used for different tasks, such as anomaly detection, pattern recognition, and predictive analysis. Machine learning model manager 2840 also coordinates with machine learning training subsystem 2860, which is responsible for continuously updating and refining the models based on new data and observed outcomes.

A feedback analyzer 2850 plays a crucial role in the system's adaptive capabilities. It processes feedback from various system components, including the results of honeypot interactions, sensor data, and the outcomes of previous decisions. This analysis helps the system learn from its experiences, refining its strategies and improving its accuracy over time. The insights generated by feedback analyzer 2850 are fed back into decision engine 2800 and other components, creating a closed-loop learning system that becomes more effective with each iteration.

In one embodiment, AI orchestrator 2630 receives data from reconnaissance data storage 1505, which contains the raw and processed information gathered by the system's sensors and honeypots. This data forms the foundation for many of AI orchestrator's 2630 analyses and decisions. Directed computational graph 1511 may be used by AI orchestrator 2630 to manage complex workflows and data processing pipelines, ensuring efficient and logical progression of tasks across the system.

A threat landscape generator 2620 may coordinate with AI orchestrator 2630, using the processed data and insights to create a comprehensive view of the current cybersecurity threat environment. This generated landscape is then used by scoring engine 1510 to assess risks and vulnerabilities, ultimately contributing to the creation of cybersecurity profile 1518 for the monitored organization or network.

Through its various subcomponents and interactions with other system elements, AI orchestrator 2630 embodies the system's ability to adapt, learn, and respond to the ever-changing landscape of cybersecurity threats. Its sophisticated decision-making capabilities, coupled with continuous learning and optimization, enable the AI-controlled sensor network to provide a level of threat detection and response that surpasses traditional security systems. By coordinating the activities of honeypots, sensors, and analytical tools, the AI orchestrator 2630 ensures that the system remains at the forefront of cybersecurity defense, capable of identifying and mitigating both known and emerging threats in real-time.

In a further embodiment, the system incorporates a multi-level risk-based triaging module that combines threat intelligence scores, honeypot engagement data, and enterprise contextual factors (e.g., business-critical processes, regulated data) to determine a prioritized response plan. The AI orchestrator maintains a continuously updated risk register indicating which segments of the network or which honeypot clusters exhibit the highest probability of being targeted. Upon detection of a critical exploit attempt, the system escalates threat events through a hierarchical decision framework. This includes automatically isolating high-value infrastructure, triggering targeted honeypot redeployment around critical assets, and activating additional deep packet inspection modules or advanced logging functions. Concurrently, a real-time risk assessment engine uses a Markov decision process to determine whether to divert suspicious traffic into specialized honeypots for deeper interaction, thereby minimizing false positives in essential production systems while maximizing intelligence collection. Additionally, a ROC curve, confusion matrix, or other similar techniques may be used to aid in sensor, human, agent, or third-party verification of detection efficacy and ongoing signature, model, rule, or escalation or co-pilot guidance events during triage, escalation, and response actions.

In a further embodiment, the system incorporates a sliding time and space context window that continuously adjusts the observation horizon and the sensor groupings responsible for collecting and analyzing threat data. This sliding context window dynamically expands or contracts based on local and global risk signals-such as spikes in honeypot engagement, newly published exploits, or network anomalies detected in neighboring segments. In practical terms, the system may shrink the time window around a single sensor to provide extremely granular near-real-time monitoring in response to emerging threats, or conversely, widen the time window to days or weeks across multiple sensors or sensor teams to capture slower, more stealthy attack patterns indicative of long-term reconnaissance or advanced persistent threats.

By maintaining multiple, concurrently shifting time and space windows, the multi-level risk-based triaging module refines how threats are prioritized and assessed. For instance, in a high-risk zone adjacent to critical assets, the system may invoke a tight sliding window spanning only a few minutes and focusing on a handful of honeypots or sensors that have consistently flagged suspicious behavior. Simultaneously, a broader window might encompass an entire data center network over a longer period, analyzing suspicious traffic volumes or lateral movement attempts that unfold more gradually. These concurrent windows provide the AI orchestrator with a layered view of potential attacks, enabling it to cross-correlate rapid bursts of malicious activity with slower, more distributed anomalies that might otherwise go unnoticed.

When the triaging module recognizes patterns tied to a critical exploit attempt, it automatically escalates the threat event based on how the suspicious traffic aligns with observed behaviors across these context windows. If multiple short-timescale anomalies correlate with subtle long-timescale indicators (e.g., unusual port scanning spikes from a consistent IP range combined with weeks-long infiltration attempts), the system raises the threat priority. This approach triggers immediate measures such as isolating sensitive infrastructure or activating deep packet inspection while also updating the Markov decision process used to decide whether to reroute traffic toward specialized honeypots. As a result, the AI-driven platform can more accurately differentiate random noise or benign anomalies from truly imminent threats that require rapid containment and further intelligence gathering.

Through these adaptive time and space windows, the system maximizes both the resolution of sensor data and the contextual breadth needed to identify sophisticated multi-stage attacks. The sliding windows act as a continual balancing mechanism, ensuring that highly focused, time-sensitive observations augment the broader situational awareness of longer-term, network-wide patterns. Consequently, the real-time risk assessment engine avoids false positives on fleeting anomalies while still gathering critical signals about stealthy or distributed attacks unfolding over days or weeks.

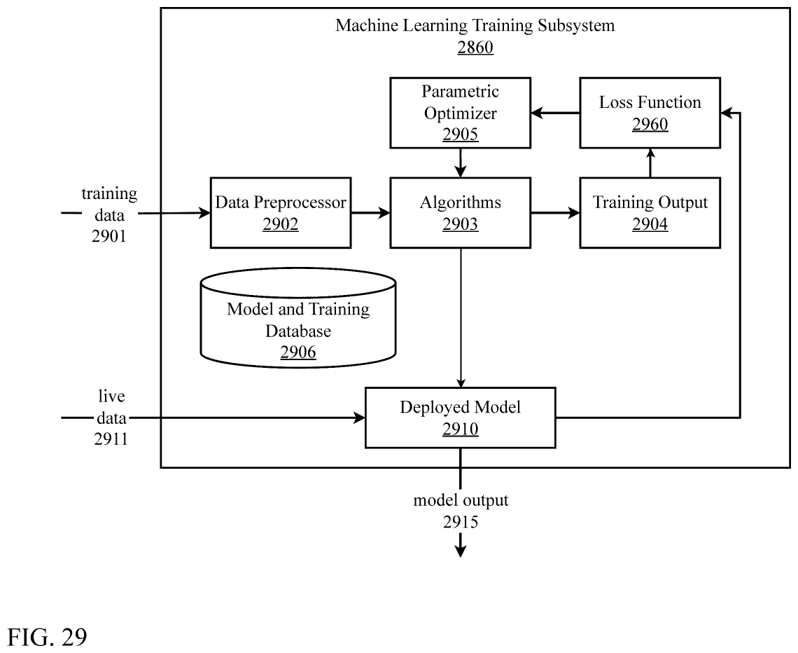

FIG. 29 is a block diagram illustrating an exemplary component of a system for an AI-controlled sensor network for threat mapping and characterization, a machine learning training subsystem. According to the embodiment, the machine learning training subsystem 2860 may comprise a model training stage comprising a data preprocessor 2902, one or more machine and/or deep learning algorithms 2903, training output 2904, and a parametric optimizer 2905, and a model deployment stage comprising a deployed and fully trained model 2910 configured to perform tasks described herein such as processing codewords through a large codeword model. The machine learning training subsystem 2860 may be used to train and deploy a plurality machine learning models and honeypot profiles to support the needs the system.

At the model training stage, a plurality of training data 2901 may be received by the machine learning training subsystem 2860. Data preprocessor 2902 may receive the input data (e.g., honeypot data, sensor data, IoT data, network data) and perform various data preprocessing tasks on the input data to format the data for further processing. For example, data preprocessing can include, but is not limited to, tasks related to data cleansing, data deduplication, data normalization, data transformation, handling missing values, feature extraction and selection, mismatch handling, and/or the like. Data preprocessor 2902 may also be configured to create and maintain a training dataset, a validation dataset, and a test set from the plurality of input data 2901. For example, a training dataset may comprise 80% of the preprocessed input data, the validation set 10%, and the test dataset may comprise the remaining 10% of the data. The preprocessed training dataset may be fed as input into one or more machine and/or deep learning algorithms 2903 to train a predictive model for object monitoring and detection.

During model training, training output 2904 is produced and used to measure the accuracy and usefulness of the predictive outputs. During this process a parametric optimizer 2905 may be used to perform algorithmic tuning between model training iterations. Model parameters and hyperparameters can include, but are not limited to, bias, train-test split ratio, learning rate in optimization algorithms (e.g., gradient descent), choice of optimization algorithm (e.g., gradient descent, stochastic gradient descent, of Adam optimizer, etc.), choice of activation function in a neural network layer (e.g., Sigmoid, ReLu, Tanh, etc.), the choice of cost or loss function the model will use, number of hidden layers in a neural network, number of activation unites in each layer, the drop-out rate in a neural network, number of iterations (epochs) in a training the model, number of clusters in a clustering task, kernel or filter size in convolutional layers, pooling size, batch size, the coefficients (or weights) of linear or logistic regression models, cluster centroids, and/or the like. Parameters and hyperparameters may be tuned and then applied to the next round of model training. In this way, the training stage provides a machine learning training loop.

In some implementations, various accuracy metrics may be used by the machine learning training subsystem 2860 to evaluate a model's performance. Metrics can include, but are not limited to, word error rate (WER), word information loss, speaker identification accuracy (e.g., single stream with multiple speakers), inverse text normalization and normalization error rate, punctuation accuracy, timestamp accuracy, latency, resource consumption, custom vocabulary, sentence-level sentiment analysis, multiple languages supported, cost-to-performance tradeoff, and personal identifying information/payment card industry redaction, to name a few. In one embodiment, the system may utilize a loss function 2960 to measure the system's performance. The loss function 2960 compares the training outputs with an expected output and determined how the algorithm needs to be changed in order to improve the quality of the model output. During the training stage, all outputs may be passed through the loss function 2960 on a continuous loop until the algorithms 2903 are in a position where they can effectively be incorporated into a deployed model 2915.

The test dataset can be used to test the accuracy of the model outputs. If the training model is establishing correlations that satisfy a certain criterion such as but not limited to quality of the correlations and amount of restored lost data, then it can be moved to the model deployment stage as a fully trained and deployed model 2910 in a production environment making predictions based on live input data 2911 (e.g., honeypot data, sensor data, IoT data, network data). Further, model correlations and restorations made by deployed model can be used as feedback and applied to model training in the training stage, wherein the model is continuously learning over time using both training data and live data and predictions. A model and training database 2906 is present and configured to store training/test datasets and developed models. Database 2906 may also store previous versions of models.

According to some embodiments, the one or more machine and/or deep learning models may comprise any suitable algorithm known to those with skill in the art including, but not limited to: LLMs, generative transformers, transformers, supervised learning algorithms such as: regression (e.g., linear, polynomial, logistic, etc.), decision tree, random forest, k-nearest neighbor, support vector machines, Naïve-Bayes algorithm; unsupervised learning algorithms such as clustering algorithms, hidden Markov models, singular value decomposition, and/or the like. Alternatively, or additionally, algorithms 2903 may comprise a deep learning algorithm such as neural networks (e.g., recurrent, convolutional, long short-term memory networks, etc.).

In some implementations, the machine learning training subsystem 2860 automatically generates standardized model scorecards for each model produced to provide rapid insights into the model and training data, maintain model provenance, and track performance over time. These model scorecards provide insights into model framework(s) used, training data, training data specifications such as chip size, stride, data splits, baseline hyperparameters, and other factors. Model scorecards may be stored in database(s) 2906.

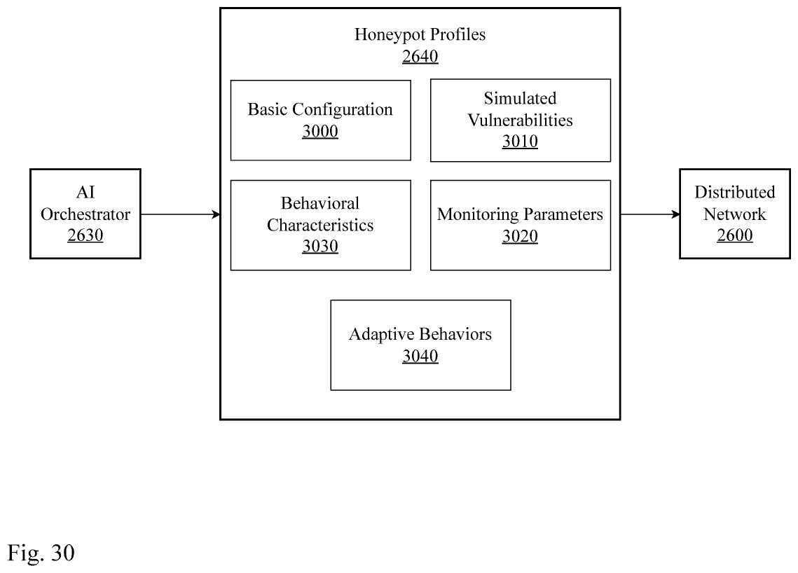

FIG. 30 is a block diagram illustrating an exemplary component of a system for an AI-controlled sensor network for threat mapping and characterization, artificial honeypot profiles. Honeypot profiles 2640 are comprehensive blueprints that define the characteristics and behaviors of the various honeypots deployed throughout the network. These profiles are dynamically generated and continuously updated by AI orchestrator 2630, ensuring that the honeypots remain effective in attracting and engaging potential attackers while providing valuable threat intelligence.

At the core of each honeypot profile is a basic configuration 3000. This includes fundamental attributes such as the simulated operating system, installed software versions, open ports, and network services. The basic configuration serves as the foundation upon which more complex behaviors and interactions are built, establishing the initial facade that potential attackers will encounter.

Simulated vulnerabilities 3010 defines specific weaknesses or misconfigurations that the honeypot will present to potential attackers. These vulnerabilities are carefully crafted to appear realistic and enticing, ranging from common software flaws to more sophisticated misconfigurations. AI orchestrator 2630 continuously updates this component based on current threat intelligence, ensuring that the honeypots simulate relevant and convincing vulnerabilities that align with real-world attack vectors.

Monitoring parameters 3020 define how the honeypot will collect and report data on interactions and attempted exploits. This includes settings for log levels, data capture granularity, and alert thresholds. These parameters are crucial for balancing the need for detailed threat intelligence with system performance and data management considerations.

Behavioral characteristics 3030 encompass the more nuanced aspects of the honeypot's operation. This includes but is not limited to elements such as simulated user activity, response latency, and content update frequencies. These characteristics are designed to make the honeypot appear as a legitimate system, complete with realistic usage patterns and inconsistencies that might be found in actual production environments. AI orchestrator 2630 may fine-tunes these behaviors based on observed attack patterns and the specific role each honeypot plays within the broader defense strategy.

Adaptive behaviors 3040 represents the dynamic, AI-driven aspects of the honeypot profiles. This element allows honeypots to modify their behavior in real-time based on interactions with potential attackers. For example, a honeypot might adjust its apparent vulnerability level or simulate different security measures in response to probing attempts. These adaptive behaviors enable the honeypots to engage more effectively with sophisticated attackers, potentially revealing more about their techniques and intentions.

AI orchestrator 2630 continuously analyzes data from the distributed network 2600, including information gathered by the honeypots themselves, to refine and update the profiles. This might involve adjusting the mix of simulated vulnerabilities to align with current threat trends, modifying behavioral characteristics to better deceive attackers, or fine-tuning monitoring parameters to capture more relevant data.

Distributed network 2600 serves as the implementation ground for these honeypot profiles. As the profiles are updated by AI orchestrator 2630, the changes are propagated across the network, ensuring that all honeypots reflect the most current and effective configurations. This distributed approach allows for a diverse and widespread deployment of honeypots, each tailored to specific network segments or potential attack vectors.

By leveraging these sophisticated honeypot profiles, the AI-controlled sensor network can create a highly convincing and adaptive deception layer within the broader cybersecurity infrastructure. This approach not only enhances the system's ability to detect and study potential threats but also serves as an active defense mechanism, engaging and misdirecting attackers while providing valuable intelligence to security teams. The continuous refinement of these profiles by AI orchestrator 2630 ensures that the honeypot network remains effective against evolving cyber threats, providing organizations with a dynamic and proactive security posture.

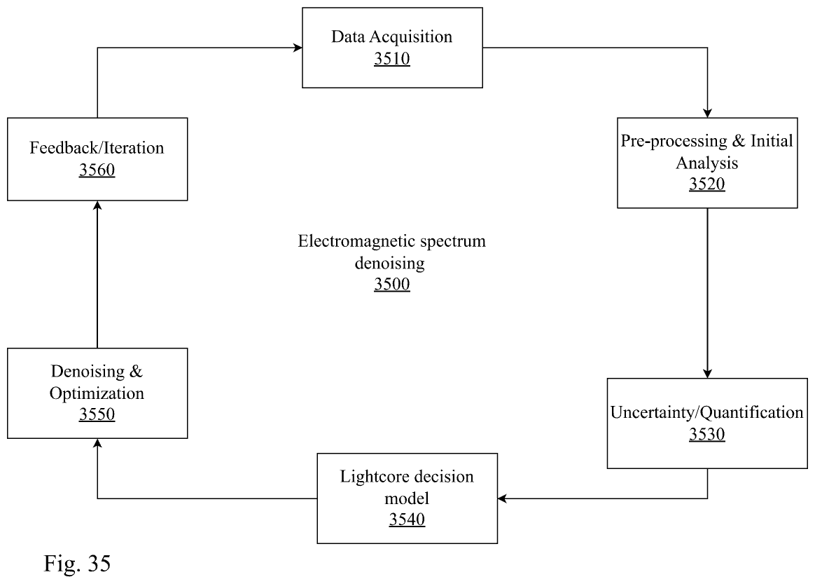

FIG. 35 illustrates a Continuous Process Loop for Denoising Electromagnetic Spectrum Data with Light-Cone Decision Uncertainty. This implements a sophisticated approach to electromagnetic signal processing and noise reduction 3500. This begins with a data acquisition stage 3510 which contains a distributed array of sensors operating across the electromagnetic spectrum from 1 Hz to 1000 GHz, collecting both raw signal data and comprehensive metadata including precise geolocation coordinates, timestamps, and environmental conditions. These sensors include RF spectrum monitors, quantum sensors, and EMF detectors, providing multi-domain coverage for thorough signal analysis. The collected data first enters a pre-processing and initial analysis stage 3520 where it undergoes initial normalization to account for sensor-specific noise characteristics. During this phase, the system applies Short-Time Fourier Transform (STFT) to decompose signals into their frequency components, allowing for standardization across heterogeneous sensor sources. This standardization is crucial for ensuring consistent analysis across different sensor types and environmental conditions.

Following the initial processing, the data enters the uncertainty quantification stage 3530, where the system employs advanced modeling techniques including mutual information metrics and entropy-based calculations. This stage specifically evaluates data quality and reliability by considering spatiotemporal pattern uncertainty, geospatial relationships between sensors, time window validity, sensor fidelity metrics, and parameter confidence levels. The uncertainty quantification 3530 provides crucial context for subsequent processing decisions. The light-cone decision modeling stage 3540 implements causality-respecting decision trees based on relativistic principles. This innovative approach ensures that decision-making respects physical causality constraints while modeling multiple future outcome scenarios. The system calculates information gain potential for each decision path, evaluates sensor reconfiguration options, and assesses the impact of different analysis granularities and response latencies.

The core denoising and parameter optimization stage 3550 employs a two-phase approach. Initial noise suppression is achieved through Truncated Singular Value Decomposition (TSVD), followed by refinement using Denoising Diffusion Probabilistic Models and Spatiotemporal Graph Neural Networks. Parameter optimization utilizes Upper Confidence Tree (UCT) algorithms to minimize decision regret while continuously adjusting sensor configurations and filtering parameters in real-time. The system completes its look through a comprehensive feedback and iteration stage 3560 which incorporates redundancy checks across multiple sensors, recalibration based on uncertainty metrics, and dynamic sensor reconfiguration. This stage propagates learned improvements back to the data acquisition phase 3510, enabling continuous refinement of sensor configurations, sampling parameters, and filtering thresholds. The feedback loop ensures that the system maintains optimal performance while adapting to changing conditions and requirements.

Critical to the system's effectiveness is its ability to maintain equilibrium between competing priorities: processing speed versus accuracy, resource utilization versus coverage, noise reduction versus signal preservation, and adaptation speed versus stability. The integration of relativistic causality principles through light-cone decision modeling, combined with multi-domain uncertainty quantification 3530 and adaptive parameter optimization, enables the system to provide reliable signal analysis and threat detection while maintaining awareness of physical and practical constraints.

This implementation offers a significant advancement in electromagnetic spectrum denoising 3500, offering robust performance across diverse operating conditions while maintaining rigorous uncertainty quantification and causality awareness. The system's continuous feedback loop ensures ongoing optimization and adaptation, making it particularly suitable for applications requiring high reliability and adaptability in signal processing and analysis.

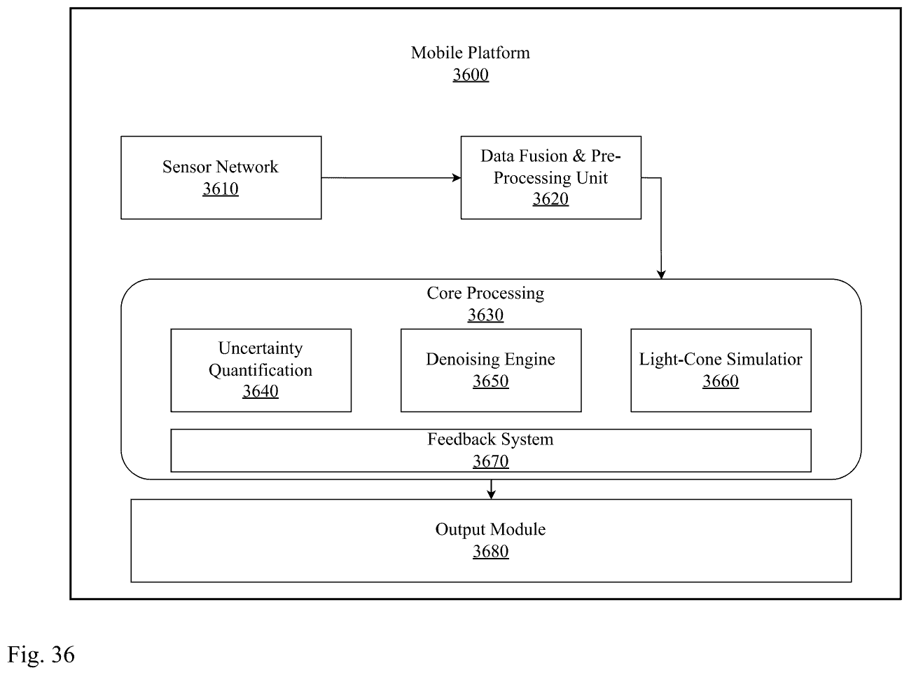

FIG. 36 is a mobile system architecture for electromagnetic spectrum denoising. This system is a sophisticated, modular approach to signal processing and noise reduction in a mobile platform 3600. The architecture is specifically designed to integrate advanced denoising capabilities with real-time uncertainty quantification and adaptive optimization, all while maintaining mobility and efficient resource utilization.

At the highest level, the system begins with a distributed Sensor Network 3610 comprising multi-modal electromagnetic sensors operating across frequencies from 1 Hz to 1000 GHz. These sensors are strategically positioned across varying geographic regions to provide comprehensive coverage. Each sensor node is capable of capturing not only raw electromagnetic data but also critical metadata including precise geolocation coordinates, temporal markers, and environmental conditions that might affect signal quality. The Data Fusion and Pre-Processing Unit 3620 serves as the primary aggregation point for all sensor inputs. This unit implements sophisticated data normalization protocols and performs initial spectral transformations using Short-Time Fourier Transform (STFT) techniques. It has the intelligence to dynamically request new sensor deployments or configuration changes based on real-time analysis of data quality and coverage needs. The unit also handles the critical task of standardizing data formats across heterogeneous sensor types to ensure consistent downstream processing.

The Core Processing block 3630 contains several sophisticated subsystems working in concert. The Uncertainty Quantification module 3640 calculates critical metrics including entropy measures and mutual information between signal components. It specifically implements light-cone metrics for analyzing the causality and reliability of considered observations, providing a mathematical framework for understanding the confidence levels of various measurements and processing decisions. This module directly supports the system's dynamic decision-making capabilities under uncertain conditions. Within the same Core Processing block, the Denoising Engine 3650 implements a multi-layered approach to noise reduction. It begins with Truncated Singular Value Decomposition (TSVD) for initial noise suppression, followed by more sophisticated processing using Graph Neural Networks (GNNs) and diffusion models. The engine integrates directly with parameter optimization systems using Upper Confidence Tree (UCT) algorithms to continuously refine its denoising parameters based on observed results and system feedback. The Light-Cone Simulator 3660 models future scenarios for data quality and parameter fidelity while respecting relativistic causality constraints. This simulator quantifies potential regret for different configuration choices and selects optimal parameters using advanced decision theory techniques. It specifically considers the spatiotemporal relationships between different signal components and sensor nodes, ensuring that processing decisions respect physical causality. A comprehensive Feedback System 3670 spans the width of the core processing block, implementing an iterative optimization loop that continuously refines sensor fidelity and analysis strategies. This system monitors the performance of all components and implements dynamic recalibration protocols when necessary. It maintains detailed performance metrics and uses them to guide system-wide optimizations, including sensor deployment strategies and processing parameter adjustments.

The Output Module 3680 serves as the final stage of processing, providing cleaned electromagnetic data alongside comprehensive uncertainty metrics and system recommendations. This module implements sophisticated visualization techniques for representing both the processed signals and their associated uncertainty measures. It can generate actionable insights for system operators while maintaining a complete record of processing decisions and their confidence levels. The system maintains continuous operation while allowing for dynamic reconfiguration and optimization based on observed performance and changing environmental conditions. This mobile architecture represents a significant advancement in electromagnetic spectrum denoising, particularly in its integration of uncertainty quantification, light-cone modeling, and adaptive optimization in a mobile platform.

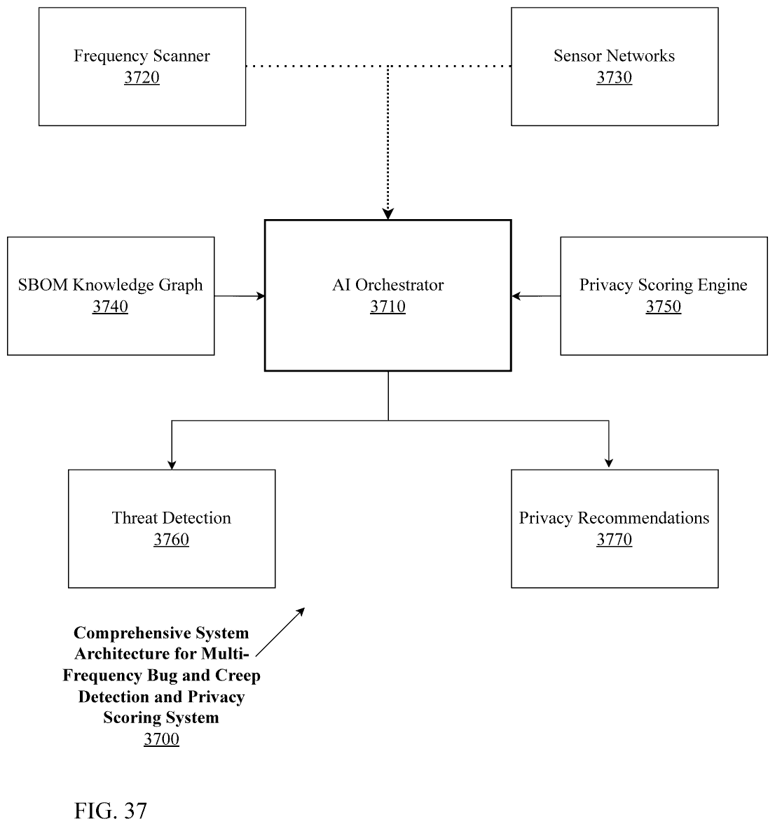

FIG. 37 illustrates an exemplary comprehensive system architecture for a multi-frequency bug and creep detection and privacy scoring system 3700 according to a preferred aspect of the invention. The system comprises an integrated approach for detecting surveillance devices (“bugs” and “creeps”) and analyzing privacy exposure levels across various environments. The system is particularly suited for identifying potentially unwanted surveillance devices including hidden cameras, audio bugs, GPS trackers, and other eavesdropping tools used for physical or electronic stalking. The AI Orchestrator May 3710 coordinate all data streams, performs real-time analysis, and manages system wide responses. The orchestrator may implement sophisticated machine learning algorithms to differentiate between benign environmental signals and potential surveillance threats while simultaneously calculating privacy exposure metrics. The AI Orchestrator 3710 may process thousands of samples per second and implements sliding context windows to detect both short-term and long-term temporal patterns in surveillance activities. The system's input layer may comprise two components to the AI Orchestrator 3710. A multi-frequency scanner 3720 provides comprehensive detection capabilities scanning multiple frequency bands from 1 MHz to 10 GHz or higher. This scanner integrates broadband RF detection to identify older analog bugs working on low-frequency channels, modern digital transmissions at higher frequencies (3G/4G/5G cellular, Wi-Fi, Bluetooth), and specialized frequencies such as millimeter-wave or novel IoT protocols. The scanner further implements infrared scanning for hidden lens detection and magnetic sensing for clandestine GPS devices. The scanner can operate in both passive detection modes to avoid generating suspicious signals and active modes when deeper probing is required. A complementary sensor network 3730 manages distributed honeypots and mobile sensors that create a comprehensive detection fabric. This network includes both fixed and mobile sensors that can be strategically deployed across various network segments and geographical locations. The mobile deployment capabilities include handheld bug detectors and portable scanning nodes that relay suspicious signals back to the AI Orchestrator 3710 for cross-checking against known infiltration patterns or malicious frequency usage.

The processing layer implements two specialized subsystems. An SBOM knowledge graph 3740 maintains a comprehensive database of device signatures, vulnerabilities, and behavioral patterns. When a potential surveillance device is identified, the system references this graph to determine if the suspicious transmissions match known software components. For example, a micro-camera might incorporate an off-the-shelf Wi-Fi or Bluetooth stack with a known fingerprint in the SBOM data. The knowledge graph continuously evolves as new threats are discovered, with each detection event feeding back to update device signatures, RF patterns, and lens reflection characteristics system-wide. A privacy scoring engine 3750 handles real-time evaluation of privacy exposure levels by analyzing overlapping sensor coverage zones and calculating contextual privacy metrics. For each vantage points along a user's path, the system estimates detection capability from various sensors, considering factors such as camera resolution, signal strength, and potential for triangulation. The scoring engine 3750 aggregates data to produce a numerical privacy score ranging from 0 (highly exposed) to 100 (nearly private), enabling real-time assessment of surveillance risk.

The outputs deliver actionable intelligence through two distinct channels. A threat detection 3760 generates detailed alerts and classification results upon surveillance device detection. This can identify specific threat types, such as “Likely Hidden Camera-check 2.4 GHz band mismatch” or “Possible GSM bug-Intermittent ARFCN pattern detected,” referencing known patterns from the SBOM data. When an anomaly is verified as suspicious, the system issues a “creep alarm” and can deploy a local virtual node or ephemeral sensor to gather additional intelligence. The Privacy recommendations 3770 produces context-aware guidance including suggested routes to avoid high-density camera zones, device setting modifications such as disabling active Wi-Fi or Bluetooth scanning, and physical protective measures like wearing privacy accessories or modifying movement patterns. For robotic systems, the recommendations may include adjusting broadcast patterns, modifying IR reflectivity, or employing radio silence protocols when legally permissible.

The system implements a sophisticated workflow for surveillance detection and privacy preservation. In operation, local or mobile scanning devices perform regular multi-frequency sweeps across an environment. When an unknown signal or device signature is detected, the orchestrator checks the knowledge graph, local environment profiles, and SBOM database for matches against known benign devices or suspicious patterns. If a signal is flagged as suspicious, the system can task local sensors to focus on that signal's origin while simultaneously deploying ephemeral honeypots to detect potential data exfiltration attempts. When a surveillance device is confirmed, the system initiates automated forensics and patch generation processes. If the system obtains any code or partial firmware from a discovered device, it scans for vulnerabilities or library matches. In corporate environments, this can trigger automated patch deployment if the discovered device uses software components present in the organization's infrastructure. The system maintains detailed logs of all detected threats and automated responses for subsequent forensic analysis. The architecture is particularly advantageous for dynamic environments with pervasive surveillance threats. For example, in urban settings, the system can help pedestrians or autonomous robots navigate while maintaining optimal privacy despite numerous CCTV cameras, mobile devices, and wireless beacons. The system's spatio-temporal knowledge graph enables real-time adaptation to changing threat landscapes, such as temporarily increased surveillance during public events or newly deployed tracking systems. This unified architecture represents a significant advancement over conventional bug detection and privacy protection systems. By integrating multi-frequency surveillance detection with real-time privacy scoring and AI-driven threat analysis, the system provides comprehensive protection against both traditional and emerging surveillance technologies. The continuous learning capabilities and adaptive response mechanisms ensure the system maintains effectiveness as new surveillance threats emerge.

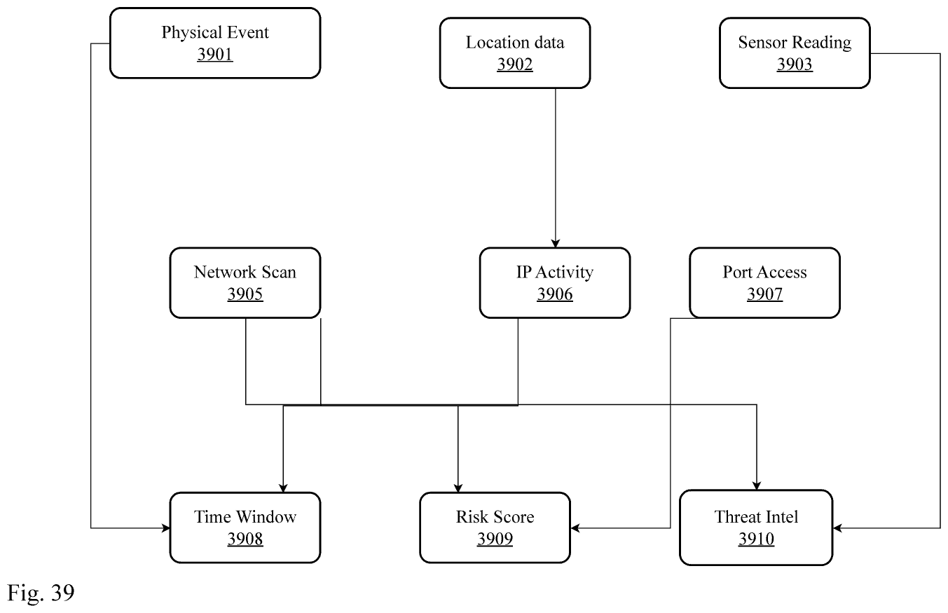

FIG. 39 is a block diagram illustrating the event knowledge graph (EKG) architecture according to a preferred embodiment. Unlike current IP-based logging systems that simply tag addresses as either “noise” or “malicious.” The EKG architecture implements a sophisticated multi-layer approach that correlates both physical and digital security events. The architecture comprises three primary layers, a physical layer, a network layer, and an analysis layer, each containing nodes representing different types of events and data points within the system. The physical layer includes nodes representing physical events 3901, location data 3902, and sensor reading 3903 which capture real-world security contexts—capabilities entirely absent from current systems IP-focused approaches. The network layer contains nodes representing network scans 3905, IP activity 3906, and Port access 3907 attempts. The analysis layer comprises nodes for threat intelligence 3910, time window analysis 3908, and risk scores 3909. The relationships between nodes significantly advances beyond current systems simple IP classification by enabling dynamic, context-aware security analysis. Physical events 3901 correlate with network scans 3905, establishing relationships between real-world activities and cyber events—a capability that is not present in traditional IP-based systems. Location data 3902 is associated with specific IP activities, enabling spatial context for network events. Sensor readings trigger updates to threat intelligence, providing real time input for security analysis. Network scans are analyzed against threat intelligence data, while IP activity is evaluated within the specific time windows. Port access attempts influence the overall risk score of the system. Physical events are timestamped and incorporated into the time window analysis, while network scans directly impact the risk scoring. This graph-based architecture enables the system to maintain a comprehensive view of both physical and cyber security events, their temporal relationships, and their collective impact on security risk assessment. Where current approaches are limited to identifying patterns in internet-scale scanning, this subsystem's directed edges between nodes allow for tracing the propagation of threats and anomalies across both physical and digital domains. The architecture supports sophisticated threat detection capabilities including: temporal sequence analysis of device exposures (e.g., tracking when devices encounter suspicious networks or come within range of unauthorized sensors), cross-domain correlation (linking physical security events with network anomalies), and dynamic privacy scoring that adapts to changing environmental conditions. The system can automatically group suspicious events by campaign identifiers using shared infrastructure patterns and repeated lateral movement tactics, techniques, and procedures (TTPs)—a level of threat actor attribution and campaign correlation not possible with simple IP-based classification.

Through this advanced EKG architecture, the system can detect and correlate sophisticated attack patterns that would be invisible to traditional IP-based scanning systems. For example, when a physical security event (such as unauthorized building access) occurs simultaneously with anomalous network activity from a new IP address, the system can automatically escalate the threat level and adjust security responses accordingly. Similarly, if network scanning activity is detected from an IP that was previously classified as benign but coincides with suspicious physical events or matches patterns associated with known threat campaigns, the system can dynamically re-evaluate the threat level and initiate appropriate defensive measures. This holistic approach to threat detection and analysis represents a significant advancement over existing technologies that rely solely on network-level indicators.

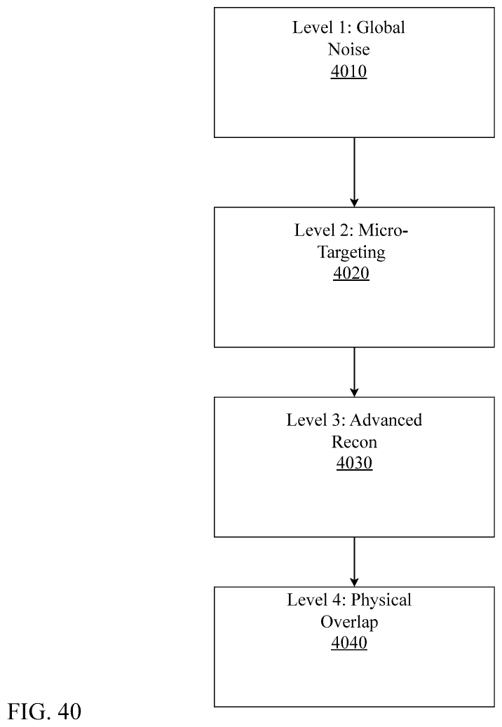

FIG. 40 is a block diagram illustrating the multi-tier threat categorization system according to a preferred embodiment, representing a significant advancement over traditional binary classification systems. Where traditional approaches implement a simple benign and malicious dichotomy, this system employs a sophisticated four-tier classification hierarchy with dynamic escalation capabilities and cross-domain correlation. Global Noise 4010 serves as the baseline classification tier, implementing advanced pattern recognition to identify and categorize Internet-wide scanning activities. At this level, the system employs multiple analysis vectors including temporal pattern analysis of scanning frequencies and intervals, statistical baseline deviation monitoring, known scanner fingerprint matching against OSINT databases, protocol-specific behavior analysis, and geographic origin correlation. The system maintains dynamic baselines for each of these vectors, allowing for adaptive threshold adjustment based on global Internet scanning trends and emerging threat patterns. Micro-targeting 4020 represents the first escalation tier, triggered by any of several sophisticated detection mechanisms: subnet-specific probe concentration analysis, port sequence pattern matching against known exploit techniques, behavioral analysis of scanner sophistication (e.g., protocol manipulation, evasion attempts), cross-network correlation of targeting patterns, and temporal clustering of probe attempts. This level implements machine learning algorithms to differentiate between legitimate security research and potential reconnaissance activities, incorporating features such as scan timing, protocol usage, and probe sophistication. Advanced recon 4030 activates upon detection of sophisticated attack patterns through correlation with known adversary campaign TTPs, vulnerability probe sequence matching, infrastructure pattern analysis (e.g., C2 server characteristics), multi-stage attack chain detection, and cross-tenant attack pattern correlation. The system employs advanced threat intelligence integration at this level, including MITRE ATT&CK framework mapping, threat actor infrastructure fingerprinting, zero-day exploit pattern detection, and campaign attribution analysis. Physical overlap 4040 is the highest threat tier, uniquely incorporating cyber-physical security correlation through integration with physical access control systems, environmental sensor data analysis, RF spectrum monitoring for unauthorized devices, Bluetooth/WiFi presence detection, and GPS tracker detection. This level implements sophisticated correlation engines that can match digital attack patterns with physical security events, track spatial-temporal relationships between cyber and physical anomalies, identify potential insider threats through behavioral analysis, and monitor for physical security bypasses that could enable cyber attacks.

The system implements dynamic escalation between levels through a sophisticated scoring mechanism that considers cumulative threat indicators across multiple domains, historical pattern analysis of attack progression, real-time risk scoring based on asset vulnerability, environmental context and physical security state, and cross-organization threat intelligence. Each level incorporates graduated response protocols that become increasingly aggressive, ranging from passive monitoring with automated baseline adjustment at Level 1, to active probe response with defensive deception capabilities at Level 2, automated containment measures with cross-network correlation at Level 3, and emergency response protocols with physical security integration at Level 4. The system maintains continuous feedback loops that enable dynamic adjustment of classification thresholds, refinement of escalation triggers, update of threat detection patterns, integration of new threat intelligence, and adaptation to emerging attack techniques. This comprehensive approach to threat categorization and response represents a significant advancement over traditional binary classification systems, providing nuanced, context-aware security that spans both cyber and physical domains.

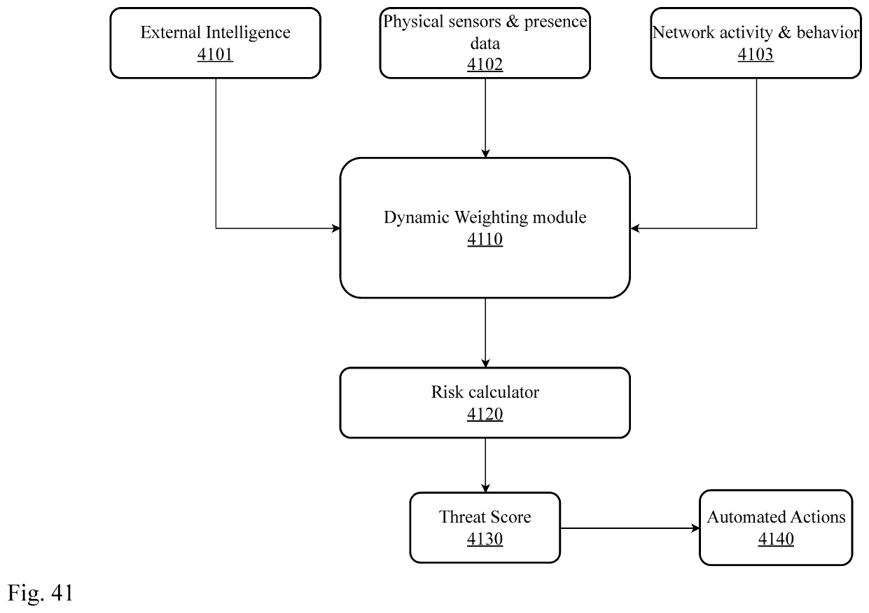

FIG. 41 is a block diagram illustrating the layered scoring mechanism architecture according to a preferred embodiment. Unlike traditional systems that implement simple binary classification of IP addresses as either benign or malicious, this system employs a sophisticated, multi-layered scoring approach that dynamically weighs multiple input sources to generate comprehensive threat assessments and automated responses. Where current systems focus solely on Internet-scale scanning patterns, this architecture incorporates physical security data, behavioral analysis, and advanced threat intelligence to provide contextualized risk scoring. The architecture comprises three primary input categories, each representing a significant advancement over traditional IP-based scoring systems. The first category, external intelligence 4101, goes beyond simple IP reputation scoring by incorporating TTPs (Tactics, Techniques, and Procedures) and IOCs (Indicators of Compromise) from multiple threat intelligence sources, including MITRE ATT&CK frameworks, commercial threat feeds, and cross-organization sharing networks. This enables the system to identify sophisticated attack patterns that would be invisible to systems focused solely on scanning behavior. The second category, physical sensors and presence data 4102, represents an entirely new dimension absent from traditional systems, incorporating data from RFID sensors, building access controls, wireless device detection systems, and environmental monitors to provide real-world security context. The third category, network activity and behavior 4103, advances beyond simple port scan detection to include protocol analysis, traffic pattern recognition, and behavioral anomaly detection.

The dynamic weighting module 4110 stands in stark contrast to current systems static classification approach by implementing real-time weight adjustment based on evolving threat landscapes. For example, if a scanning IP belongs to a legitimate security research organization but suddenly exhibits behavior matching known malicious TTPs, the system will dynamically increase weights assigned to behavioral indicators and decrease weights assigned to reputation scores. This module employs sophisticated machine learning algorithms including gradient boosting for weight optimization and recurrent neural networks for temporal pattern analysis. The weighting system may also adapt to different operational contexts—for instance, increasing the importance of physical security indicators during non-business hours or in restricted areas.

The risk calculator 4120 processes these weighted inputs using a proprietary algorithm that combines Bayesian inference for uncertainty handling, temporal sequence analysis for pattern recognition, and graph-based correlation for relationship mapping. Unlike current systems focus on individual IP classification, this system maintains historical context through a sliding window approach, allowing it to detect subtle changes in behavior over time. The calculator generates a normalized threat score ranging from 0-100, with sub-scores for different threat categories including reconnaissance, exploitation attempts, and physical security risks.

The system implements automated response actions 4140 based on score thresholds, ranging from increased monitoring to active defense measures. These actions are contextually aware—for instance, a high threat score triggered by both network scanning and unauthorized physical presence will initiate different responses than one triggered by scanning alone. The system supports graduated response protocols including automated network segmentation, deception technology deployment, enhanced logging activation, physical security alerts, and incident response team notification. Each response is calibrated based on the specific threat indicators that contributed to the score, ensuring proportional and effective defensive measures. A continuous feedback loop enables the system to refine its scoring accuracy over time. This includes parameter tuning through supervised learning, correlation strength adjustment through statistical analysis, and automated threshold calibration based on false positive or negative rates. The feedback mechanism allows the system to adapt to new attack techniques while maintaining high precision in threat classification. This self-improving capability represents a fundamental advancement over static classification systems, enabling the detection of sophisticated attacks that evolve over time or combine multiple attack vectors.

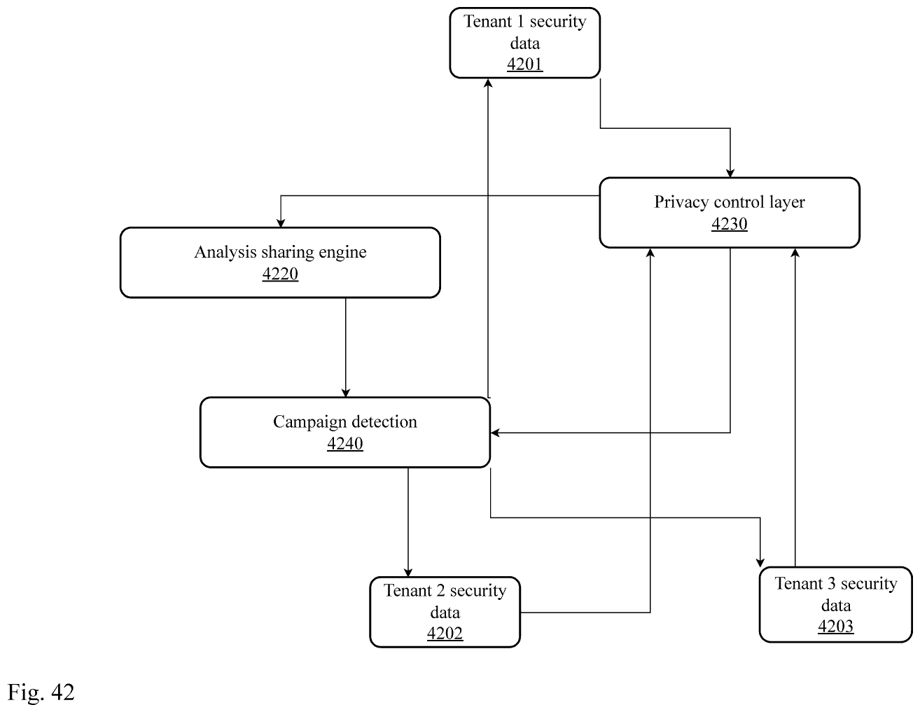

FIG. 42 is a block diagram illustrating the collaborative tenant-level threat sharing system according to a preferred embodiment of the invention. Where traditional approaches rely primarily on public internet scanning data and offer limited information sharing through simple IP classifications, this system implements a sophisticated multi-tenant architecture that enables deep cross-organizational threat detection while maintaining stringent privacy controls. Unlike traditional system's focus on internet-wide scanning patterns, this system can detect and correlate sophisticated attack campaigns that span multiple organizations, network segments, and attack vectors. Individual tenant security data 4201, 4202, 4203 is first processed through the Privacy Control Layer 4230, representing a significant advancement over current system's public scanning approach. Where current system's primarily process publicly visible scan data, this system implements sophisticated privacy-preserving mechanisms that enable sharing of sensitive security telemetry without exposing organizational details. The privacy control layer 4230 may employ multiple advanced techniques including homomorphic encryption for preserving data confidentiality while enabling analysis, differential privacy mechanisms that protect individual tenant data while allowing meaningful aggregate statistics, k-anonymity protocols for masking specific network attributes, and zero-knowledge proofs for validating threat indicators without revealing source information. Each tenant 4201, 4202, 4203 maintains granular control over their data sharing policies, with configurable rules for different types of security information and threat indicators.

The analysis and sharing engine 4220 represents a fundamental advancement over current systems binary IP classification approach. While current systems focus on categorizing individual IP addresses as benign or malicious, this engine implements sophisticated correlation algorithms that can identify complex attack patterns across multiple organizations. The engine may employ advanced machine learning techniques including temporal pattern matching for identifying coordinated attacks, graph-based analysis for mapping attack infrastructure relationships, behavioral clustering for identifying similar TTPs across different targets, and anomaly detection for identifying novel attack patterns. This multi-dimensional analysis enables the detection of sophisticated campaigns that would be invisible to systems focused solely on IP-based scanning patterns.

The campaign detection module 4240 extends far beyond current systems. This module maintains a sophisticated temporal attack graph that maps relationships between events across different tenants, time periods, and attack vectors. The system can correlate seemingly unrelated events such as low-level reconnaissance against multiple organizations, testing of exploit variants across different targets, lateral movement attempts between organizations, and coordination between cyber and physical attack vectors. Unlike present system's focus on individual scanning sources, this system can identify and track sophisticated threat actors through pattern analysis of their TTPs, infrastructure usage, and targeting preferences.

The system implements tenant-specific alert generation that provides contextual, actionable intelligence while maintaining strict privacy boundaries. Where current systems offer the same public feed to all users, this system generates customized alerts for each organization based on their specific threat landscape, infrastructure, and security priorities. The alert generation system employs multiple privacy-preserving techniques including data minimization to share only relevant indicators, anonymization of source attribution, and cryptographic protocols for secure indicator sharing. This enables organizations to benefit from collective threat intelligence while maintaining complete control over their sensitive information.

The system's collaborative architecture enables multiple advanced sharing modes not possible with traditional systems: real-time attack pattern distribution, zero-day exploit detection through cross-organization correlation, coordinated response to emerging threats, and early warning of sophisticated campaign activities. Each sharing mode implements its own privacy preservation rules and data handling requirements, ensuring appropriate protection while maximizing defensive value. The system can detect and respond to threats that would be invisible to individual organizations or traditional IP-based classification systems, including: advanced persistent threats (APTs) using distributed infrastructure, supply chain attacks targeting multiple organizations, and sophisticated social engineering campaigns coordinated across multiple victims. The key is the system's ability to maintain effective threat detection and correlation capabilities without compromising tenant data privacy. Unlike current systems, this system enables sharing of sensitive security telemetry through privacy-preserving computation techniques. Organizations can participate in collective defense while maintaining strict control over their security information, enabling a level of threat detection and response that surpasses what is possible with public scanning data alone.

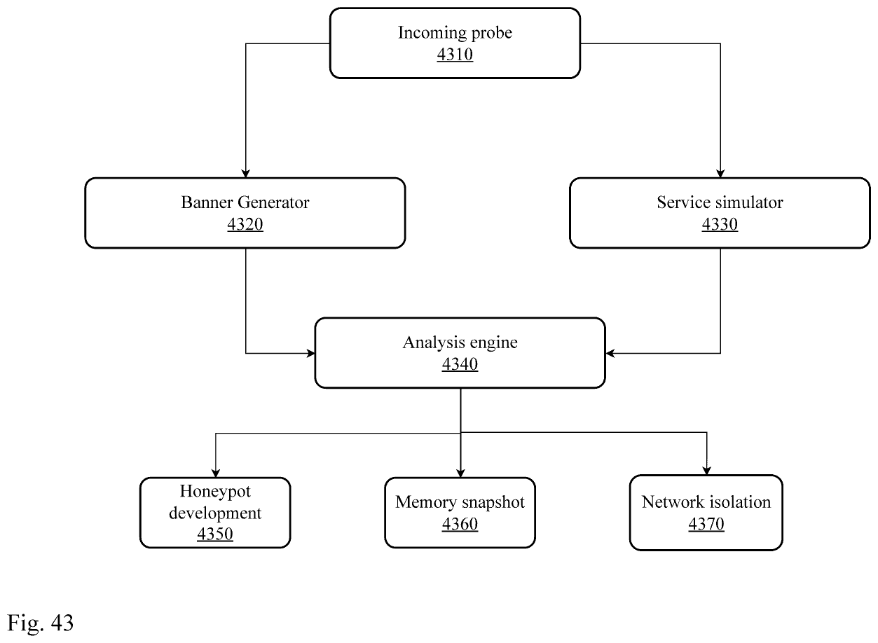

FIG. 43 is a block diagram illustrating the adaptive response system architecture according to a preferred embodiment. Unlike current systems passive approach of simply categorizing scanning traffic, this system implements an active defense architecture that dynamically responds to potential threats while gathering intelligence about attacker motives and capabilities. The system represents a significant advancement over traditional approaches by employing sophisticated service simulation and intelligent response mechanisms. When an incoming probe 4310 is detected, it triggers two parallel response mechanisms. The Banner Generator 4320, unlike simple honeypots that return static responses, implements a sophisticated “Rorschach” response system that dynamically generates service banners based on attacker behavior. For example, if a probe appears to be targeting Apache vulnerabilities, the system might respond with carefully crafted Apache version strings to observe the attacker's subsequent actions. This banner randomization goes far beyond current systems passive monitoring by actively engaging with attackers to reveal their intentions and capabilities. The service simulator 4330 works in concert with the banner generator 4320 to present convincing service responses. Where traditional systems might simply return a banner, this simulator can emulate complex service behaviors including protocol handshakes, error responses, and state transitions. The simulator maintains detailed interaction logs and can adapt its behavior based on attacker responses, creating a dynamic environment that appears authentic to automated scanning tools and manual reconnaissance attempts. The simulator employs advanced protocol fuzzing techniques to identify attacker tools and methodologies, capabilities entirely absent from current passive monitoring systems.

The analysis engine 4340 processes data from both the banner generator 4320 and service simulator 4330 to make real-time decisions about response strategies. This engine employs sophisticated machine learning algorithms to identify attack tool signatures, correlate probe patterns with known threat actor TTPs, detect potential zero-day exploitation attempts, and predict attacker objectives based on interaction patterns. Unlike current systems focus on IP reputation, this engine builds comprehensive attacker profiles that include preferred targets, exploitation techniques, and behavioral patterns.

Based on the analysis engine's 4340 findings, the system can trigger multiple automated response actions. These include deploying specialized honeypots 4350 tailored to the detected threat, capturing memory snapshots 4360 for forensic analysis, and implementing network isolation 4370 procedures. Each response is calibrated to maximize intelligence gathering while containing potential threats. The system can dynamically adjust its response strategy based on attacker behavior, deploying increasingly sophisticated deception techniques as needed. This adaptive response capability enables the system to engage with attackers at varying levels of sophistication, from simple banner checks to complex protocol interactions, gathering valuable intelligence at each stage.

The response system maintains a continuous feedback loop that enables it to improve its effectiveness over time. It tracks which banner types and service simulations are most effective at engaging different types of attackers, allowing it to optimize its responses for maximum intelligence gathering. This self-improving capability represents a fundamental advancement over static classification systems, enabling more effective threat detection and response over time. The feedback mechanism incorporates multiple data sources including successful attacker engagement metrics, exploit capture rates, and intelligence gathering effectiveness to continuously refine its response strategies.

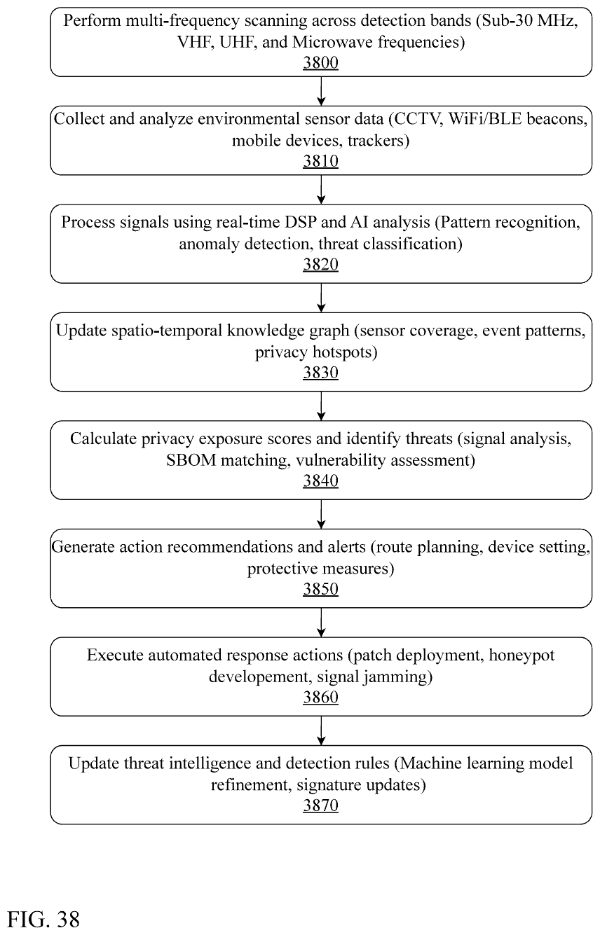

FIG. 38 is a flow diagram illustrating an exemplary method for integrated multi-frequency bug and creep detection and privacy scoring according to a preferred aspect of the invention. The method comprises a continuous cycle of detection, analysis, and response steps that work together to provide comprehensive surveillance detection and privacy protection.

In step 3800, the system performs multi-frequency scanning across multiple detection bands. This scanning encompasses Sub-30 MHz frequencies for detecting analog bugs and ultrasonic devices, VHF (30-300 MHz) for identifying low-cost radio-based bugs, UHF (300 MHz-3 GHz) for monitoring modern wireless threats including WiFi and cellular communications, and Microwave (3-30 GHz) frequencies for detecting advanced or military-grade surveillance equipment. The scanning operation employs both passive and active detection modes to maintain stealth while maximizing detection capabilities.

In step 3810, the system collects and analyzes environmental sensor data from multiple sources to build a comprehensive view of the surveillance landscape. This includes monitoring CCTV camera systems, WiFi and Bluetooth Low Energy beacons, mobile devices, asset tracking systems, and wearable devices. The system maintains awareness of both fixed and mobile surveillance capabilities in the environment.

In step 3820, the collected signals undergo sophisticated processing using real-time Digital Signal Processing (DSP) and AI analysis techniques. This processing includes pattern recognition to identify known surveillance device signatures, anomaly detection to flag unusual transmission patterns, and threat classification to categorize detected devices. The system achieves processing speeds capable of detecting microsecond-duration transmissions characteristic of sophisticated surveillance equipment.

In step 3830, the system updates its spatio-temporal knowledge graph based on the processed data. This graph maintains a dynamic model of sensor coverage zones, event patterns, and privacy hotspots throughout the monitored environment. The graph evolves in real-time as new sensors are discovered or existing sensors change their behavior or configuration.

In step 3840, the system calculates privacy exposure scores and identifies specific threats. This calculation considers multiple factors including signal analysis results, matches against known surveillance device profiles in the SBOM database, and vulnerability assessments of detected devices. The privacy scoring takes into account both immediate surveillance exposure and potential for future identification or tracking.

In step 3850, the system generates specific action recommendations and alerts based on the calculated privacy scores and identified threats. These recommendations may include route planning to avoid high-surveillance areas, device setting adjustments to reduce trackability, and physical protective measures appropriate to the current threat environment.

In step 3860, the system executes automated response actions when necessary. These may include deploying security patches if vulnerable software components are identified, establishing honeypots to gather additional intelligence about detected threats, or implementing signal jamming measures when legally permitted.

In step 3870, the system updates its threat intelligence database and detection rules based on newly gathered information. This includes refining machine learning models with new training data and updating signature databases with newly identified surveillance device characteristics.

The method implements a continuous feedback loop, indicated by the return path from step 3870 to step 3800, ensuring that the system continuously improves its detection and protection capabilities based on operational experience. This adaptive approach enables the system to maintain effectiveness against both known and emerging surveillance threats while providing increasingly sophisticated privacy protection recommendations.

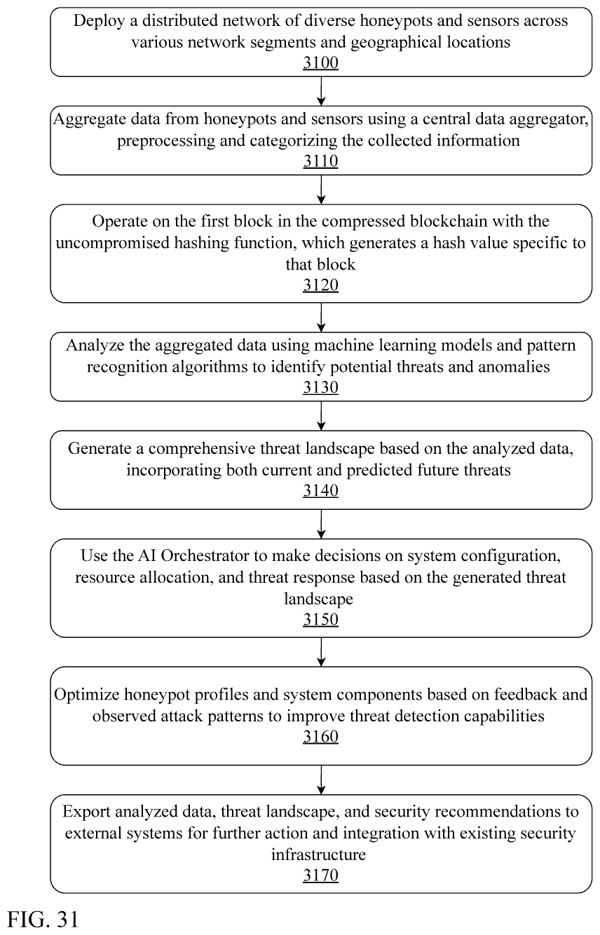

FIG. 31 is a flow diagram illustrating an exemplary method for an AI-controlled sensor network for threat mapping and characterization. In a first step 3100, the process begins with the deployment of a distributed network of diverse honeypots and sensors across various network segments and geographical locations. This strategic placement ensures a wide coverage of potential attack vectors and provides a holistic view of the threat landscape. The honeypots are designed to mimic various systems and services, such as web servers, databases, and IoT devices, while sensors are deployed to passively monitor network traffic and system behaviors. This distributed approach allows for the detection of threats that might not be visible from a single vantage point and enables the identification of coordinated attacks targeting multiple points of an organization's infrastructure.

In a step 3110, the system aggregates data from the deployed honeypots and sensors using a central data aggregator. This component is responsible for collecting, preprocessing, and categorizing the vast amounts of information gathered from across the distributed network. The data aggregator may handle heterogeneous data streams, managing irregular surges in data input and ensuring that all relevant information is efficiently captured and prepared for further analysis. This step aids in transforming raw data into a structured format that can be effectively analyzed by subsequent components of the system.

In a step 3120, the aggregated data is analyzed using advanced machine learning models and pattern recognition algorithms to identify potential threats and anomalies. This analysis involves processing vast amounts of network traffic data, system logs, and honeypot interactions to detect suspicious patterns, potential vulnerabilities, and indicators of compromise. The machine learning models are continuously updated and refined based on new data and observed outcomes, allowing the system to adapt to evolving threat landscapes and improve its detection capabilities over time.

In a step 3130, the system generates a comprehensive threat landscape based on the analyzed data, incorporating both current and predicted future threats. This threat landscape provides a holistic view of the organization's security posture, including identified vulnerabilities, active threats, and potential future risks. The predictive component of this step leverages advanced analytics and machine learning techniques to forecast emerging threats based on current trends and historical data, enabling proactive security measures.

In a step 3140, an AI orchestrator utilizes the generated threat landscape to make decisions on system configuration, resource allocation, and threat response. This step involves dynamically adjusting the deployment and configuration of honeypots and sensors, optimizing the allocation of computational resources, and initiating automated response measures to mitigate detected threats. The AI orchestrator's decision-making process takes into account the current threat landscape, system performance metrics, and predefined security policies to ensure an optimal balance between security effectiveness and operational efficiency.

In a step 3150, the system optimizes honeypot profiles and other system components based on feedback and observed attack patterns to improve threat detection capabilities. This continuous optimization process involves refining the simulated vulnerabilities, behavioral characteristics, and adaptive behaviors of the honeypots to ensure they remain convincing and effective in attracting and engaging potential attackers. Similarly, other system components, such as sensors and analysis algorithms, are fine-tuned to enhance their effectiveness in detecting and characterizing emerging threats.

In a step 3160, the system exports analyzed data, threat landscape information, and security recommendations to external systems for further action and integration with existing security infrastructure. This step ensures that the insights and intelligence gathered by the AI-controlled sensor network can be leveraged by other security tools and processes within the organization. The exported data may include but is not limited to detailed threat reports, risk assessments, and actionable recommendations for enhancing the organization's overall security posture. This integration enables a more comprehensive and coordinated approach to cybersecurity, allowing organizations to make informed decisions and implement effective defensive measures based on the advanced threat intelligence provided by the system.

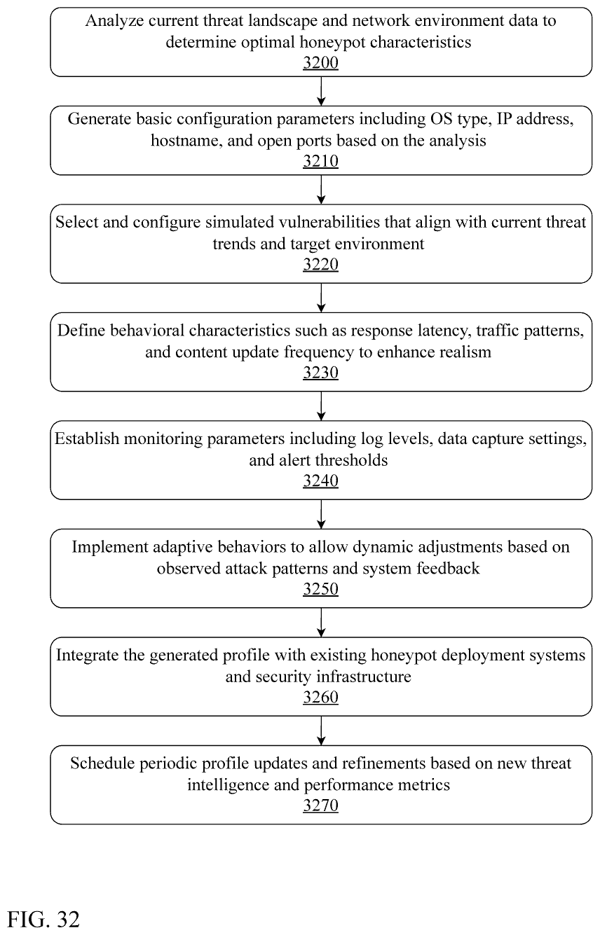

FIG. 32 is a flow diagram illustrating an exemplary method for generating artificial honeypot profiles using an AI-controlled sensor network for threat mapping and characterization. In a first step 3200, the process begins with a thorough analysis of the current threat landscape and network environment data to determine optimal honeypot characteristics. This step involves leveraging the system's threat intelligence capabilities, including data from the distributed sensor network, external threat feeds, and historical attack patterns. The AI orchestrator plays a role in this analysis, using machine learning models to identify trends and predict potential attack vectors. This comprehensive analysis ensures that the honeypot profiles are tailored to the most relevant and pressing threats facing the organization.

In a step 3210, the system generates basic configuration parameters for the honeypot profiles. These parameters include essential attributes such as operating system type, IP address, hostname, and open ports. The selection of these parameters is based on the analysis conducted in the previous step, ensuring that the honeypots present a convincing and attractive target to potential attackers. The AI orchestrator carefully balances the need for realism with the strategic placement of vulnerabilities, creating a diverse ecosystem of honeypots that can attract a wide range of potential threats.

In a step 3220, the method moves on to selecting and configuring simulated vulnerabilities that align with current threat trends and the target environment. This step aids in ensuring that the honeypots are effective in attracting and engaging sophisticated attackers. The system draws upon its extensive threat intelligence to identify relevant vulnerabilities, ranging from common misconfigurations to more complex, emerging exploit opportunities. The AI orchestrator fine-tunes these vulnerabilities to present a realistic and enticing target while maintaining a balance that allows for effective monitoring and analysis of attacker behavior.

In a step 3230, the system defines behavioral characteristics for the honeypots to enhance their realism. This includes setting parameters such as response latency, traffic patterns, and content update frequency. These characteristics are carefully crafted to mimic the behavior of legitimate systems, making it difficult for attackers to distinguish the honeypots from real targets. The AI orchestrator may employ advanced behavioral modeling techniques to ensure that these characteristics are consistent with the simulated system type and purported function within the network.

In a step 3240, the method establishes monitoring parameters for the honeypots. This includes setting appropriate log levels, configuring data capture settings, and defining alert thresholds. These parameters are crucial for balancing the need for detailed threat intelligence with system performance and data management considerations. The AI orchestrator optimizes these settings to ensure that the honeypots capture valuable data about attacker techniques and intentions without overwhelming the system with unnecessary information.

In a step 3250, the system implements adaptive behaviors for the honeypots. These behaviors allow for dynamic adjustments based on observed attack patterns and system feedback. This capability enables the honeypots to respond intelligently to probing attempts, potentially revealing more about the attacker's techniques and intentions. The AI orchestrator continuously refines these adaptive behaviors based on real-time data and machine learning insights, ensuring that the honeypots remain effective against evolving attack strategies.

In a step 3260, the generated honeypot profile is integrated with existing honeypot deployment systems and security infrastructure. This step ensures that the new or updated profile is seamlessly incorporated into the organization's broader cybersecurity ecosystem. The integration process includes updating firewall rules, adjusting network segmentation, and configuring any necessary data flow paths to ensure that the honeypot can effectively capture and relay threat intelligence without compromising the security of the production environment.

In a step 3270, the method concludes with scheduling periodic profile updates and refinements based on new threat intelligence and performance metrics. This ongoing optimization process ensures that the honeypot profiles remain effective and relevant in the face of evolving cyber threats. The AI orchestrator analyzes performance data, attack patterns, and new threat intelligence to determine when and how to update the profiles. This may involve adjusting simulated vulnerabilities, fine-tuning behavioral characteristics, or completely redesigning profiles to address emerging threat vectors. By maintaining this cycle of continuous improvement, the system ensures that its honeypot network remains a powerful tool for threat detection and analysis in the ever-changing landscape of cybersecurity.

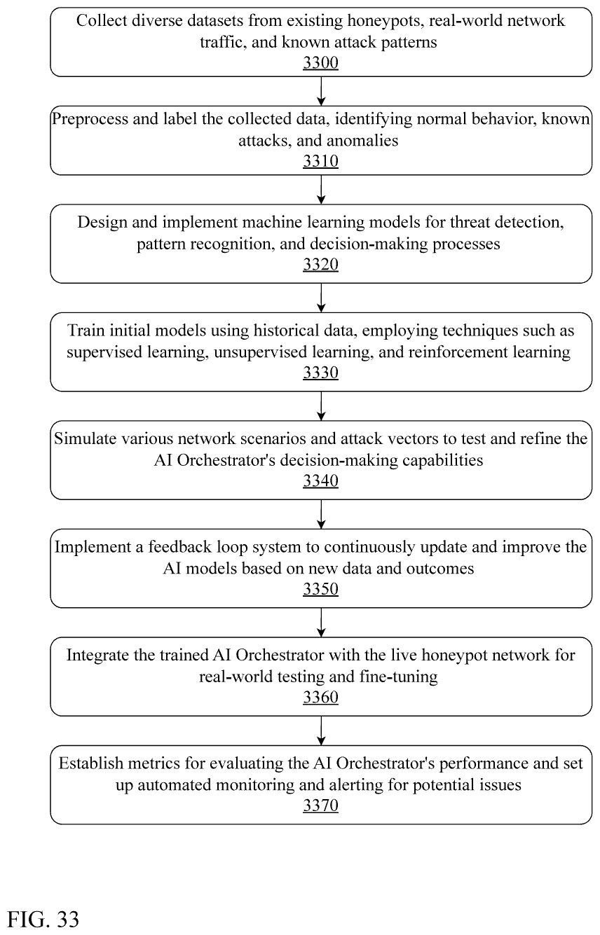

FIG. 33 is a flow diagram illustrating an exemplary method for training an AI orchestrator integrated into an AI-controlled sensor network for threat mapping and characterization. In a first step 3300, the process begins with the collection of diverse datasets from multiple sources. These datasets include information from existing honeypots, real-world network traffic, and known attack patterns. This comprehensive data collection approach ensures that the AI Orchestrator has access to a rich and varied set of information, covering both historical and current cybersecurity threats. The diversity of the data is crucial for training robust and versatile machine learning models that can effectively identify and respond to a wide range of potential threats.

In a step 3310, the collected data undergoes preprocessing and labeling. This critical step involves cleaning the data, normalizing formats, and identifying key features that will be used in the machine learning process. The data is categorized into normal behavior patterns, known attack signatures, and potential anomalies. This labeling process is essential for supervised learning techniques and helps in creating a baseline for detecting deviations that may indicate new or evolving threats. The AI orchestrator may employ advanced data processing algorithms to handle the large volumes of heterogeneous data efficiently.

In a step 3320, the system designs and implements machine learning models specifically tailored for threat detection, pattern recognition, and decision-making processes. This step involves selecting appropriate algorithms and architectures based on the nature of the cybersecurity challenges being addressed. The AI orchestrator may employ a combination of supervised learning for known threat detection, unsupervised learning for anomaly detection, and reinforcement learning for adaptive response strategies. The design process also considers factors such as model interpretability, computational efficiency, and scalability to ensure that the resulting models can operate effectively within the constraints of the real-world cybersecurity environment.

In a step 3330, the initial training of the machine learning models takes place using the preprocessed historical data. This training employs a variety of techniques, including supervised learning for labeled data, unsupervised learning for pattern discovery in unlabeled data, and reinforcement learning for developing adaptive response strategies. The AI orchestrator utilizes advanced training methodologies such as transfer learning and ensemble methods to enhance the models' performance and generalization capabilities. This initial training phase establishes the foundation for the AI orchestrator's threat detection and decision-making abilities.

In a step 3340, the system conducts extensive simulations of various network scenarios and attack vectors. These simulations serve to test and refine the AI orchestrator's decision-making capabilities in a controlled environment. By exposing the trained models to a wide range of potential threats and network conditions, the system can identify areas for improvement and fine-tune its responses. The simulation process includes both known attack patterns and novel scenarios designed to challenge the AI orchestrator's adaptability and robustness.

In a step 3350, a feedback loop system is implemented to enable continuous updating and improvement of the AI models. This system allows the AI orchestrator to learn from its successes and failures in real-time, incorporating new data and outcomes into its decision-making processes. The feedback loop ensures that the models remain current and effective against emerging threats, automatically adjusting their parameters and strategies based on observed results and changing threat landscapes.

In a step 3360, the trained AI orchestrator is integrated with the live honeypot network for real-world testing and fine-tuning. This integration allows the AI orchestrator to operate in a production environment, managing actual honeypots and responding to real threats. During this phase, the system's performance is closely monitored, and any discrepancies between simulated and real-world performance are addressed. This real-world exposure is crucial for validating the AI orchestrator's effectiveness and identifying any unforeseen challenges or opportunities for improvement.

In a step 3370, the method establishes comprehensive metrics for evaluating the AI orchestrator's performance and sets up automated monitoring and alerting systems for potential issues. These metrics may include factors such as threat detection accuracy, false positive rates, response time, and system resource utilization. The automated monitoring ensures that any degradation in performance or unexpected behaviors are quickly identified and addressed. This ongoing evaluation process supports the continuous improvement of the AI orchestrator, allowing for timely interventions and updates to maintain optimal performance in the face of evolving cybersecurity challenges.

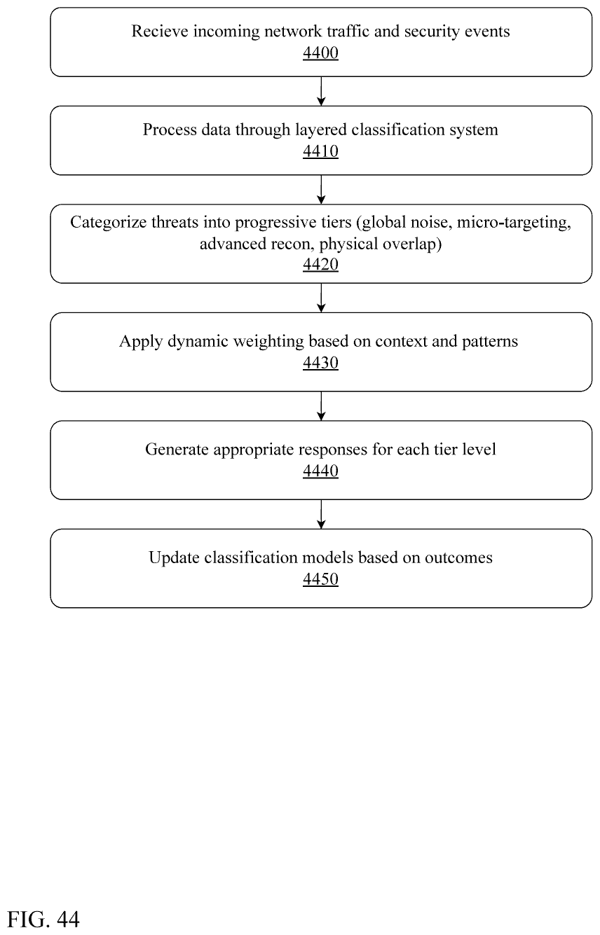

FIG. 44 is a flow diagram illustrating an exemplary method for multi-tier threat categorization according to a preferred embodiment. Unlike traditional binary classification systems that simply categorize traffic as either benign or malicious based on scanning patterns, this method implements a sophisticated multi-stage classification process that considers both cyber and physical security contexts while enabling dynamic threat escalation. The process begins at step 4400 with receiving incoming network traffic and security events from multiple sources. Where current systems focus solely on internet-scale scanning data, this system ingests a diverse range of inputs including network traffic patterns, physical security sensor data, wireless signals, and environmental monitoring inputs. For example, the system might simultaneously process traditional port scan attempts, Bluetooth device broadcasts near secure facilities, badge reader access patterns, and network authentication attempts. This multi-source data collection enables the system to build a comprehensive view of potential threats across both cyber and physical domains.

In step 4410, the system processes this heterogeneous data through a sophisticated layered classification system that goes far beyond simple IP-based categorization. The classification engine employs multiple machine learning models including temporal pattern analysis for detecting timing-based attack signatures, spatial correlation for identifying physical security anomalies, and behavioral analysis for profiling attack methodologies. For instance, if an IP address associated with a legitimate security research organization suddenly begins conducting port scans using patterns matching known threat actor TTPs, the system can detect this behavioral shift and adjust its classification accordingly. The system also incorporates contextual data such as time of day, physical location information, and organizational security policies to provide richer classification context.

At step 4420, the system categorizes threats into progressive tiers that enable more nuanced response strategies than traditional system's binary approach. The base tier, Global Noise, handles Internet-wide scanning activity similar to traditional systems but with enhanced pattern recognition. For example, the system can differentiate between academic research scanning and reconnaissance attempts by analyzing scan patterns, protocol usage, and historical behavior. The micro-targeting tier identifies focused probing attempts against specific assets or subnets, incorporating factors such as scan frequency, target selection, and probe sophistication. The advanced reconnaissance tier detects sophisticated attack patterns by correlating multiple indicators such as vulnerability probe sequences, lateral movement attempts, and evasion techniques. The highest tier, physical overlap, represents a capability entirely absent from traditional systems by detecting correlation between cyber activities and physical security events.

In step 4430, the system applies dynamic weighting based on context and emerging patterns. Unlike static classification systems, this approach continuously adjusts threat scoring based on new evidence and changing attack patterns. For example, if the system detects multiple failed badge reader attempts coinciding with network probes from a new IP address, it can dynamically increase the weight assigned to those network events based on the physical security correlation. The weighting system considers factors including time correlation, spatial relationships, attack sophistication, and historical patterns to provide more accurate threat assessment than simple IP reputation scoring.

Step 4440 involves generating appropriate responses for each tier level, with responses becoming progressively more aggressive at higher tiers. At the global noise tier, responses might include enhanced monitoring and baseline adjustment. For micro-targeting, the system might deploy deception technologies or implement targeted logging. Advanced reconnaissance triggers might include network segment isolation or deployment of specialized honeypots, while physical overlap could initiate comprehensive security lockdown procedures and real-time security team notification. Each response is calibrated based on the specific threat indicators detected, enabling more precise defensive measures than possible with binary classification systems.

Finally, at step 4450, the system updates its classification models based on observed outcomes and effectiveness metrics. This continuous learning process enables the system to improve its detection accuracy over time by incorporating new attack patterns, refining response strategies, and adjusting classification thresholds. The feedback loop considers multiple factors including false positive rates, detection accuracy, response effectiveness, and emerging threat patterns. This adaptive capability ensures the system maintains effectiveness against evolving threats while minimizing false positives through sophisticated pattern analysis and multi-source correlation.

Through this advanced classification methodology, the system achieves significantly higher accuracy and more nuanced threat detection than traditional binary approaches. The integration of physical security correlation, dynamic weighting, and continuous learning enables the detection of sophisticated attacks that would be invisible to systems focused solely on network scanning patterns. This comprehensive approach to threat classification represents a fundamental advancement in security monitoring and response capabilities.

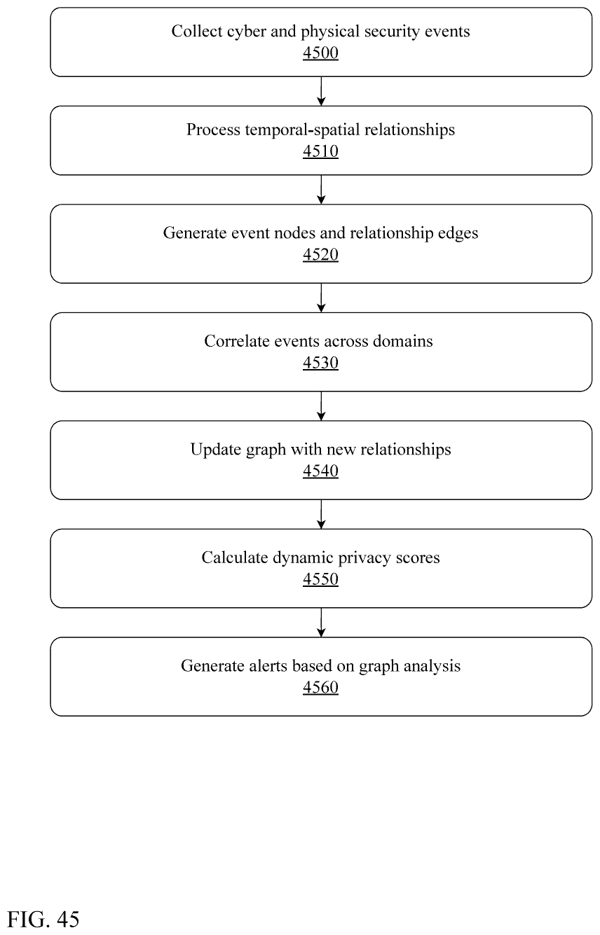

FIG. 45 is a flow diagram illustrating an exemplary method for Event Knowledge Graph (EKG) generation according to a preferred embodiment. Unlike traditional approaches of maintaining simple IP-based logs with basic timestamps, this method implements a sophisticated graph-based architecture that captures complex relationships between cyber and physical security events while enabling advanced temporal-spatial analysis.

The process begins at step 4500 with collecting cyber and physical security events from a diverse array of sources. Where traditional approaches focus solely on internet scanning data, this system ingests data from network sensors, physical security systems, wireless monitoring devices, and environmental sensors. For example, the system might simultaneously collect data about port scanning activity, badge reader access attempts, wireless device broadcasts in secure areas, and network authentication patterns. Each event is tagged with precise temporal and spatial metadata, enabling sophisticated correlation across domains that traditional systems cannot achieve. For instance, if a new wireless device is detected near a secure facility concurrent with unusual network probes, both events are captured with their full contextual relationships intact.

In step 4510, the system processes temporal-spatial relationships using advanced analytics that go far beyond simple timestamp correlation. The system employs sophisticated algorithms to identify temporal patterns such as event sequences, timing correlations, and periodic behaviors. This includes analyzing event chains that might indicate sophisticated attack progression, such as physical security breaches followed by network lateral movement attempts. The spatial analysis component maps relationships between events in physical space (building locations, access points, sensor coverage areas) and logical space (network segments, virtual private clouds, container clusters), enabling detection of patterns that span both domains.

At step 4520, the system generates event nodes and relationship edges within the knowledge graph. Unlike traditional systems that may contain flat data structure, each event becomes a node with rich metadata including event type, severity, source characteristics, and contextual information. The edges between nodes represent sophisticated relationships such as causal connections, temporal sequences, spatial proximity, and behavioral similarities. For example, if an IP address attempts to exploit a vulnerability shortly after a similar attempt was detected in a different network segment, the system creates edges representing this temporal and tactical relationship. The graph structure enables discovery of complex attack patterns through relationship analysis that would be impossible with traditional log-based approaches.

Step 4530 involves correlating events across domains using advanced pattern recognition capabilities entirely absent from IP-focused systems. The correlation engine employs machine learning algorithms to identify relationships between seemingly unrelated events. For instance, it might correlate unusual badge reader access patterns with specific network authentication attempts, or link wireless device detection events with subsequent data exfiltration attempts. This cross-domain correlation enables detection of sophisticated attack campaigns that operate across multiple attack vectors simultaneously.

In step 4540, the system continuously updates the graph with new relationships as they are discovered. This dynamic graph evolution goes beyond simple log append operations by reconstructing relationship patterns based on new evidence. When new events are detected, the system analyzes potential connections to historical events, updates relationship weights based on emerging patterns, and refines its understanding of attack methodologies. For example, if a new type of network probe is detected following a specific physical security event pattern, the system can retroactively identify similar historical patterns that might have been part of previous attacks.

Step 4550 implements continuous calculation of dynamic privacy scores based on graph analysis. The system evaluates the current exposure level of assets and systems based on observed event patterns, relationship strengths, and historical attack progressions. This scoring considers factors such as event proximity (both temporal and spatial), relationship patterns indicating coordinated activity, and similarity to known attack sequences. The privacy scoring enables proactive defense measures by identifying potential attack paths before they are fully exploited.

Finally, at step 4560, the system generates alerts based on comprehensive graph analysis rather than simple rule matching. The alert generation considers the full context of observed events, their relationships to other activities, and their similarity to known attack patterns. This approach enables more accurate threat detection by considering the broader context of security events rather than analyzing them in isolation. For example, an alert might be generated not just because of suspicious network activity, but because that activity follows a pattern of physical security events that matches a known attack methodology.

Through this sophisticated graph-based methodology, the system achieves significantly deeper insight into attack patterns and threat actor behaviors than traditional log-based approaches. The ability to map and analyze complex relationships between events across multiple security domains represents a fundamental advancement in threat detection capabilities, enabling identification of sophisticated attacks that would be invisible to systems focused solely on individual event analysis.

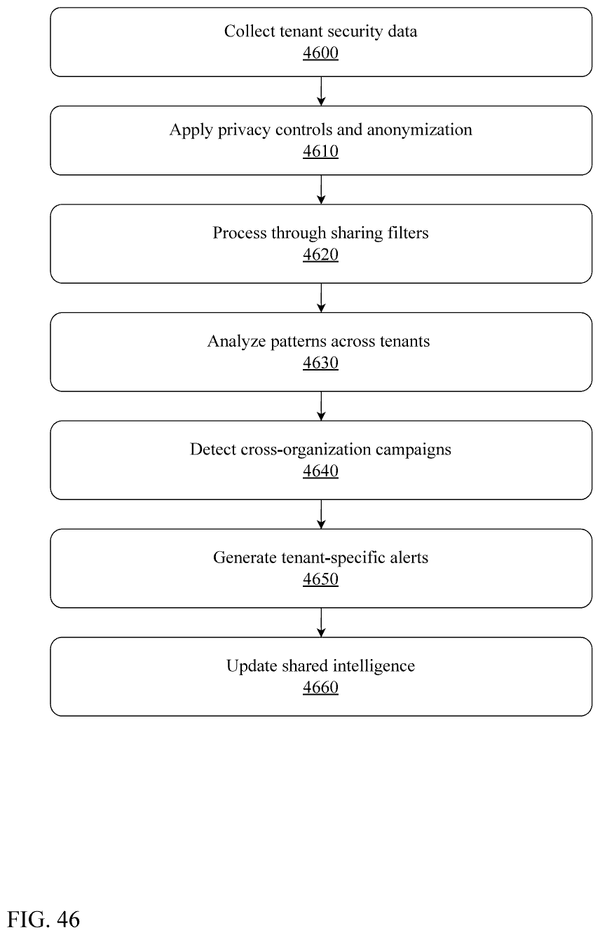

FIG. 46 is a flow diagram illustrating an exemplary method for privacy-preserving threat sharing according to a preferred embodiment. Unlike traditional approaches of providing a public feed of scanning data, this method implements a sophisticated multi-tenant architecture that enables secure sharing of sensitive threat intelligence while maintaining strict privacy controls and enabling deep cross-organizational correlation.

The process begins at step 4600 with collecting tenant security data from participating organizations. Where traditional systems may only process publicly visible scanning data, this system may collect rich security telemetry including network traffic patterns, security tool alerts, incident response data, and attack indicators. For example, the system might collect data about exploitation attempts, successful compromises, lateral movement patterns, and attacker TTPs (Tactics, Techniques, and Procedures). Each tenant maintains complete control over their data through sophisticated access controls and sharing policies. The system supports granular data classification, allowing organizations to precisely specify which types of security information can be shared and under what circumstances.

In step 4610, the system applies advanced privacy controls and anonymization techniques that go far beyond simple data masking. The privacy engine employs multiple sophisticated mechanisms including homomorphic encryption for maintaining data confidentiality during analysis, differential privacy techniques for protecting aggregate statistics, k-anonymity protocols for masking network attributes, and zero-knowledge proofs for validating threat indicators without revealing source information. For example, if an organization detects a new attack pattern, the system can share the pattern characteristics while cryptographically protecting details about the target infrastructure and attack impact. These privacy-preserving computations enable collaborative defense while maintaining strict data protection.

Step 4620 processes the anonymized data through sophisticated sharing filters that enforce tenant-specific policies. Unlike traditional approaches that may apply a one-size-fits-all approach, each organization can implement custom sharing rules based on data sensitivity, threat types, and trust relationships. The filtering system supports complex policies such as sharing certain indicators only with specific industry sectors, limiting temporal scope of shared data, or requiring multiple independent observations before sharing patterns. The system employs advanced policy engines to resolve conflicts and ensure consistent policy enforcement across multiple sharing relationships.

At step 4630, the system analyzes patterns across tenants using privacy-preserving computation techniques that enable sophisticated correlation without exposing sensitive details. The analysis engine can identify coordinated campaigns targeting multiple organizations, detect emerging attack methodologies being tested across different victims, and map attacker infrastructure without compromising tenant privacy. For example, if multiple organizations observe similar exploitation attempts, the system can correlate these events while maintaining confidentiality of specific target information and attack impacts.

Step 4640 focuses on detecting cross-organization campaigns through advanced pattern recognition that would be impossible with isolated security monitoring. The system employs machine learning algorithms to identify subtle attack patterns across different targets, temporal correlation of activities across organizations, and infrastructure reuse by sophisticated threat actors. This capability enables early warning of sophisticated attacks that might initially appear as isolated incidents when viewed from a single organization's perspective. For instance, the system might detect an attacker testing different variants of an exploit across multiple organizations before launching their main campaign.

In step 4650, the system generates tenant-specific alerts that provide actionable intelligence while preserving privacy constraints. Unlike traditional generic feeds, these alerts are customized based on each organization's infrastructure, security priorities, and risk profile. The alert generation system considers factors such as observed attack patterns, infrastructure similarities, temporal attack progressions, and historical impact data to provide relevant warnings while maintaining confidentiality of the source intelligence. These targeted alerts enable organizations to implement proactive defenses against emerging threats while respecting privacy boundaries.

Finally, at step 4660, the system updates its shared threat intelligence using carefully controlled data aggregation and anonymization. This continuous refinement process enables the system to maintain current attack pattern information while protecting sensitive details about specific incidents. The intelligence update process considers factors such as pattern confidence, correlation strength, and privacy implications to ensure high-quality shared intelligence without compromising tenant security. This collaborative approach enables significantly more sophisticated threat detection than possible with traditional public feeds or isolated security monitoring.

Through this advanced privacy-preserving sharing architecture, the system enables sophisticated collaborative defense while maintaining strict data protection. The combination of strong privacy controls, granular sharing policies, and advanced correlation capabilities represents a fundamental advancement over traditional threat intelligence sharing approaches, enabling organizations to benefit from collective defense without exposing sensitive security information.

### Exemplary Computing Environment

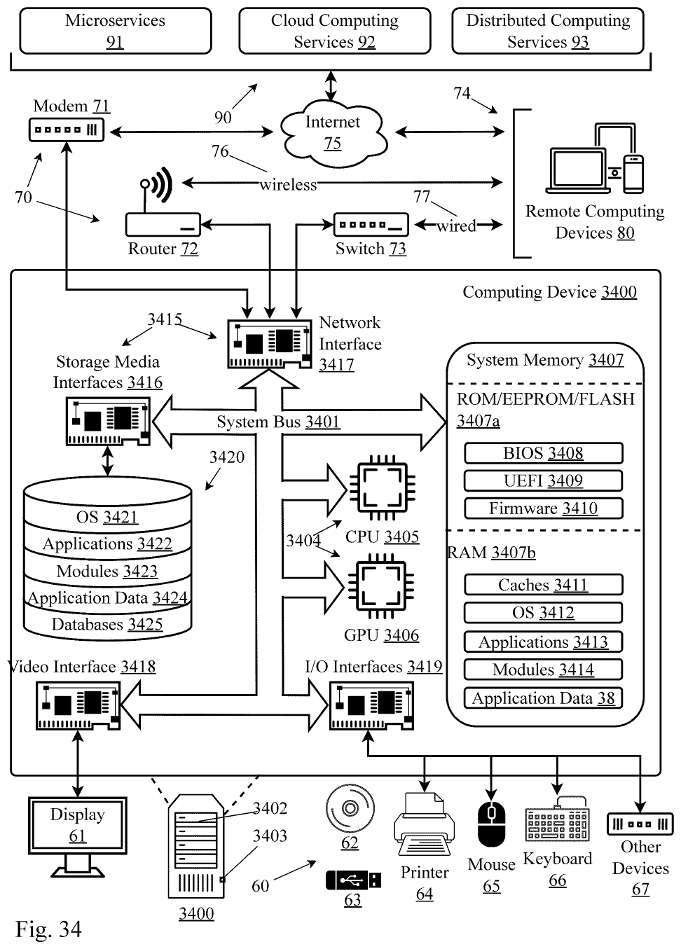

FIG. 34 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 3400 (further comprising a system bus 3401, one or more processors 3404, a system memory 3407, one or more interfaces 3415, one or more non-volatile data storage devices 3420), external peripherals and accessories 60, external communication devices 70, remote computing devices 80, and cloud-based services 90.

System bus 3401 couples the various system components, coordinating operation of and data transmission between, those various system components. System bus 3401 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 3404, system memory 3407 and other components of the computing device 3400 can be physically co-located or integrated into a single physical component, such as on a single chip. In such a case, some or all of system bus 3401 can be electrical pathways within a single chip structure.

Computing device may further comprise externally-accessible data input and storage devices 3402 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 3400. Computing device may further comprise externally-accessible data ports or connections 3402 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices such as joysticks and gaming pads, touchpads, additional displays and monitors, and external hard drives (whether solid state or disc-based), microphones, speakers, cameras, and optical scanners.

Processors 3404 are logic circuitry capable of receiving programming instructions and processing (or executing) those instructions to perform computer operations such as retrieving data, storing data, and performing mathematical calculations. Processors 3404 are not limited by the materials from which they are formed or the processing mechanisms employed therein, but are typically comprised of semiconductor materials into which many transistors are formed together into logic gates on a chip (i.e., an integrated circuit or IC). However, the term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 3400 may comprise more than one processor. For example, computing device 3400 may comprise one or more central processing units (CPUs) 3405, each of which itself has multiple processors or multiple processing cores, each capable or independently or semi-independently processing programming instructions. Further, computing device 3400 may comprise one or more specialized processors such as a graphics processing unit (GPU) 3406 configured to accelerate processing of computer graphics and images via a large array of specialized processing cores arranged in parallel.

System memory 3407 is processor-accessible data storage in the form of volatile and/or nonvolatile memory. System memory 3407 may be either or both of two types: non-volatile memory 3407a such as read only memory (ROM), electronically-erasable programmable memory (EEPROM), or rewritable solid state memory (commonly known as “flash memory”). Non-volatile memory 3407a is not erased when power to the memory is removed. Non-volatile memory 3407a is typically used for long-term storage a basic input/output system (BIOS) 3408, containing the basic instructions, typically loaded during computer startup, for transfer of information between components within computing device, unified extensible firmware interface (UEFI), which is a modern replacement for BIOS that supports larger hard drives, faster boot times, more security features, and provides native support for graphics and mouse cursors. Non-volatile memory 3407a may also be used to store firmware comprising a complete operating system 3412 and applications 3413 for operating computer-controlled devices. The firmware approach is often used for purpose-specific computer-controlled devices such as appliances and Internet-of-Things (IoT) devices where processing power and data storage space is limited. Volatile memory 3407b is erased when power to the memory is removed and is typically used for short-term storage of data for processing. Volatile memory 3407b such as random access memory (RAM) is normally the primary operating memory into which the operating system 3412, applications 3413, program modules 3414, and application data 38 are loaded for execution by processors 3404. Volatile memory 3407b is generally faster than non-volatile memory 30a due to its electrical characteristics and is directly accessible to processors 3404 for processing of instructions and data storage and retrieval. Volatile memory 3407b may comprise one or more smaller cache memories which operate at a higher clock speed and are typically placed on the same IC as the processors to improve performance.

Interfaces 3415 may include, but are not limited to, storage media interfaces 3416, network interfaces 3417, display interfaces 3418, and input/output interfaces 3419. Storage media interface 3416 provides the necessary hardware interface for loading data from non-volatile data storage devices 3420 into system memory 3407 and storage data from system memory 3407 to non-volatile data storage device 3420. Network interface 3417 provides the necessary hardware interface for computing device 3400 to communicate with remote computing devices 80 and cloud-based services 90 via one or more external communication devices 70. Display interface 3418 allows for connection of displays 61, monitors, touchscreens, and other visual input/output devices. Display interface 3418 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 3419 provide the necessary support for communications between computing device 3400 and any external peripherals and accessories 60. For wireless communications, the necessary radio-frequency hardware and firmware may be connected to I/O interface 3419 or may be integrated into I/O interface 3419.

Non-volatile data storage devices 3420 are typically used for long-term storage provide long-term storage of data. Data on non-volatile data storage devices 3420 is not erased when power to the non-volatile data storage devices 3420 is removed. Non-volatile data storage devices 3420 may be implemented using technology for non-volatile storage of content such as CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 3420 may be non-removable from computing 10 as in the case of internal hard drives, removable from computing device 3400 as in the case of external USB hard drives, or a combination thereof, but computing device will comprise one or more internal, non-removable hard drives using either magnetic disc or solid state memory technology. Non-volatile data storage devices 3420 may store any type of data including, but not limited to, an operating system 3421 for providing low-level and mid-level functionality of computing device 3400, applications for providing high-level functionality of computing device 3400, program modules 3423 such as containerized programs or applications, or other modular content or modular programming, application data 3424, and databases 3425 such as relational databases, non-relational databases, and graph databases.

Applications (also known as computer software or software applications) are sets of programming instructions designed to perform specific tasks or provide specific functionality on a computer or other computing devices. Applications are typically written in high-level programming languages such as C++, Java, and Python, which are then either interpreted at runtime or compiled into low-level, binary, processor-executable instructions operable on processors 3404. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network. Here, modem 71 is shown connecting computing device 3400 to both remote computing devices 80 and cloud-based services 90 via the Internet 75. While modem 71, router 72, and switch 73 are shown here as being connected to network interface 3417, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 3417 may be connected to switch 73 which is connected to router 72 which is connected to modem 71 which provides access for computing device 3400 to the Internet 75. Further, any combination of wired 77 or wireless 76 communications between and among computing device 3400, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 3417 may be installed and used at server devices.

In a networked environment, certain components of computing device 3400 may be fully or partially implemented on remote computing devices 80 or cloud-based services. Data stored in non-volatile data storage device 3420 may be received from, shared with, duplicated on, or offloaded to a non-volatile data storage device on one or more remote computing devices 80 or in a cloud computing service 92. Processing by processors 3404 may be received from, shared with, duplicated on, or offloaded to processors of one or more remote computing devices 80 or in a distributed computing service 93. By way of example, data may reside on a cloud computing service, but may be usable or otherwise accessible for use by computing device 3400. Also, certain processing subtasks may be sent to a microservice 91 for processing with the result being transmitted to computing device 3400 for incorporation into a larger processing task. Also, while components and processes of the exemplary computing environment are illustrated herein as discrete units (e.g., OS 3421 being stored on non-volatile data storage device 3421 and loaded into system memory 3407 for use) such processes and components may reside or be processed at various times in different components of computing device 3400, remote computing devices 80, and/or cloud-based services 90.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, main frame computers, network nodes, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are microservices 91, cloud computing services 92, and distributed computing services.

Microservices 91 are collections of small, loosely coupled, and independently deployable computing services. Each microservice represents a specific business functionality and runs as a separate process or container. Microservices promote the decomposition of complex applications into smaller, manageable services that can be developed, deployed, and scaled independently. These services communicate with each other through well-defined APIs (Application Programming Interfaces), typically using lightweight protocols like HTTP or message queues. Microservices 91 can be combined to perform more complex processing tasks.

Cloud computing services 92 are delivery of computing resources and services over the Internet 75 from a remote location. Cloud computing services 92 provide additional computer hardware and storage on as-needed or subscription basis. For example, cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over the Internet on a subscription basis.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power. These services enable parallel processing, fault tolerance, and scalability by distributing tasks across multiple nodes.

Although described above as a physical device, computing device 3400 can be a virtual computing device, in which case the functionality of the physical components herein described, such as processors 3404, system memory 3407, network interfaces 3415, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 3400 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 3400 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

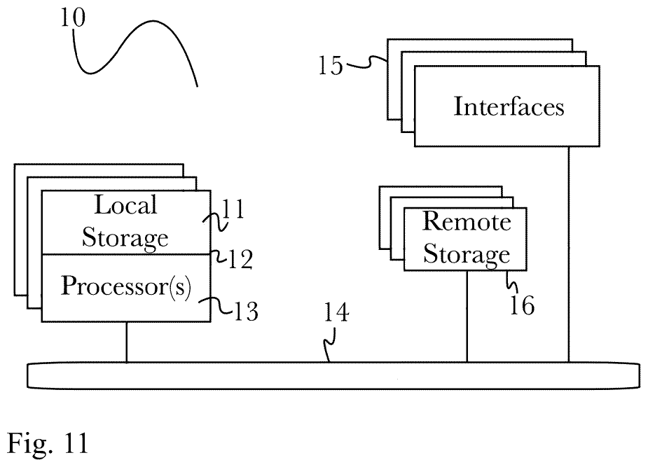

Referring now to FIG. 11, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

FIG. 11 illustrated one architecture of a possible computing device. Although the system shown in FIG. 11 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

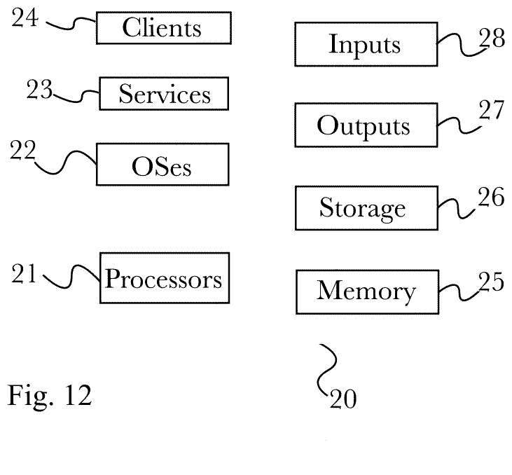

In some embodiments, systems according to the present invention may be implemented on a standalone computing system. Referring now to FIG. 12, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 11). Examples of storage devices 26 include flash memory, magnetic hard drive, CD-ROM, and/or the like.

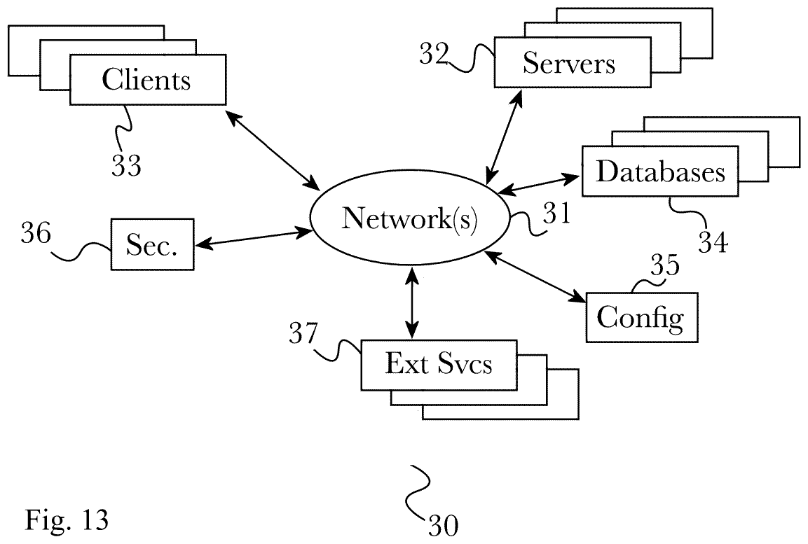

In some embodiments, systems of the present invention may be implemented on a distributed computing network, such as one having any number of clients and/or servers. Referring now to FIG. 13, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 12. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

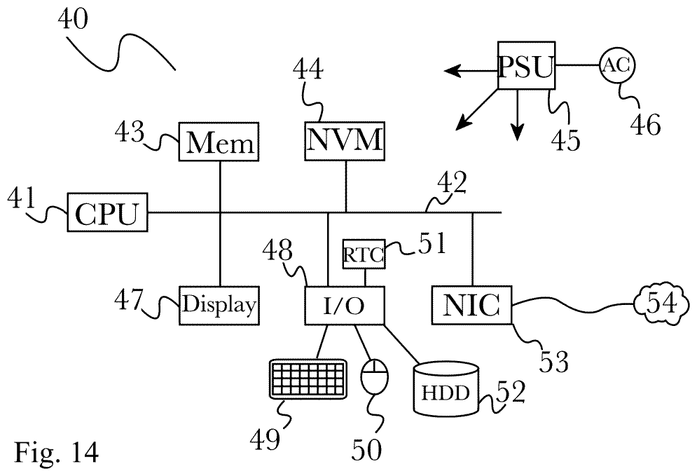

FIG. 14 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

The skilled person will be aware of a range of possible modifications of the various aspects described above. Accordingly, the present invention is defined by the claims and their equivalents.

What is claimed is:

1. A system for an AI-controlled sensor network for threat mapping and characterization, comprising one or more computers with executable instructions that, when executed, cause the deep learning system to:
deploy a distributed network of diverse honeypots and sensors, wherein the sensors include both cyber and physical security sensors;
aggregate data from the honeypots and sensors, wherein the aggregated data includes both network traffic data and physical security event data;
analyze the aggregated data using machine learning models and pattern recognition algorithms to identify a plurality of patterns across both cyber and physical security domains;
generate a comprehensive threat landscape based on the analyzed data, wherein the threat landscape includes temporal-spatial correlations between cyber and physical security events;
restructure system configurations based on the comprehensive threat landscape using dynamic response mechanisms; and
optimize system components based on feedback and observed attack patterns to improve threat detection capabilities through continuous learning.

2. The system of claim 1, wherein data from the honeypots and sensors includes network traffic, simulated vulnerabilities, and behavioral characteristics of the honeypots.

3. The system of claim 1, wherein the aggregated data is used to generate a cyber-physical graph representing the relationships between entities associated with a network.

4. The system of claim 3, wherein the cyber-physical graph is updated based on changes in the aggregated data from the honeypots and sensors.

5. The system of claim 1, wherein diverse honeypots includes AI generated honeypot profiles.

6. The system of claim 5, wherein AI generated honeypot profiles include basic configurations, simulated vulnerabilities, behavioral characteristics, monitoring parameters, and adaptive behaviors.

7. The system of claim 1, wherein the system implements a multi-tier threat categorization framework comprising:
global noise detection for internet-wide scanning;
micro-targeting detection for subnet-specific probing;
advanced reconnaissance detection for vulnerability testing; and
physical overlap detection for cyber-physical correlation.

8. The system of claim 1, wherein the system implements a layered scoring mechanism that:
combines external intelligence, tactics, techniques, procedures and indicators of compromise (TTP/IOC) correlation, and physical presence data;
dynamically adjusts threat weights based on observed behavior patterns;
generates automated responses based on calculated threat scores.

9. The system of claim 1, wherein the system implements privacy-preserving tenant-level threat sharing comprising:
anonymization of shared security data;
cross-organization campaign detection; and
tenant-specific alert generation.

10. The system of claim 1, wherein the system implements adaptive response capabilities comprising:
dynamic service simulation;
banner randomization for attacker motive analysis; and
automated response action triggering.

11. The system of claim 1, wherein the system implements event knowledge graphs comprising:
temporal-spatial relationship modeling;
cross-domain correlation capabilities; and
dynamic privacy scoring.

12. A method for an AI-controlled sensor network for threat mapping and characterization, comprising the steps of:
deploying a distributed network of diverse honeypots and sensors, wherein the sensors include both cyber and physical security sensors;
aggregating data from the honeypots and sensors, wherein the aggregated data includes both network traffic data and physical security event data;
analyzing the aggregated data using machine learning models and pattern recognition algorithms to identify a plurality of patterns;
generating a comprehensive threat landscape based on the analyzed data across both cyber and physical security domains;
restructuring system configurations based on the comprehensive threat landscape using dynamic response mechanisms; and
optimizing honeypot profiles and system components based on feedback and observed attack patterns to improve threat detection capabilities through continuous learning.

13. The method of claim 12, wherein data from the honeypots and sensors includes network traffic, simulated vulnerabilities, and behavioral characteristics of the honeypots.

14. The method of claim 12, wherein the aggregated data is used to generate a cyber-physical graph representing the relationships between entities associated with a network.

15. The method of claim 14, wherein the cyber-physical graph is updated based on changes in the aggregated data from the honeypots and sensors.

16. The method of claim 12, wherein diverse honeypots includes AI generated honeypot profiles.

17. The method of claim 16, wherein AI generated honeypot profiles include basic configurations, simulated vulnerabilities, behavioral characteristics, monitoring parameters, and adaptive behaviors.

18. The method of claim 12, wherein the method includes implementing a multi-tier threat categorization framework comprising:
global noise detection for internet-wide scanning;
micro-targeting detection for subnet-specific probing;
advanced reconnaissance detection for vulnerability testing; and
physical overlap detection for cyber-physical correlation.

19. The method of claim 12, wherein the method includes implementing a layered scoring mechanism that:
combines external intelligence, TTP/IOC correlation, and physical presence data;
dynamically adjusts threat weights based on observed behavior patterns;
generates automated responses based on calculated threat scores.

20. The method of claim 12, wherein the method includes implementing privacy-preserving tenant-level threat sharing comprising:
anonymization of shared security data;
cross-organization campaign detection; and
tenant-specific alert generation.

21. The method of claim 12, wherein the method includes implementing adaptive response capabilities comprising:
dynamic service simulation;
banner randomization for attacker motive analysis; and
automated response action triggering.

22. The method of claim 12, wherein the method includes implementing event knowledge graphs comprising:
temporal-spatial relationship modeling;
cross-domain correlation capabilities; and
dynamic privacy scoring.
